(19) United States
(12) Patent Application Publication
(10) Pub. No.: US 2019/0392018 A1
(43) Pub. Date: Dec. 26, 2019

(54) Displaying Data Using Enhanced Functionality

(71) Applicant: R. R. Donnelley & Sons Company, Chicago, IL (US)

(72) Inventor: Timothy J. Reedy, Milton, GA (US)

(21) Appl. No.: 16/447,807

(22) Filed: Jun. 20, 2019

Related U.S. Application Data
(60) Provisional application No. 62/688,111, filed on Jun. 21, 2018.

(51) Int. Cl. G06F 16/957; G06F 16/901; G06K 15/02; G06F 16/951; G06F 16/9538

(52) U.S. Cl. CPC G06F 16/9577; G06F 16/9024; G06F 16/9538; G06F 16/951; G06K 15/1813

(57) ABSTRACT

According to one aspect, a method includes the steps of receiving first page definition language (PDL) code defining a first document wherein the first PDL code includes first data, deriving further code from the first code, and using the further code to display the first document with an indication of functionality at a particular location wherein the particular location includes a representation of the first data. The method further includes the steps of receiving a user selection of the particular location, and, in response to receipt of user selection of the particular location, displaying second data from a data source other than the first document wherein the second data are related to the first data by at least one of (a.) subject matter and (b.) chronology.

### CROSS REFERENCE TO RELATED APPLICATIONS

The present application claims the benefit of U.S. Provisional Application Ser. No. 62/688,111, filed Jun. 21, 2018, entitled “Systems and Methods for Digital Content Delivery.” The present application also incorporates by reference U.S. Pat. No. 10,043,022, issued Aug. 7, 2018, entitled “Systems and Methods for Digital Content Delivery” by Reedy et al.

### FIELD OF DISCLOSURE

The present application is directed to the display of data, and more particularly, to methods of displaying data and computer readable media implementing same.

### BACKGROUND

A consumer often receives communications from vendors of goods and services. These communications may be communicated to the consumer in electronic form, typically, but not exclusively, by email, as one or more text messages, and/or as one or more viewable web pages. U.S. Pat. No. 10,043,022, incorporated by reference herein, discloses a system that processes data and stores the processed data. Specifically, data that are related to one another by subject matter are tagged similarly and stored as entries in the database. Thus, for example, invoices issued to a particular consumer by a particular utility company are similarly tagged and stored, as are credit card statements issued to a particular consumer by a particular credit card company, and the like.

Maher et al. U.S. Published Patent Application No. 2010/0293049 is directed to content delivery methods and systems to distribute video content interspersed with advertisements to a user. A content provider supplies one or more video content files and a content rules XML file associated with each video content file. The content rules XML file associated with a video content file specifies information about the video content such as a genre, a rating, time slots during playback of the video content when an advertisement may be displayed, minimum fees the content provider charges for the advertisement to be displayed, and the like. Advertisement providers supply advertisement content and an ad rules XML file. The ad rules XML file specifies, for example, demographic characteristics of the target audience for the advertisement and how much the advertiser is willing to pay for placement of the advertisement. When a user selects a video content file to view on a device, the ad matching engine uses information about the user, the content rules XML file associated with the video content, and the ad rules XML files from different advertisement providers to select one or more advertisement(s) to present with the video content. A digital rights management system operating on the device operated by the user to view the video content confirms that the user has appropriate licenses to view the video content and the selected advertisement(s). The content and the ad rules XML files are supplied with tags already embedded therein.

Hauser U.S. Pat. No. 7,814,116 discloses a method and system for creating customized news digests. A profile module receives a delivery preference of a user along with a user attribute and a content preference of the user. A content management module searches a location for content items that match the user attribute and the content preference. A document creation module compiles a printable personalized digest document for the user that includes the matching content item. An interface delivers the personalized digest document to the user in accordance with the delivery preference.

Felsher U.S. Published Patent Application No. 2002/0010679 discloses a method and system for maintaining electronic medical records.

Roever et al. U.S. Published Patent Application No. 2005/0234860 is directed to facilitating transactions involving exchange of “titles.” A title is an object that includes embedded digital content and attributes of such content that specify ownership, copy permissions, and the like. A title management apparatus allows users to manage titles owned thereby and to exchange ownership of titles with other users.

Kanamori et al. U.S. Published Patent Application No. 2004/0255152 is directed to software and methods for providing an intellectual property (IP) core from an IP core owner to an IP core licensee or user. Kanamori et al. specifies the IP core as logic or data used in the manufacture of semiconductor devices.

### SUMMARY

According to one aspect, a method includes the steps of receiving first page definition language (PDL) code defining a first document wherein the first PDL code includes first data, deriving further code from the first code, and using the further code to display the first document with an indication of functionality at a particular location wherein the particular location includes a representation of the first data. The method further includes the steps of receiving a user selection of the particular location, and, in response to receipt of user selection of the particular location, displaying second data from a data source other than the first document wherein the second data are related to the first data by at least one of (a.) subject matter and (b.) chronology.

According to a further aspect, a non-transitory computer-readable medium has programming for executing the steps of receiving first page definition language (PDL) code defining a first document wherein the first PDL code includes first data, deriving further code from the first code, and using the further code to display the first document with an indication of functionality at a particular location wherein the particular location includes a representation of the first data. The programming further executes the steps of receiving a user selection of the particular location, and, in response to receipt of user selection of the particular location, displaying second data from a data source other than the first document wherein the second data are related to the first data by at least one of (a.) subject matter and (b.) chronology.

According to a still further aspect, a method comprises the steps of receiving first data from code defining a first document in accordance with a page definition language (PDL) specification wherein the first data would be displayed at a particular location of the first document if the first document were displayed using the code and receiving second data from a data source other than the first document wherein the second data are related to the first data by at least one of (a.) subject matter and (b.) chronology. The method further comprises the step of instructing a client device to display the first document together with a portion in response to selecting the particular location on the client device wherein the portion includes a representation of at least one of (c.) the first data and the second data and (d.) a combination of the first data and the second data.

According to yet another aspect, a method of using data stored in one or more entries of a database, wherein the data are related by at least one of subject matter and chronology includes the steps of receiving first code defining a first document according to a page description language specification and using the first code to develop second code defining a second document having a first portion at least substantially identical to a corresponding portion of the first document and the second document further having a second portion that includes a selectable area. The method further includes the steps of operating a display device in accordance with the second code to display the second document, receiving an indication of selection of the selectable area, and, in response to receipt of the indication displaying a representation of at least one entry in the database.

Aspects and advantages of the embodiments described herein will become apparent upon consideration of the following detailed description and the attached drawings wherein like numerals designate like structures throughout the specification.

### BRIEF DESCRIPTION OF THE DRAWINGS

FIG. 1 is a block diagram of an exemplary system for displaying data;

FIG. 2 is a screenshot of a displayed document not having enhanced features and shown in a window with a header allowing a user to enable enhanced features;

FIGS. 3A and 3B, when joined along the similarly lettered lines, together represent a flowchart of programming that may be executed by the client computer of FIG. 1 alone or in conjunction with one or more other programmable devices to implement enhanced features;

FIG. 4 is a screenshot of the displayed document for which enhanced capabilities have been enabled;

FIG. 5 is a screenshot of a dialog box or window opened by selection of a Summary area of the document of FIG. 4;

FIG. 6 is a screenshot of a document that may be opened by selection of one of the bar icons of FIG. 5;

FIG. 6A is a screenshot of a dialog box or window that is opened by selection of the help icon of FIG. 5;

FIG. 7 is a screenshot of a dialog box or window opened by selection of a Payment area of the document of FIG. 4;

FIG. 7A is a screenshot of a dialog box or window opened when a submit payment area of the dialog box or window of FIG. 7 is selected;

FIG. 7B is a dialog box or window opened when an area of the dialog box or window of FIG. 7A that allows specification of a payment method is selected;

FIG. 7C is the dialog box or window of FIG. 7B when an area associated with a particular payment method is selected therein;

FIG. 8 is a screenshot of a dialog box or window that is opened by selection of the help icon of FIG. 7;

FIG. 9 is a screenshot of a dialog box or window that is opened by selection of a Property Address area of the document of FIG. 4;

FIG. 10 is a screenshot of a dialog box or window that is opened by selection of a Name and Address area of the document of FIG. 4;

FIG. 11 is screenshot of the dialog box or window of FIG. 10 after selection of the “Submit” button thereof;

FIG. 12 is a screenshot of the document of FIG. 4 after selection of one of the areas 144e;

FIG. 13 is a screenshot of a dialog box or window opened by selection of the icon 240-1 of FIG. 12;

FIG. 14 is a screenshot of a dialog box or window that is opened by selection of the help icon of FIG. 13;

FIG. 15 is a screenshot of a dialog box or window that is opened by selection of the hyperlink “Add Note” of FIG. 13;

FIG. 16 is a screenshot of a dialog box or window that is opened by selection of the hyperlink “Add Attachment” of FIG. 13;

FIG. 17 is a screenshot of a dialog box or window opened by selection of the icon 240-2 of FIG. 12;

FIG. 18 is a screenshot of a drop-down box opened by selection of the hyperlink 274 of FIG. 17;

FIG. 19 is a screenshot of a dialog box or window opened by selection of the sub-area 278a or the link 284 of FIG. 18;

FIG. 20 is a screenshot of a dialog box or window opened by selection of the sub-area 278b or the link 288 of FIG. 18;

FIG. 21 is a screenshot of the dialog box or window of FIG. 17 after selection of the hyperlink 275;

FIG. 22 is a screenshot of the dialog box or window of FIG. 17 after a user hovers over a portion of the graph illustrated therein;

FIGS. 23A and 23B are screenshots of the dialog box or window of FIG. 17 after a user hovers over sub-areas 278a and 278b, respectively;

FIG. 24 is a screenshot of the dialog box or window of FIG. 19 after a user hovers over one sub-area of the donut chart 282;

FIG. 25 is a screenshot of the dialog box or window of FIG. 19 after a user hovers over another sub-area of the donut chart 282;

FIG. 26 is a screenshot of a dialog box or window that is opened by selection of another enhanced feature area of the document of FIG. 4;

FIG. 27 is a screenshot of a dialog box or window that is opened by selection of yet another enhanced feature area of the document of FIG. 4;

FIGS. 28 and 57 are screenshots of a dialog box or window that is opened by selection of a still further enhanced feature area of the document of FIG. 4;

FIG. 29 is a screenshot of a dialog box or window that is opened by selection of the “Calculate” button of FIG. 28;

FIG. 30 is a screenshot of a portion of the header bar of FIG. 4 as a user is typing text into the search area thereof;

FIG. 31 is a screenshot of the search area of FIG. 30 as further text is typed therein;

FIG. 32 is a screenshot of the document of FIG. 4 after selection of a “download” icon;

FIGS. 33-37 are screenshots of the document of FIG. 4 after selection of a help icon;

FIG. 37A is a screenshot of a portion of the header bar displaying the document of FIG. 4;

FIGS. 37B-37D are screenshots of dialog boxes or windows opened by the “Notes and Attachments” widget;

FIG. 37 E is a screenshot of the header bar of FIG. 37A;

FIGS. 37F-37I are screenshots of dialog boxes or windows opened by the “Trends and History” widget;

FIG. 38 is a screenshot of a further document comprising a sample credit card statement having enhanced features;

FIG. 39 is a screenshot of a portion of the document of FIG. 38 in conjunction with a dialog box opened by selection of an area 358b;

FIG. 40 is a screenshot of a portion of an activity-line portion of the credit card statement of FIG. 38;

FIGS. 41 and 42 are screenshots of dialog boxes or windows opened by a “Notes and Attachments” widget;

FIG. 43 is a screenshot of a dialog box or window opened by a “Trends and History” widget;

FIG. 44 is a screenshot of a dialog box or window opened by a “Deals and Offers” widget;

FIG. 45 is a screenshot of a dialog box or window opened by a “Profile Update” widget;

FIG. 46 is a screenshot of a portion of a header bar displaying a utility statement;

FIGS. 47, 48, and 48A are screenshots of dialog boxes or windows opened by a “Notes and “Attachments” widget;

FIG. 49 is a screenshot of a portion of the header bar of FIG. 46;

FIGS. 50 and 51 are screenshots of dialog boxes or windows opened by a “Notes and “Attachments” widget;

FIG. 52 is a screenshot of a portion of a dialog box or window comprising an activity-line of an utility statement;

FIG. 53 is a screenshot of a portion of a utility statement;

FIGS. 54 and 55 are screenshots of dialog boxes or windows opened by a “Budget Plan Estimator” widget;

FIG. 56 is a dialog box or window that may be opened by the enhanced feature when the area 144d of FIG. 4 is selected;

FIG. 58 is a screenshot of the header bar of a window displaying an escrow statement;

FIGS. 59-61 are screenshots of dialog boxes or windows opened by the “Notes and Attachments” widget;

FIG. 62 is screenshot of the header bar of FIG. 58;

FIGS. 63-65 are screenshots of dialog boxes or windows opened by the “Trends and History” widget;

FIG. 66 is a screenshot of a sample escrow statement with enhanced features;

FIGS. 67-69 are screenshots of dialog boxes or windows opened by the “Shortage Payoff Estimator” widget;

FIGS. 70A and 70B, when joined along the similarly lettered lines, together comprise a flowchart of programming executed by the block 154 of FIG. 3b;

FIG. 70C comprises a flowchart of programming executed by the block 156 of FIG. 3B;

FIG. 71A is a screenshot of a displayed document associated with a utility bill for which enhanced features have been enabled;

FIG. 71B is a screenshot of a dialog box or window opened when an area of the displayed document of FIG. 71A associated with energy efficiency is invoked;

FIG. 71C is a screenshot of a displayed document associated with a healthcare statement having enhanced features enabled;

FIGS. 71D-71G are screenshots of dialog boxes or windows opened when areas of the displayed document of FIG. 71 associated with a service history, a provider history, provider search, and an out-of-pocket analyzer, respectively, are invoked;

FIG. 71H is a screenshot of a displayed document associated with a financial account with enhanced features enabled;

FIGS. 71I and 71J are screenshots of dialog boxes or windows opened when areas of the displayed document of FIG. 71H associated with balances and holdings and past statement balances are invoked;

FIG. 71K is a screenshot of a dialog box or window opened when an area of the displayed document of FIG. 71H associated with enabling a transfer of funds from an account is invoked;

FIG. 71L is a screen shot of a dialog box or window opened when an area of the displayed dialog box or window of FIG. 71K associated with enabling a transfer of funds into an account is invoked;

FIG. 71M is a screen shot of a dialog box or window opened when an area of the displayed document of FIG. 71H associated with a plan overview is invoked; and

FIG. 71N is a screen shot of the dialog box or window of FIG. 71M when an area thereof associated with displaying additional account information is invoked.

### DETAILED DESCRIPTION

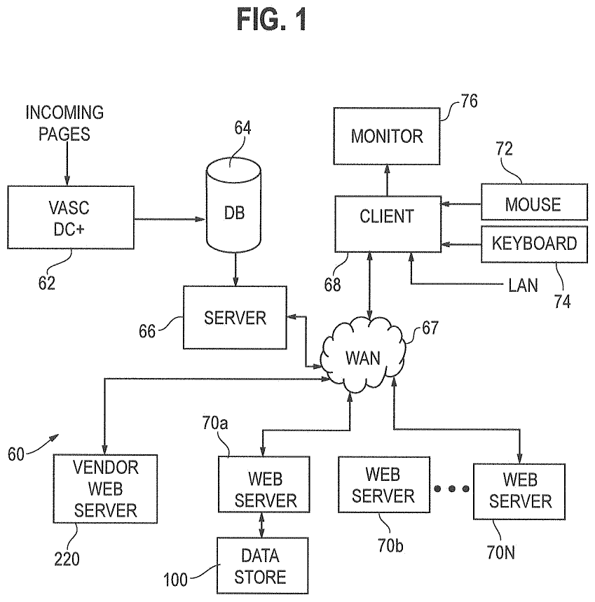

Referring to FIG. 1, an exemplary system 60 for displaying data is illustrated, it being understood that the system 60 may be implemented by other combinations of components and/or other interconnection configurations. The illustrated system 60 includes a data receipt server or other programmable device 62 that receives page description language (PDL) data, such as data encoded according to the Adobe PostScript specification, the Adobe Portable Document Format (PDF) specification, and/or the Advanced Function Presentation (AFP) specification defined by the AFP Consortium, Inc. Alternatively or in addition, the device 62 may accept data in other formats. In some embodiments, the PDL data are in a format that may be directly rendered on a display device and/or interpreted by a printer to produce a printed document. The PDL data define a one or more documents that have been or are to be sent to recipients, such as consumers. Such documents may be sent electronically, for example, via electronic mail, or as printed documents.

In a specific embodiment, a first data stream may be directly or indirectly transmitted to the device 62 by a first supplier of goods and/or services, such as a mortgage company, a second data stream may thereafter be transmitted directly or indirectly by the first supplier or a second supplier of goods and/or services, such as a credit card issuer, a third data stream may thereafter be transmitted directly or indirectly by the first or second suppliers or a third supplier of goods and/or services, such as a power utility company, a bank, an investment firm, etc. Each data stream may comprise, for example, data representing documents sent or to be sent to recipients within a particular period of time and/or documents regarding consumer activity during a period of time, or the like. The data of each stream is supplied in a particular PDL format according to a document structure defined by a generating program that is used by the supplier or a contractor working on behalf of the supplier. The data defines the position and appearance (and, possibly, other document attributes) of each document of the data stream. Thus, for example, a first data stream may be encoded in AFP and may define a first data field to appear at a first position at each document comprising the name of the recipient, a second data field comprising the address of the recipient may be defined to appear at a second document location adjacent the first position, and a third data field representing an amount due may be defined to appear at a third location spaced from the first and second locations. With prior knowledge of the PDL format and document structure, which may be obtained using one or more sample data streams provided by the supplier, a programmer may program the device 62 to recognize the PDL format and document structure associated with a respective supplier of a data stream, parse documents defined by the respective data stream, fetch and extract information associated with data field(s) represented in the data stream, categorize such information by the content type of data field associated therewith and log the extracted information in a database 64. The database 64 may be managed using a database management system and may be of a relational or non-relational type. In an alternative embodiment, database 64 is a plurality of databases of relational and/or non-relational type. When stored in the database such extracted information (e.g., “Mary”) is associated with a tag or key (e.g., “xFirstName”) that is associated with the data field (e.g., identified as “First Name”) with which such information is extracted and, hence, what such information represents (e.g., a recipient's first name). The entries in the database are thus stored in a manner that facilitates the retrieval of data that are related by one or both of subject matter and chronology using such key or tag. An example of such a system 62 is disclosed in, for example, U.S. Provisional Patent Application No. 61/606,932 and U.S. Pat. No. 10,043,022, the entire contents of which are incorporated by reference herein. The processes for undertaking such functions are referred to as VASC (“Value Added Service Capable”) and DC+(“Digital Content+”).

The database 64 is accessible by a server 66 that can, in turn, be accessed over a wide-area network (WAN) 67, such as the Internet and/or a cloud-based set of devices either standing alone or combined with other devices/networks. A client computer 68 may also access the WAN 67, as may web servers 70a, 70b, . . . , 70N maintained by suppliers such as a mortgage company, a credit card company, a power utility company, a bank, an investment firm, as well as other suppliers. As is common, the client computer 68 is responsive to user inputs, such as via a mouse 72 and/or a keyboard 74. A monitor 76 is responsive to display signals developed by the computer 68, for example, in response to user inputs and/or instructions received from the server 66 and/or the web servers 70. The monitor 76 may be a device that is only responsive to commands issued by the computer 68 or may be of the touch-sensitive type.

In an alternative embodiment, the client computer 68 may be replaced by a tablet, smartphone, or another programmable device, in which case the separate mouse 72, keyboard 74, and/or monitor 76 may not be necessary and may be omitted inasmuch as human interface activities may be undertaken via the touch screen of such a device. In any embodiment, the programmable device (e.g., the client computer 68 or the tablet or smartphone) may have wireless and/or local area network (LAN) connectivity to permit method steps disclosed herein to be executed by and/or data to be shared among local devices.

Further, any of the components disclosed herein may be replaced by one or more combinations of components, wherein each component is identical or equivalent to the original component.

As noted in greater detail hereinafter, the data stored in the database 64 are used by enhanced features that a user of the client computer 68 may select and interact with to obtain detailed information and/or provide further information (such as an updated address, credit card number, profile information, etc.) to a supplier. The enhanced features are implemented at least in part by “widgets” that may comprise one or more plug-in(s) or extension(s) that utilize/expand the functionality of a browser, such as Google Chrome, Mozilla Firefox, Apple Safari, or the like to display documents encoded in a PDL (such as the portable document format (PDF) developed by Adobe) with the enhanced features. If desired, the enhanced features may be implemented in another fashion, such as by programming unrelated to a browser. The document may be displayed using the same PDL that the document was originally supplied to the device 62 or the document may be encoded in a different PDL for display by the client computer 68 that executes the widgets and/or other programming. The document with enhanced features may be developed by client 68 and/or server 66 and widgets/enhanced features may be executed by either or both. While the disclosure herein contemplates that the client computer 68 executes the programming described herein to realize the enhanced features, it is alternatively possible for at least some of such programming to be executed by one or more other programmable devices, such as any or all of the programmable components illustrated in FIG. 1.

Further, in the illustrated embodiments disclosed herein, the enhanced features are indicated on the monitor 76 by displaying a selected document with highlighting added thereto, and/or displaying data and/or text in a different color (e.g., in blue in the case of hypertext), and/or differentiating one or more portions of the selected page in some other way to indicate to a user of the client computer 68 or equivalent device that the one or more portions may be selected e.g., using the mouse 72, keyboard 74, and/or the user's finger or a stylus if a touch-sensitive display is used as the monitor 76. Once selected, a corresponding widget and/or other enhanced feature is executed and the result displayed, typically, although not necessarily, in a window or dialog box either in or separate from the display window of the selected document.

Widgets may be categorized as being of a generalized type that may be used under many, if not all circumstances (i.e., irrespective of the document type and/or the supplier/consumer) or as directed to specific document types and/or of particular utility to one or more suppliers/consumers. Enhanced features include the above-described widgets, as well as other functionality described hereinafter. Enhanced features may be invoked by selecting an area of a document or an area of a window header, for example, at which an icon may be disposed, or some other displayed area of the monitor 76.

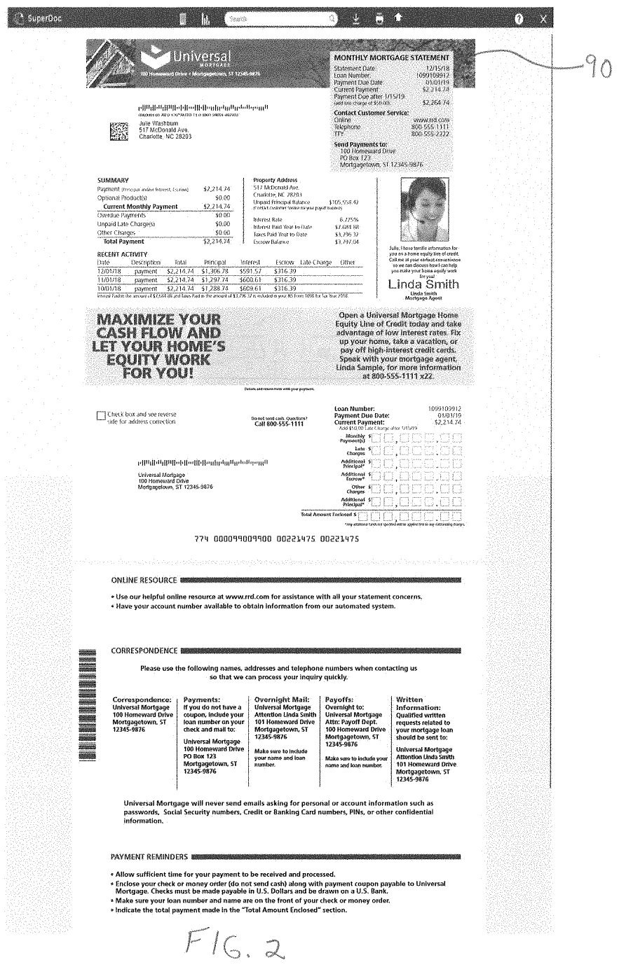

More specifically, FIG. 2 illustrates a sample document 90 comprising a mortgage summary sheet developed by a supplier identified as “Universal Mortgage” in connection with a consumer “Julie Washburn” with an account statement date of Dec. 15, 2018. As noted above, the sample document 90, as well as other similar documents comprising summary sheets for other customers of Universal Mortgage for the same or similar account dates are processed by the programmable device 62. The extracted and tagged data from the data stream provided by Universal Mortgage are stored in the database 64 together with other data obtained from other data streams, including data streams from Universal Mortgage for summary sheets in connection with prior billing periods, such as prior months. The data extracted from the data stream defining the sample document of FIG. 2 are tagged so as to associate such data with other data extracted from other data streams provided by Universal Mortgage defining summary sheets in connection with prior billing periods for Julie Washburn. Thus, for example, the “Principal” data for the current billing period may be associated with the “Principal” data for prior billing periods. Other data may be, but are not necessarily, appropriately tagged, if desired. Thus, “Interest,” “Escrow,” “Optional Products,” “Overdue Payments,” “Unpaid Late Charges,” and/or other data for the present billing period may be similarly tagged as the respective data from prior billing periods. Any of the above data tagging associates the data by subject matter (i.e., data relating to Julie Washburn) and chronology (i.e., data for the current billing period are associated with corresponding data for prior billing periods).

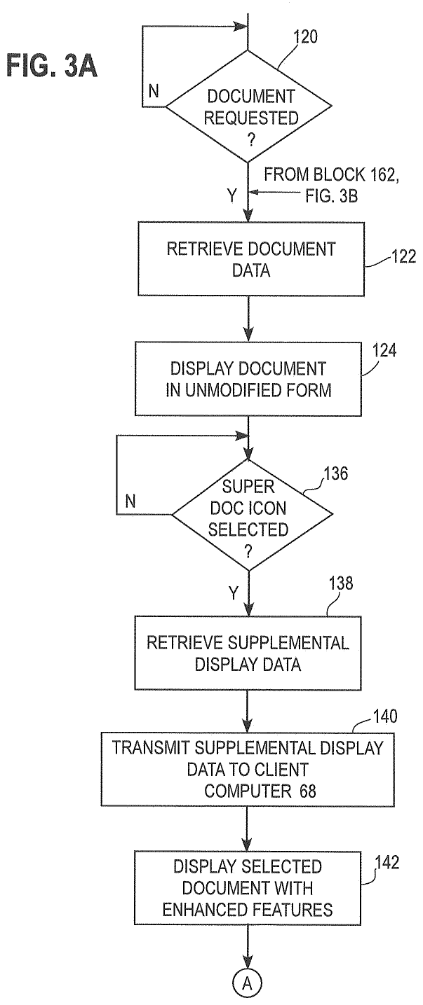

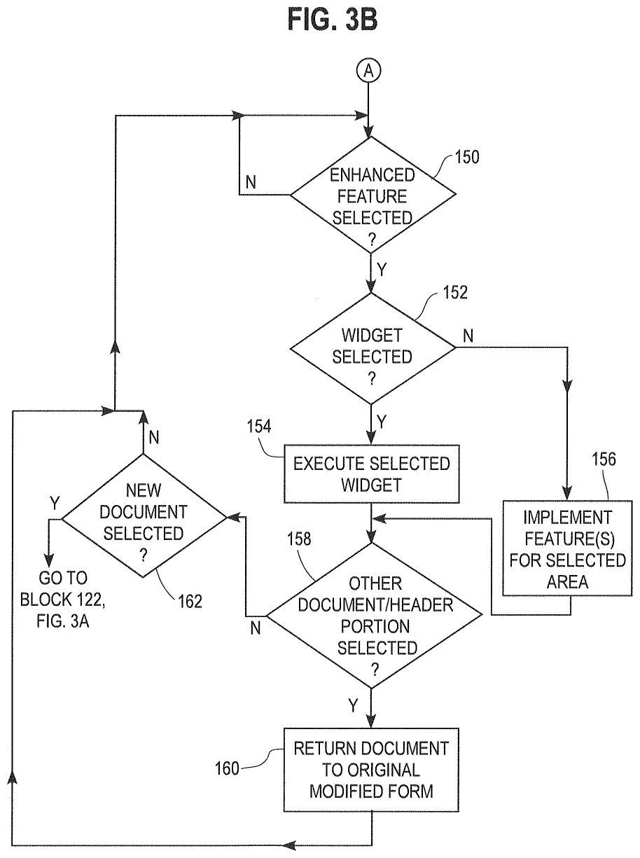

Referring also to the flowcharts of FIGS. 3A and 3B comprising programming executed by the client computer 68, once the data tagging is complete, a user may use a web browser having the plug-in or extension that enables enhanced functionality on the client computer 68 to log onto a supplier's website server 70, such as the server 70a, using a supplier-issued and maintained login name and password (using any authentication scheme). If desired, the user may instead or additionally be prompted by the browser at any time to authenticate, for example, using Single Sign-On (SSO). The user may request that a document issued by the supplier be displayed. In response to such request, the supplier's website server 70 preferably issues an instruction to the client computer 68 to fetch the requested document from a server identified by a URL, such as the server 66. In the illustrated embodiment, the URL identifies not only the server 66 but also the document to retrieve from the database 64. In response to such request, the server 66 polls the database 64 via the server 66 to retrieve the requested document from the database and supply same to the client computer 68.

Thus, in the illustrated example, the user signs onto the web server 70a, which may be maintained by Universal Mortgage, navigates to an area of the associated website at which statements may be requested and viewed, and requests display of the summary sheet for the statement date of Mar. 15, 2019. As seen in FIG. 3A, once a block 120 receives the resulting instructions from the server 70a with the URL, a block 122 requests such display code/data from the database 64 via the server 66. In the preferred embodiment, the database 64 stores the pages in unmodified form (i.e., without enhanced features). A block 124 may thereafter cause the requested document (the document 90 in the illustrated embodiment) to be displayed on the monitor 76 in a first browser window.

Alternatively, the block 122 may instruct the server 70a to retrieve the data representing such document from a data store 100 maintained by Universal Mortgage and the web server 70a may provide such data to the browser on the client computer 68. The block 124 may then cause the requested document to be displayed on the monitor 76 without enhanced features in the first browser window, as seen in FIG. 2.

The page displayed on the client computer 68 is displayed in the first browser window having a header 126 including a plurality of icons 128a-128f, a search box or other area 130, and text “SuperDoc” at an area 132. A greater or lesser number of the same and/or different icons 128 may instead be displayed. In the illustrated embodiment the area 132 is disposed in the upper left-hand portion of the header 126 and may be clicked (i.e., selected) by the user at the client computer 68 using the mouse 72 or the user's fingertip or a stylus (if the display 76 is touch-sensitive). Such selection is detected by a block 136 and a block 138 causes the client computer 68 to issue a command to the server 66 to retrieve supplemental display code stored in the database 64 and associated with the page displayed on the client computer. The supplemental display code is developed by one or more programmers for each different document structure. In the illustrated example, the supplemental display code defines areas of the document that are to be displayed with highlighting and/or boxes that surround selected groups of displayed data. The supplemental display code is combined with the code/data defining the unmodified document, such as by Boolean combination(s) of the two data sets on a pixel-by-pixel basis, to create a modified document 139 that is displayed by the monitor 76. In the illustrated embodiment, the resulting modified document comprises the original unmodified document 90 with portions represented by the supplemental display code overlaid atop portions of the unmodified document 90. To that end, a block 140 requests that the supplemental display code be transmitted by the server 66 to the client computer 68 whereupon a block 142 causes the browser to display the modified document 139 on the monitor 76 in a second browser window wherein the availability of enhanced features is indicated in the page. Alternatively, the modified document 139 may be displayed in the first browser window. Thus, for example, as seen in FIG. 4, the document may include a plurality of areas 144a-144i having highlighting and box outlines added thereto to indicate that enhanced features are available through selection of the areas by a user-initiated action, such as a mouse click or a fingertip selection of the areas.

If desired, code/data for display of the entire modified document 139 may be supplied from the database 64 and the server 66 to the client computer 68, as opposed to transmitting supplemental code and combining the supplemental code with the code/data for the unmodified document 90. Further, some or all of the highlighting, box outlines, display in a different color, and/or other indication of enhanced feature capability in the areas 144a-144i may appear only when a cursor is hovered over such areas.

Once a block 150 (FIG. 3B) determines that a user has selected one of the areas 144a-144i or an icon 128, the search area 130, or other indicator in the header 126, a block 152 checks to determine whether the selected area/icon is associated with a widget. In the illustrated example, the areas 144a-144i and the icons 128c-128e are associated with widgets, while the icons 128a, 128b and the search area 130 are not. (The use of the term “widget” is intended to connote programming for implementing a particular functionality or set of functionalities, whether enhanced or not. The categorization of programming comprising a widget is not intended to be limiting in any way, inasmuch as any functionality could be considered to be implemented by a widget or another set of programming, such as the programming that implements any of the functionality afforded by selection of the areas 128a, 128b or 130. Accordingly, if the block 152 determines that the selected area/icon is associated with a widget then control passes to a block 154 that causes execution of the associated widget as described hereinafter. If the block 152 determines that the selected area is not associated with a widget, then a block 156 causes execution of code that implements other feature(s) (enhanced or not) associated with the selected area. When the blocks 154, 156 execute the widget or code, among other things, a dialog box, window, or other display structure is displayed, preferably in the second browser window, as noted in greater detail hereinafter.

Control from the blocks 154 and 156 passes to a block 158, which checks to determine whether the user of the client computer 68 has selected an area of the browser window where the dialog box, window, or other display structure is displayed other than the particular location associated with the respective widget or code. If this is determined to be true a block 160 causes the monitor 76 to display the document again in the form seen in FIG. 4. Control then returns to the block 150. Otherwise, a block 162 checks to determine whether the user has requested display of a different document in unmodified form. This may occur when the user switches to another browser window displaying the supplier's website and selects the relevant portion to request such document. If this is true then control returns to the block 122, FIG. 3A, whereupon the new document is displayed and the process repeats.

Detailed description of the operation of the blocks 154, 156 is presented below with reference to the examples of the indicated FIGS., it being understood that the examples should not be considered limiting, inasmuch as other functionality similar but not identical to such examples may be implemented.

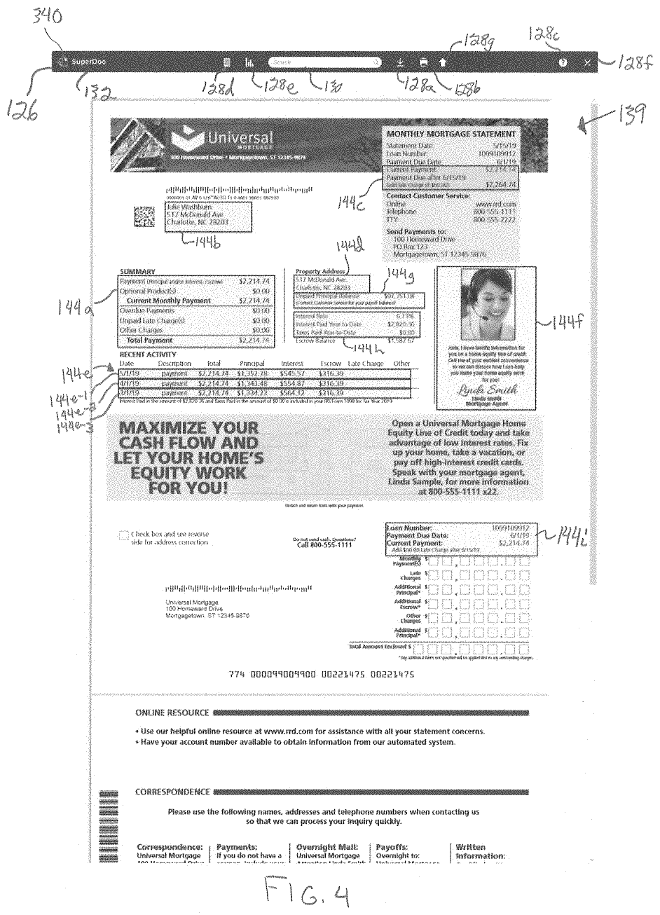

Referring next to FIGS. 4 and 5, selection of the area 144a of FIG. 4 (referred to as the “Summary” area) results in execution of a “Past Statement Balances” widget. The widget causes a dialog box or window “Past Statement Balances” 170 of FIG. 5 to open. It should be noted that selection of any of the areas 144 (and, optionally, any of the icons 128 or search area 130) may cause the document 139 of FIG. 4 to remain displayed below (i.e., underlying) the dialog box, window, or other display element that is displayed in response to such selection. Alternatively, selection of any of the icons 128 or any of the areas 144, 130 may result in a dialog box, window, or other display structure being displayed in a separate window. Further, the document 139 seen in FIG. 4 is also preferably, although not necessarily, displayed in grayed-out form when a dialog box, window, or other display structure is being displayed. In the illustrated embodiment, the dialog box or window 170 includes a plurality of bar icons 172a-172f, each representing a principal amount remaining due at a particular time on a loan obtained by the addressee identified in the area 144b of FIG. 4. Thus, for example, the bar icon 172c indicates that as of March 2019 (i.e., the current month), $100,661.56 of principal remained due on loan number 1099109912 whereas bar icon 172f indicates that as of December 2018, $105,558.42 of principal remained on the same loan.

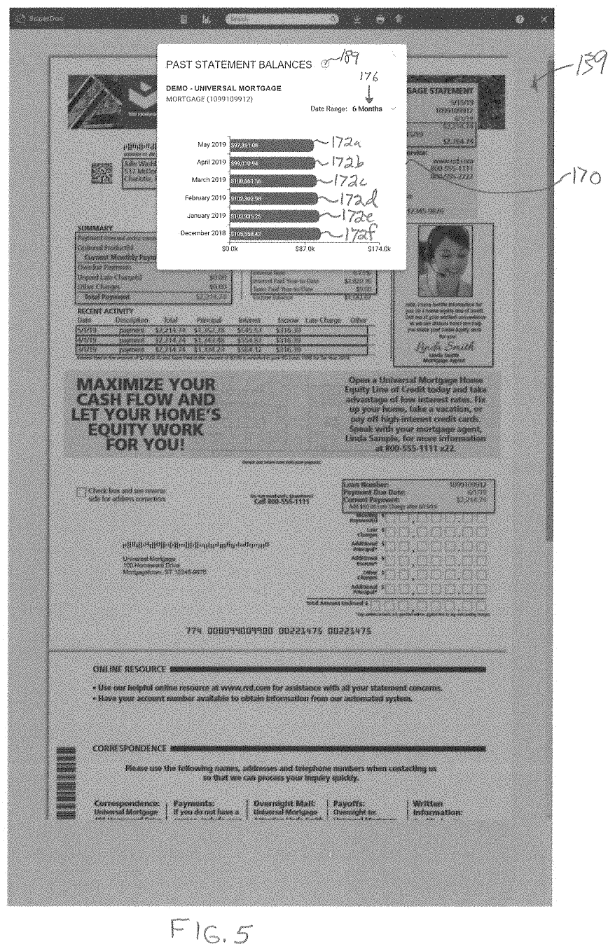

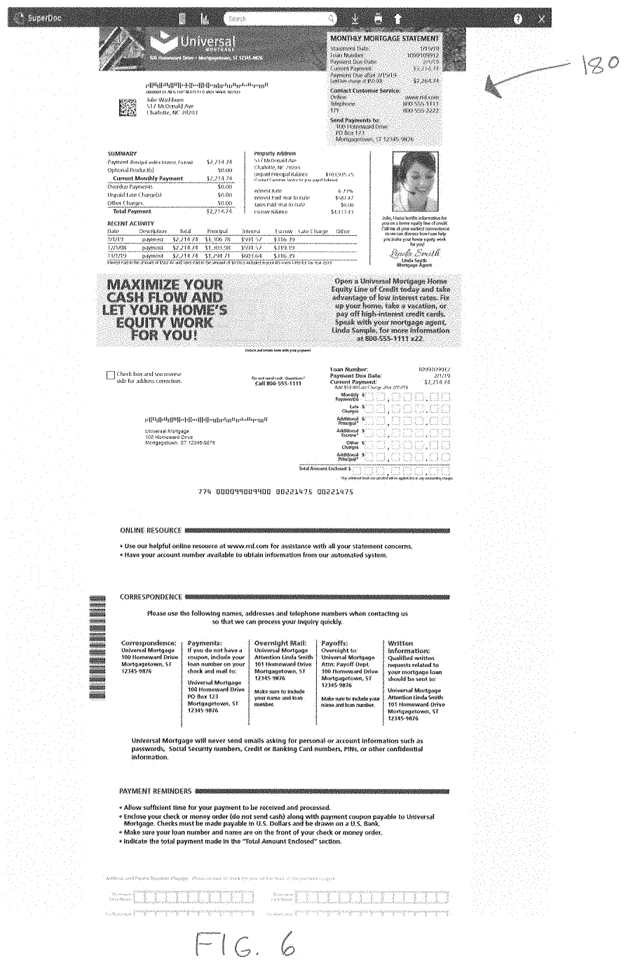

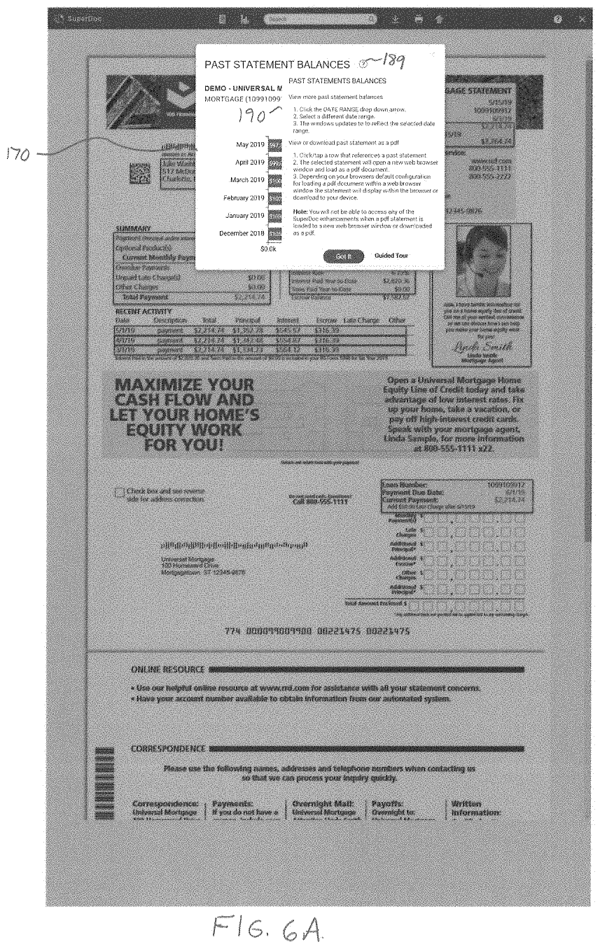

The number of displayed bar icons is selectable by the user by selecting a date range area 176, which permits selection of a particular period of time, such as number of months for display up to a maximum, e.g., six months, twelve months, or more. If necessary, a scroll bar may be selectable to scroll down to months that could not otherwise be displayed due to size constraints. Selection of one of the bar icons 172, e.g., the bar icon 172e, by the user results in display of a corresponding document 180 from the selected month (i.e., January 2019), preferably in a separate window (FIG. 6) or tab and/or download of the document 180 in pdf form to the device 68 (depending on browser default configuration). In the illustrated embodiment, the document 180 is identical to the document 90 of FIG. 2 with the exception that the document 180 is populated with data current as of January, 2019, although a different document and/or different data may instead be displayed, particularly if the document structure has changed in the interim. The document 180 may be stored as a pdf on the server 64 and may be retrieved therefrom by a suitable command issued to the server 66 or may be retrieved from the data store 100 via the server 70a, as in the case of the document 90. While the document 180 is shown in FIG. 6 as not having enhanced features associated therewith, the document 180 may have one or more enhanced features, for example, those described herein, if desired.

Referring again to FIG. 5, the dialog box or window 170 further includes a “?” (or help) icon 189 which, when selected, causes a further dialog box or window 190 of FIG. 6A to open. The dialog box or window 190 is preferably opened in the same window as the dialog box or window 170 overlying the latter or in a separate window. The dialog box or window 190 includes text that provides the user with details concerning the operation of the dialog box or window 170.

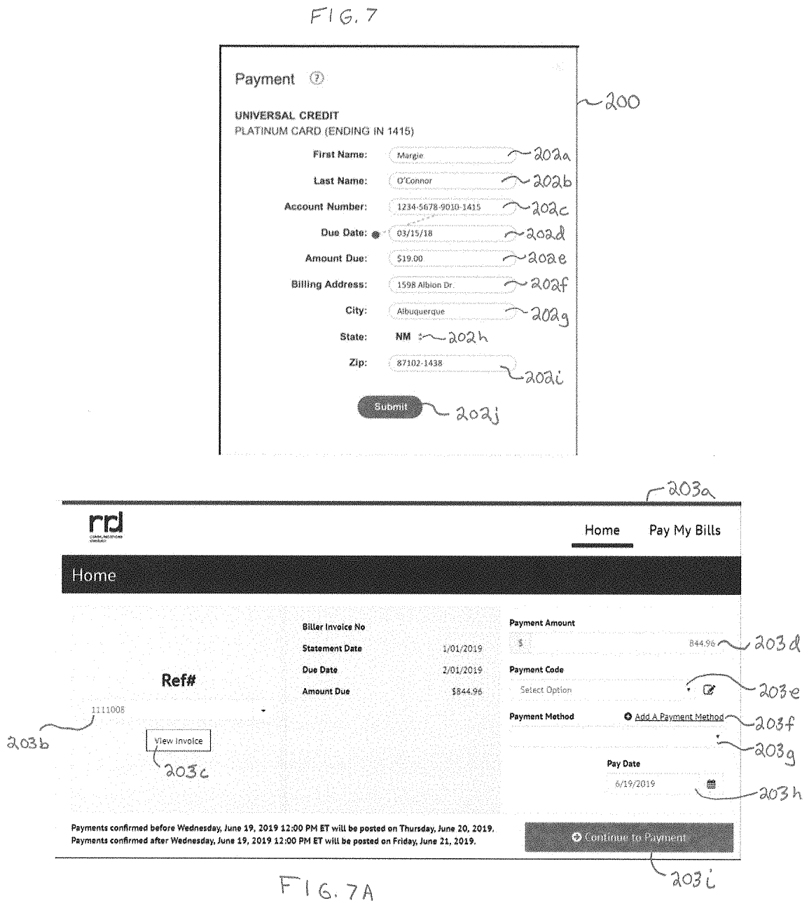

Referring next to FIG. 7, selection of the area 144c of FIG. 4 causes a payment widget to open a dialog box or window “Payment” 200. (In the illustrated embodiment, the same widget is operable when the area 144i is selected). The dialog box or window 200 includes a plurality of data fields 202a-202i in which one or more of a plurality of data such as:
First Name;
Last Name;
Full Name;
Billing Address;
City;
State;
Zip Code;
Minimum Amount Due;
Due date;
Balance/Full Amount Due; and
Account number

may be auto-populated. (In the example of FIG. 7, only a subset of these data is entered into fields). One or more of the data fields 202, for example, the state data field 202h, may be populated by a user selecting from a drop-down box. Populated data fields 202 may be manually corrected by the user, if desired. The dialog box or window 200 also includes an area 202j that, when selected, opens a further dialog box or window 203a in which the user may specify a payment amount, a method of payment, and schedule submission of such payment. In particular, the dialog box or window 203a includes an area 203b that, when selected, displays a pop-up menu of one or more reference number(s) or other identifier(s) associated with outstanding invoices from which the user may select a reference number of an invoice to pay. After selecting such reference number, the user may select an area 203c to open a dialog box or window (not shown) in which the invoice associated with the selected reference number is displayed.

The dialog box or window 203a further includes an area 203d in which the user may enter an amount to be paid. In some embodiments, such area 203d may be pre-populated with the total amount due. In some embodiments, if the area 203d is pre-populated in this manner, the user may be allowed to enter a different amount in such area. In some embodiments, the dialog box or window 200 may include an area 203e that, when selected, displays a list of payment codes associated with the amount being paid. Such payment code may be customizable by the entity that supplied the invoice to identify different reasons why a payment may be made.

The dialog box or window 203a includes an area 203f that, when selected, allows the user to specify one or more payment methods. In particular, referring also to FIG. 7B, selecting the area 203f displays a dialog box or window 204a. The dialog box or window 204a includes areas 204b-204g, each one associated with a particular payment method (e.g., a bank account, a credit/debit card, etc.). Although the dialog box 204a shows six payment methods, one of ordinary skill in the art may realize that more or fewer payment methods may be presented in such dialog box or window 204a. Selecting one of the areas 204b-204g expands the dialog box or window 204a to accommodate an additional area 204h just below such selected area. For example, as shown in FIGS. 7B and 7C, if the user selects the area 204b (FIG. 7B), the dialog box 204a is expanded as shown in FIG. 7C and the area 204h in inserted just below the selected area 204b.

The inserted area 204i includes a plurality of areas in which the user may enter information regarding the payment method associated with the selected area 204b-204g. For example, if such payment method is a bank account, the plurality of areas in the inserted area 204i may have areas in which to enter bank account information. If such payment method is a credit/debit card, the inserted area 204i may have areas in which to enter credit/debit card information. If such payment method is an online payment system (e.g., Pay Pal, Google Pay, Amazon Pay, Apple Pay, and the like), the inserted area 204i may have areas in which credentials or other information associated with such online payment system may be entered.

After entering information associated with the payment method in the area 204h, the user may select an area 204j. Selecting the area 204j stores the information associated with the payment method in one or more entries associated with the user in, for example, the database 64 (FIG. 1), the data store 100 (FIG. 1), and/or another data store (not shown). In some embodiments, the information entered by the user in the inserted area 204i is validated with the selected payment provider for accuracy before being stored. If such data cannot be validated, an error message may be displayed in an area (not shown) of the dialog box or window 204a or in another dialog box or window (not shown) and the user may be provided an opportunity to correct any incorrect information in the inserted area 204i.

Returning to FIG. 7A, the dialog box or window 203a includes an area 203g that, when selected, displays a pop-up list of payment methods the user has entered by selecting the area 203f. The user may then select one such payment method with which to submit payment for the invoice. It should be apparent to one who has ordinary skill in the art that the user need only enter and store a particular payment once and thereafter such payment method may be used to pay multiple invoices at different times.

The dialog box or window 203a includes an area 203h by which the user may specify a date when the invoice should be paid. In some embodiments, the user may type in a date in the area 203h. In other embodiments, selecting the area 203h may display a calendar (not shown) from which the user may select the date.

The dialog box or window 203a includes an area 203i that, when selected, schedules submission of a payment in accordance with the information entered by selecting the areas 203b and 203d-203h.

Alternatively, a supplier may decide to allow a user to use a hotlink that directs the user to a third-party payment portal or landing area to make a payment toward his/her statement. In either event the payment portal window may be maintained by the third party with the foregoing information, which may be auto-populated into the portal window or landing area.

It should be noted that the above information fields are standard fields that should be gathered in a standardized format for the payment portal. The account number may be omitted in the case of certain document types. Balance/Full Amount Due may be used if the Minimum Amount Due is not present. Further, the availability of making payment by bank account and credit card may be dependent on the document type (i.e., mortgage, credit card, utility, etc.).

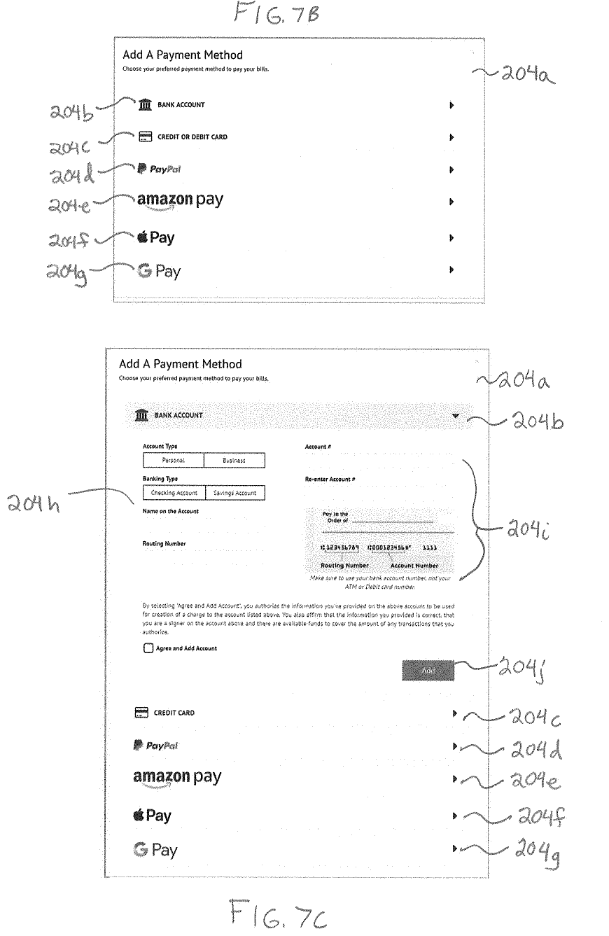

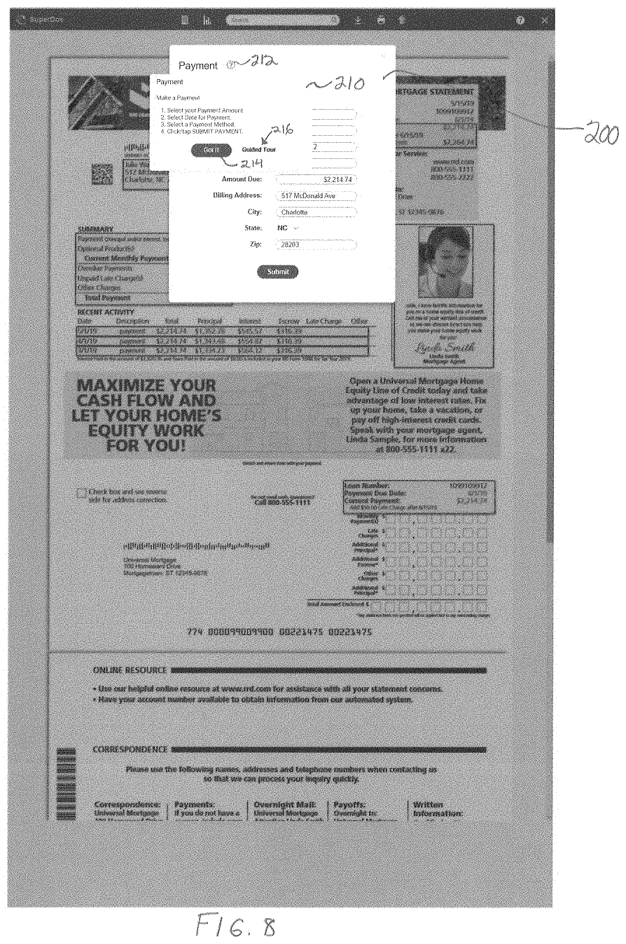

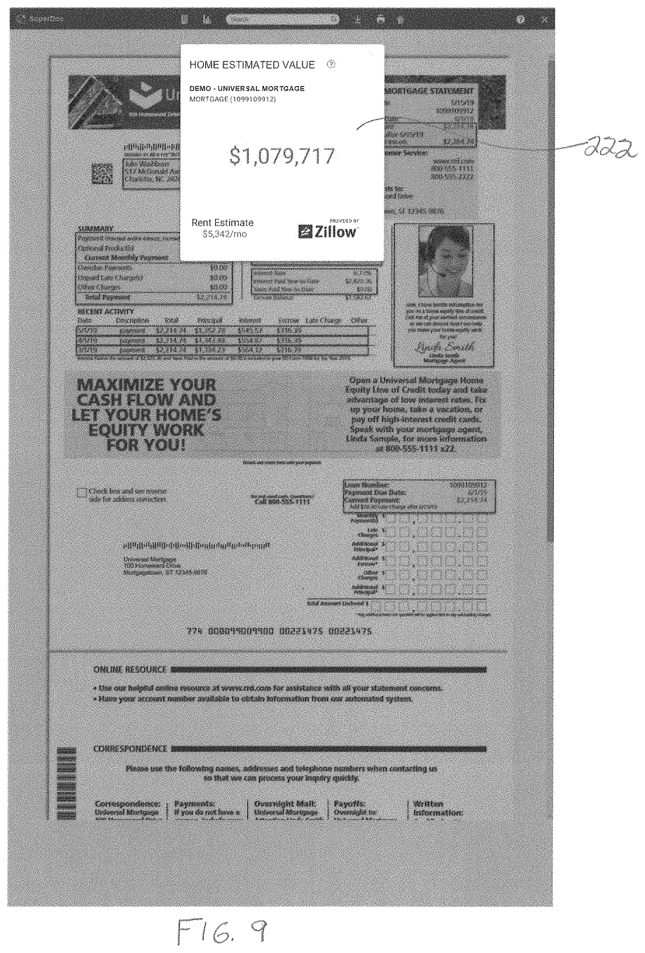

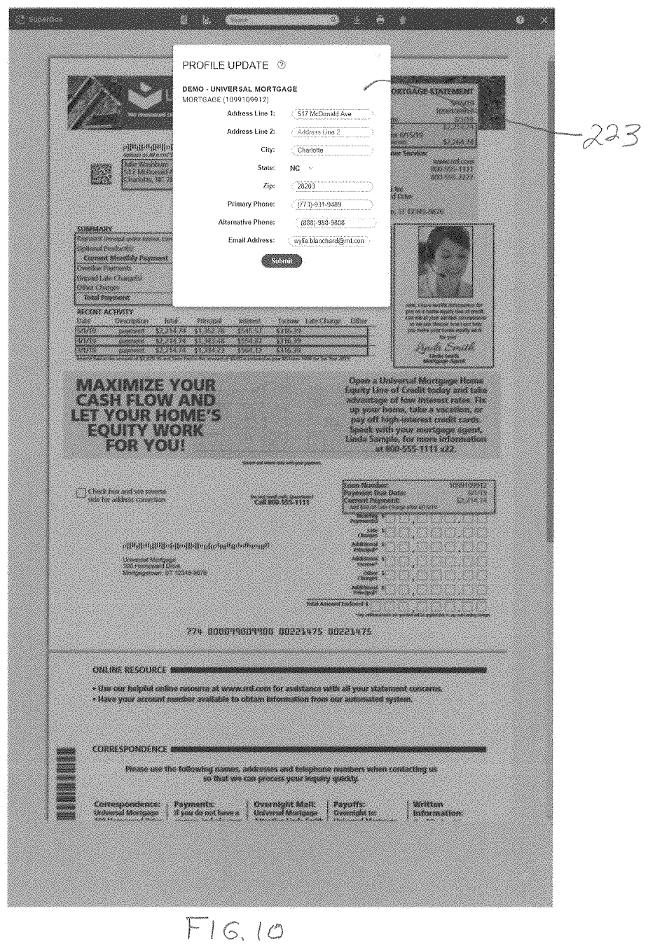

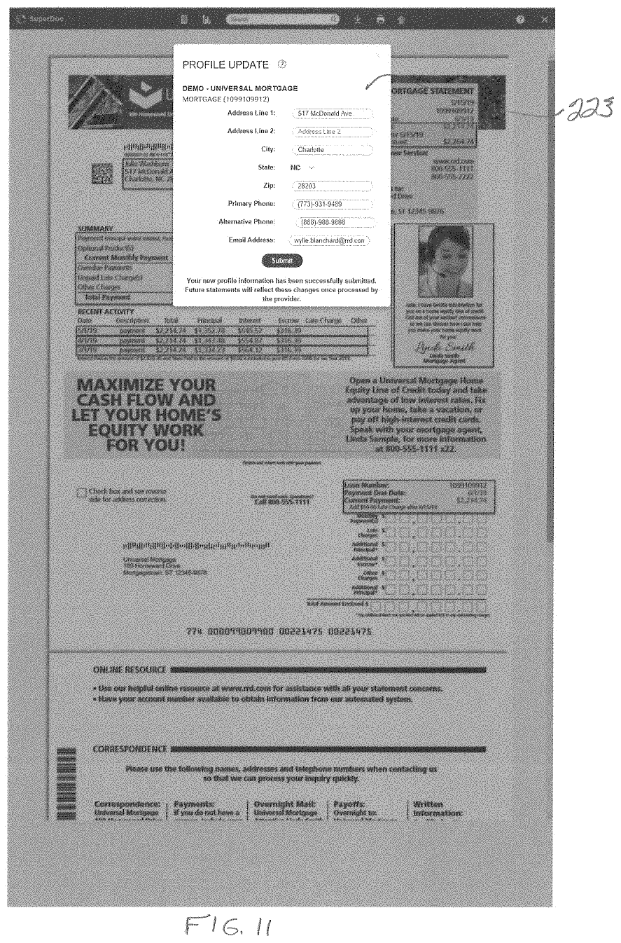

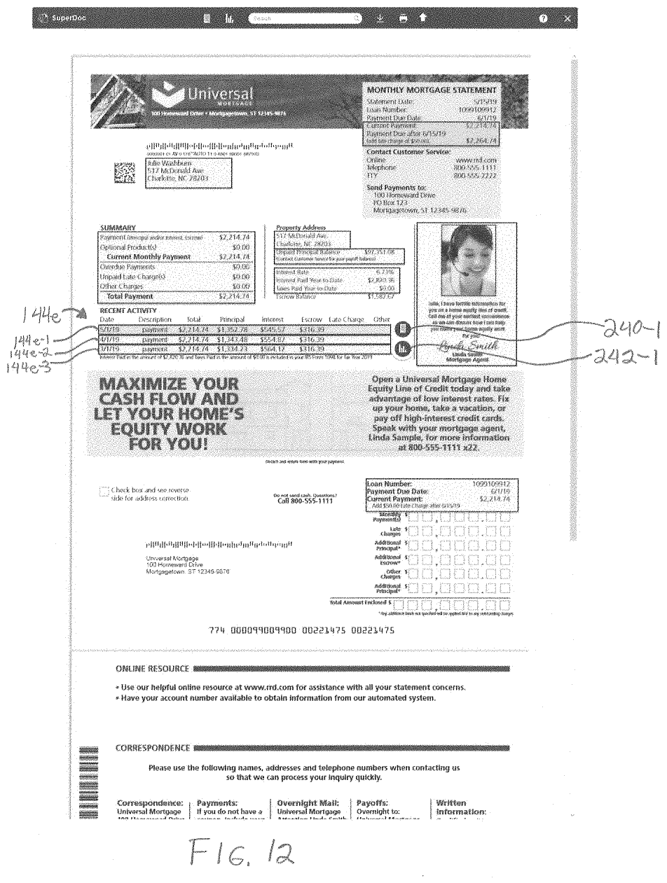

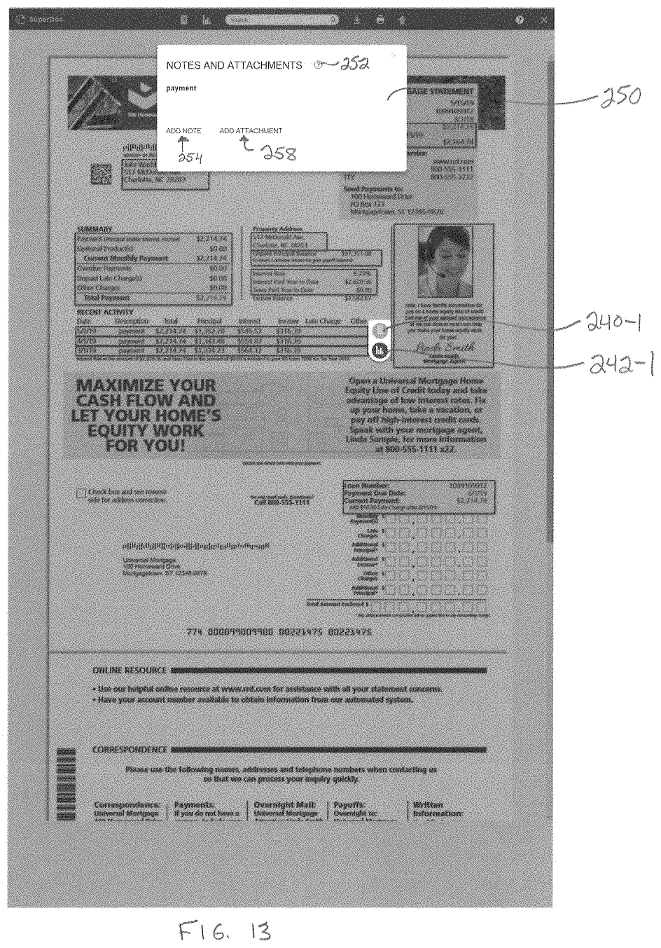

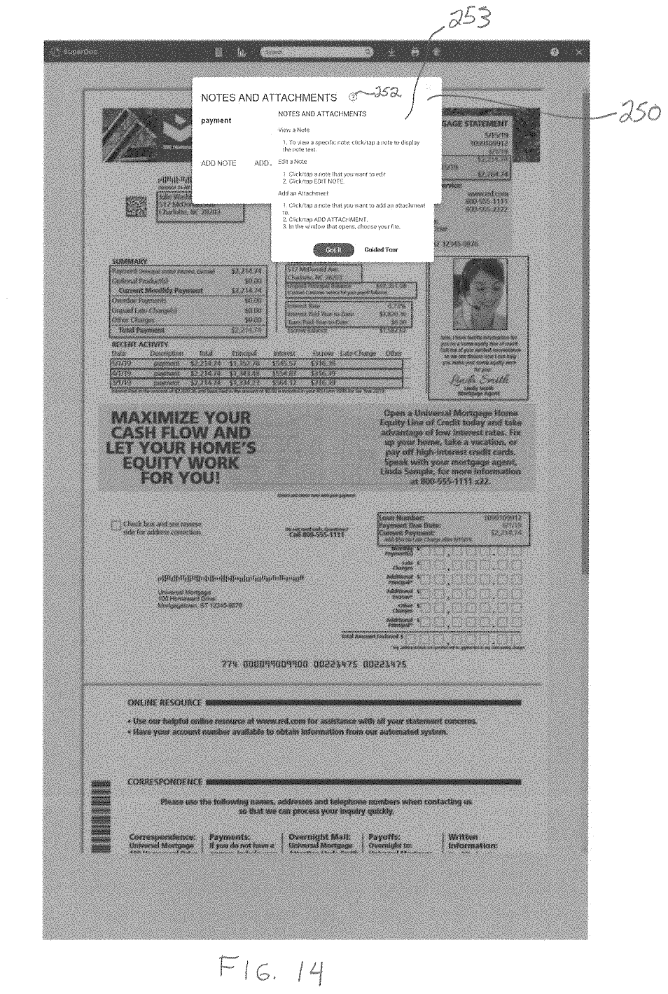

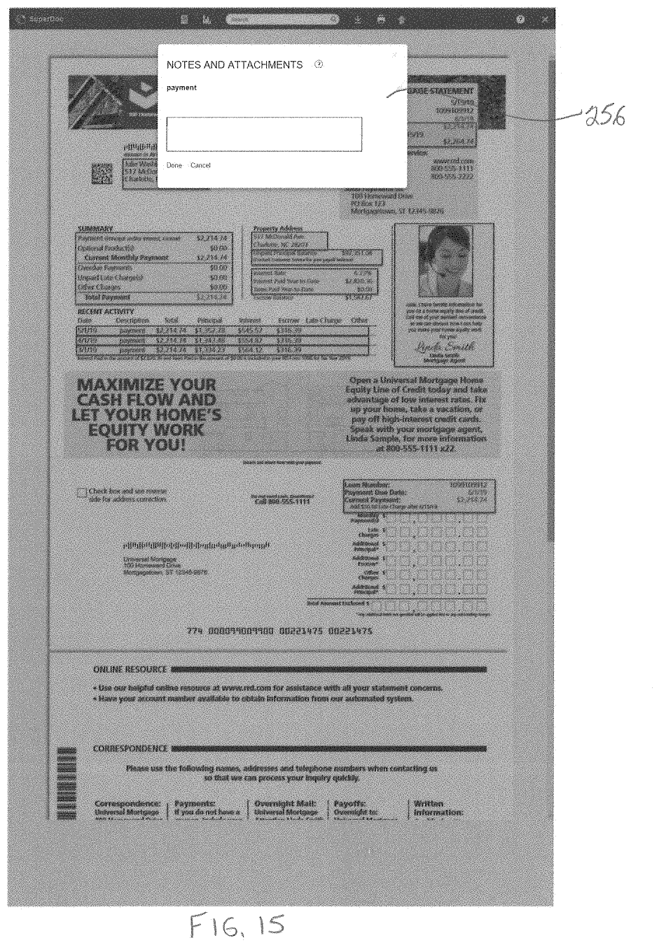

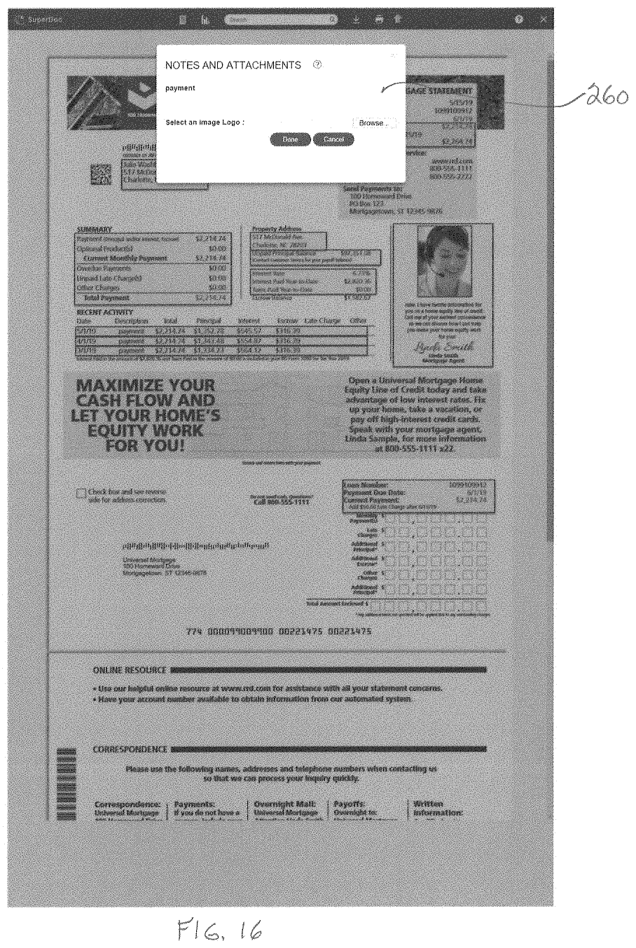

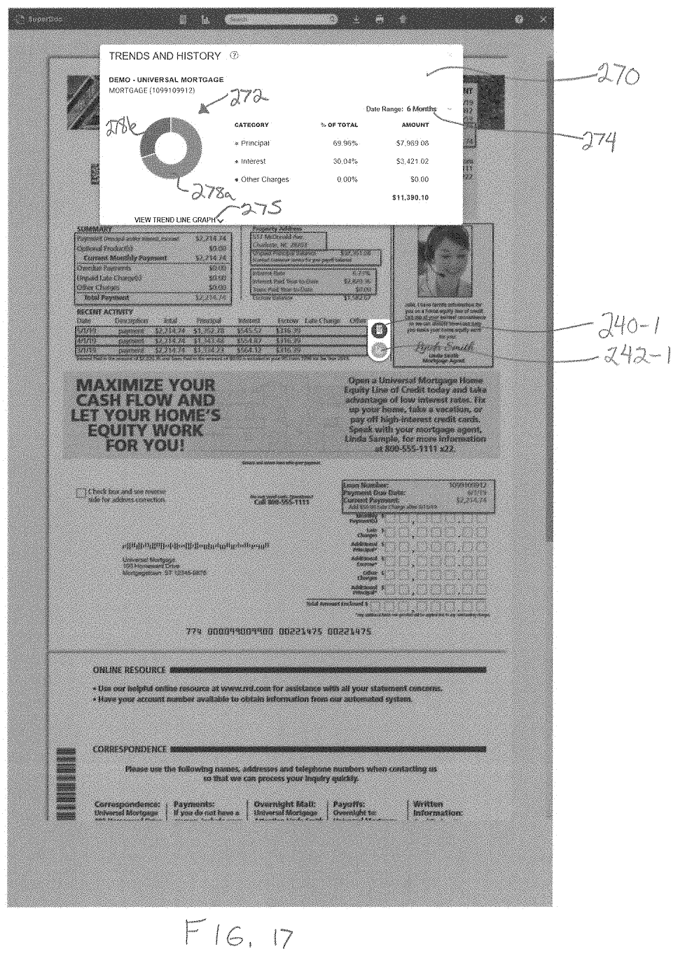

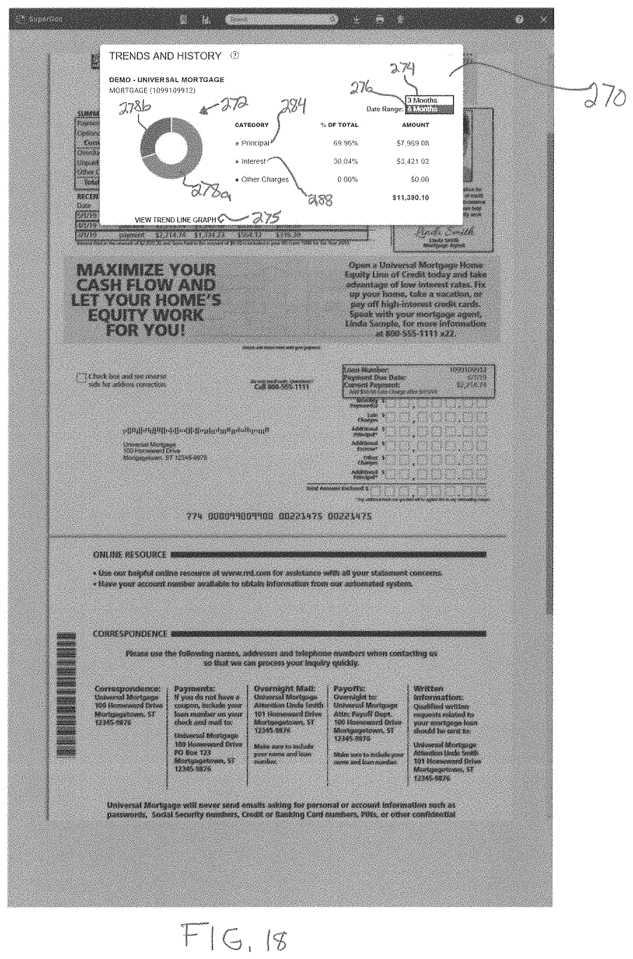

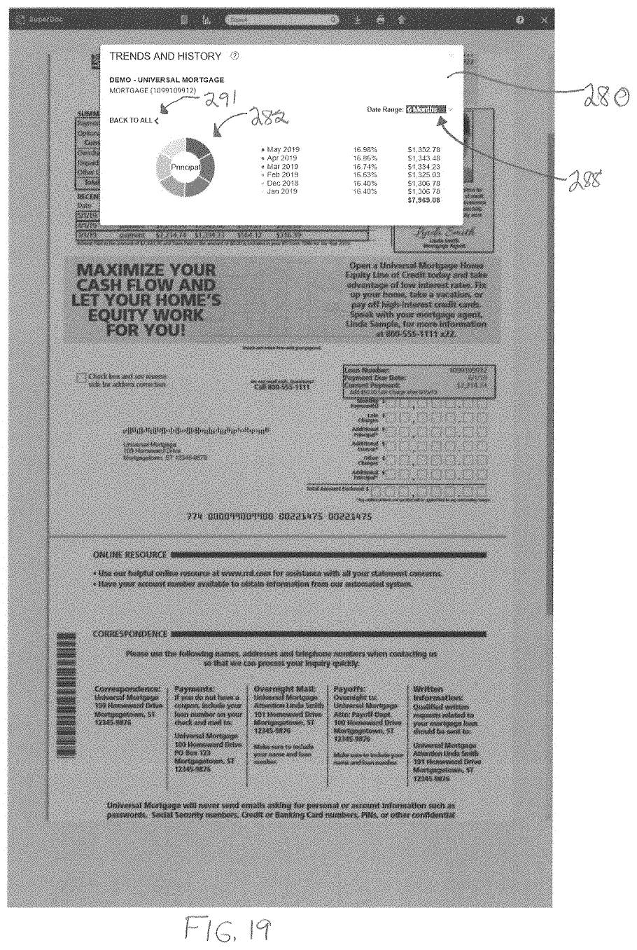

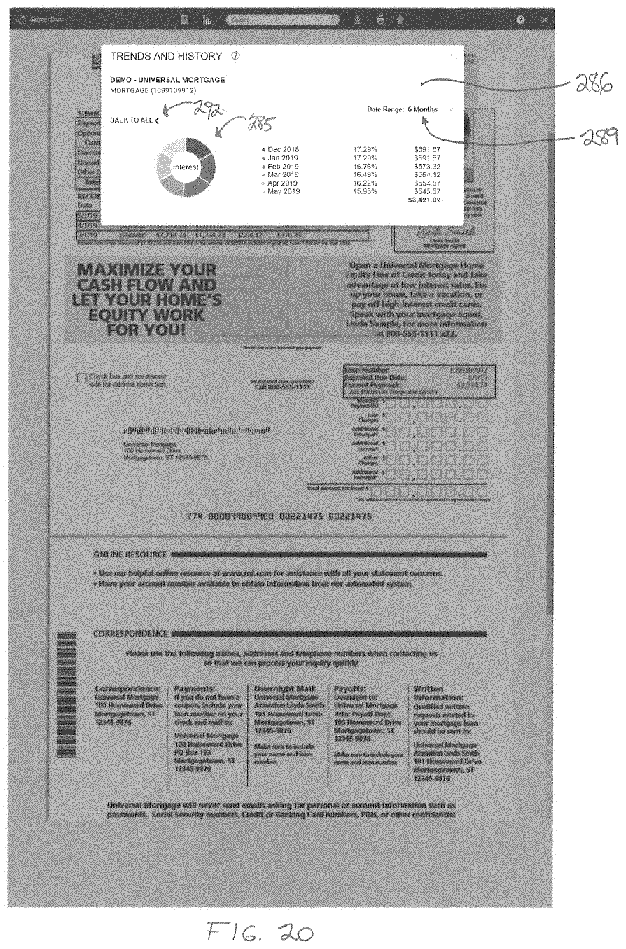

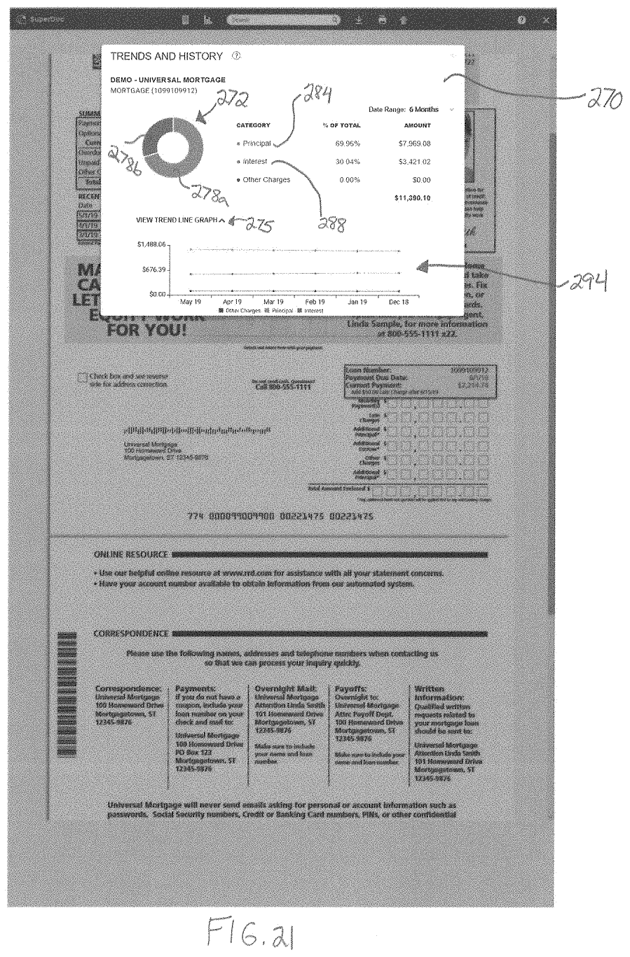

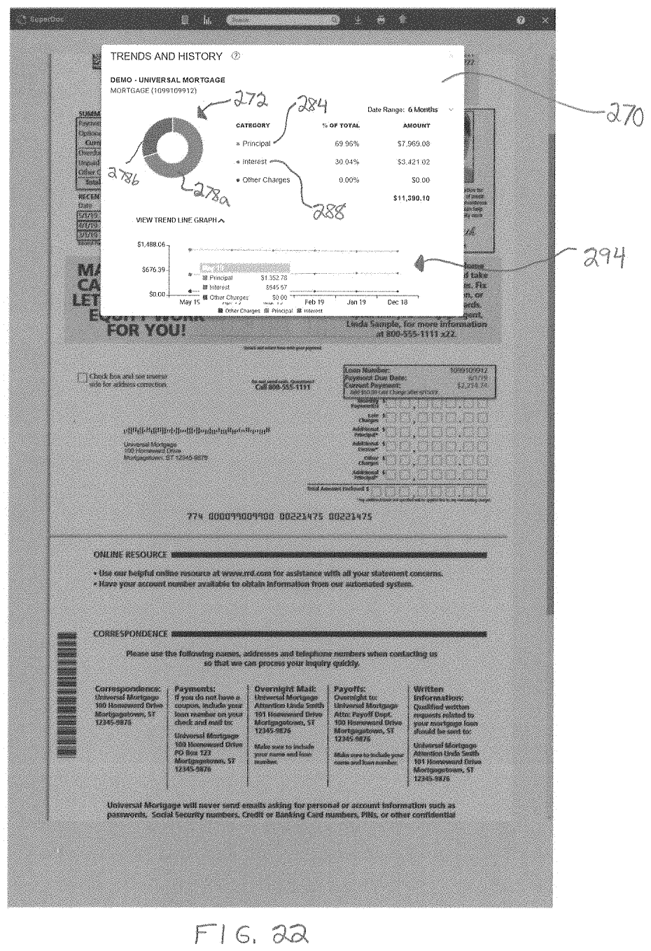

FIG. 8 shows a dialog box or window 210 that is opened when a help icon 212 of the dialog box or window 200 is selected. The dialog box or window 210 includes instructions comprising steps 1-4 for filling out the data fields of FIG. 7, a clickable text button 214 labeled “Got It” and a further clickable text button 216 labeled “Guided Tour.” Selecting the button 214 returns the user to the display of FIG. 7 whereas selection of the button 216 results in display of a guide concerning the enhanced features available when selecting the icons 128, as noted in greater detail hereinafter.

The dialog boxes or windows 190, 210 that are displayed when the help icons 189, 212 are selected are context-sensitive, as are other dialog boxes or windows opened by selection of other help icons in other dialog boxes or other windows. Further description of dialog boxes, windows, or other display structures in response to selection of a help icon or area will not be provided herein, it being understood that selection of a help icon or area may result in the display of one or more dialog boxes, windows, or other display structures that may have one or more items that may be selected to invoke the display of yet further dialog boxes, windows, or other display structures, and so on.

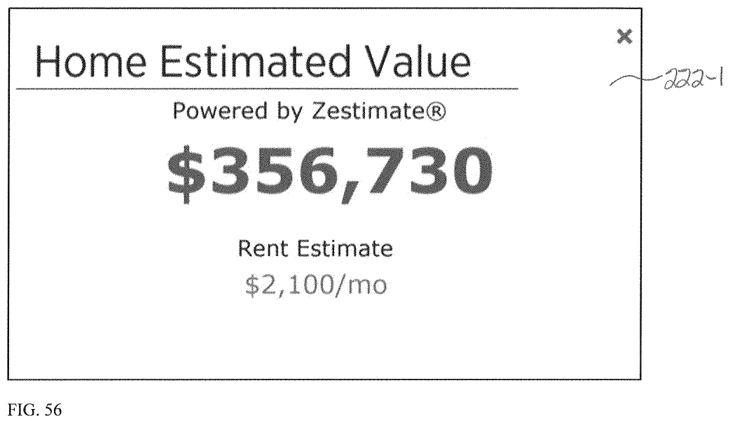

FIG. 9 illustrates an enhanced feature available when the area 144d is selected. In contrast to the functionality afforded by selection of the remaining areas 144a-144c and 144e-144i wherein data are supplied by the database 64 and the server 66, selection of the area 144d results in the browser on the client computer 68 establishing contact with a vendor web server 220 (FIG. 1) and requesting data therefrom. In the illustrated embodiment, the web server 220 is operated and maintained by a third-party vendor, which provides an application programming interface (API) to allow access to features offered by the third-party. In the illustrated embodiment, selection of the area 144d results in display of the dialog box or window 222 of FIG. 9 indicating the value of the home at the addressee location as estimated by a vendor, such as Zillow. Alternatively, a dialog box or window 222-1 of FIG. 56 may be displayed having an estimated home value and rent estimate.

If desired, the third-party's name/logo may be displayed as a hyperlink in the dialog box or window 222 that directs the user to the third-party's website.

Set out below is a summary of the widgets/features that are executed when the remaining areas 144b, 144e-144i or the icons 128a-128e, or the search area 130 is/are selected:

Profile Update widget (operable when the area 144b is selected):

This widget allows a user to update user contact details, and optionally, user personal preferences (notification options, plain-text v. HTML email formats, paperless delivery enrollment, etc.).

As seen in FIG. 10, the “Profile Update” widget displays a dialog box or window 223 listing the account holder's address, phone, and email connect information as currently registered with the supplier. The data may be modified by selecting fields and typing/selecting as appropriate. Thus, for example, a user may select a different state via a “State” drop-down box, type into a “Primary Phone” text box, type a new email address into an “Email Address” text box, etc. The user may select the “Submit” button, and, upon successful receipt of the modified information, the user may receive a message “Submitted Successfully” (FIG. 11). The widget may also display check boxes or other selection display structures in the form of FIG. 10 that allow a user to select communication preference options, such as document delivery options, notification options, etc. and sends such user selection(s) back to the supplier.

Recent Activity Area 144e

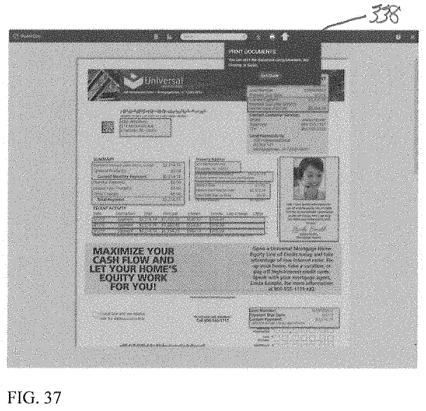

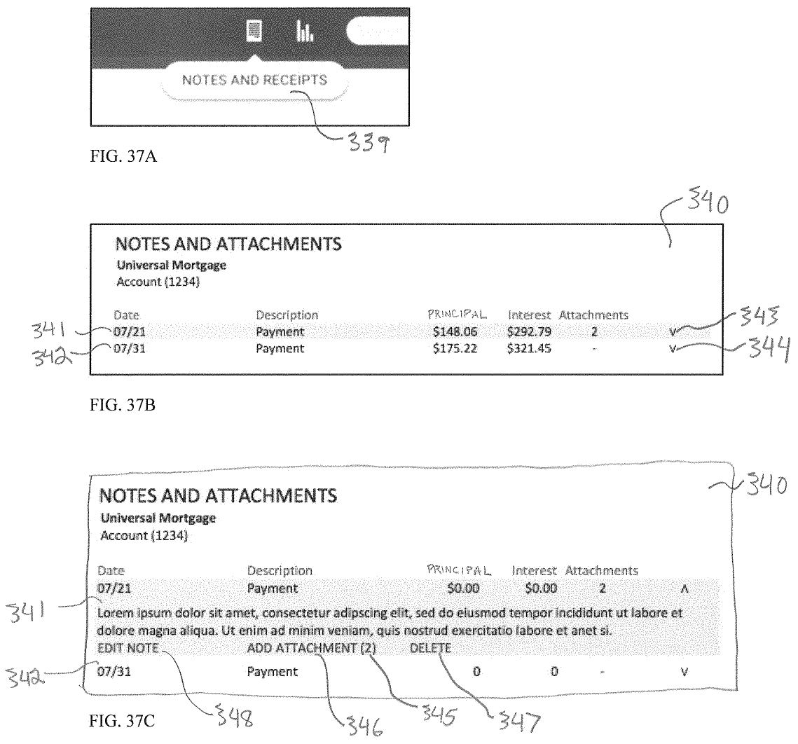

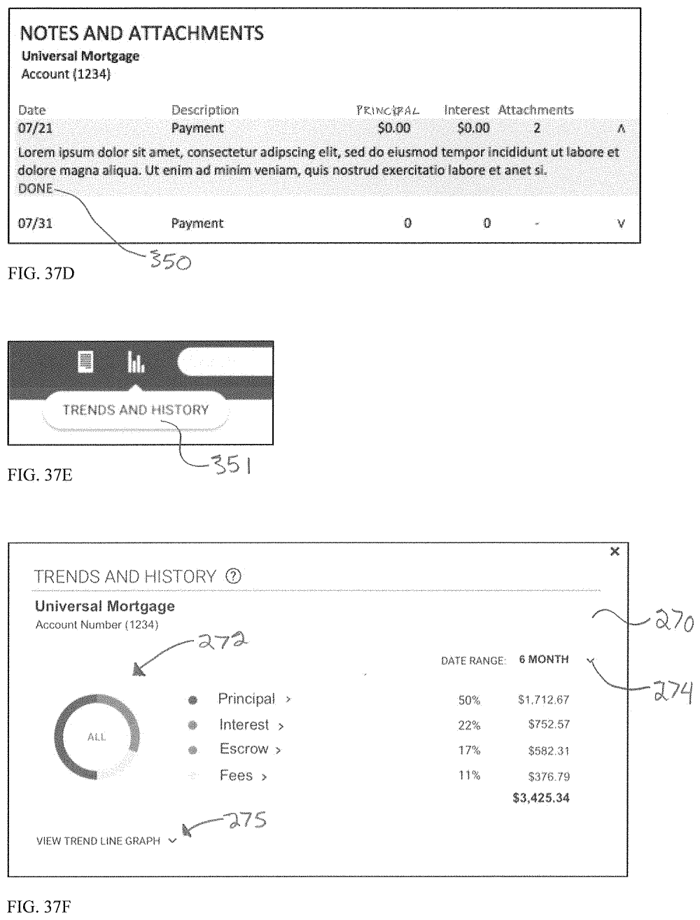

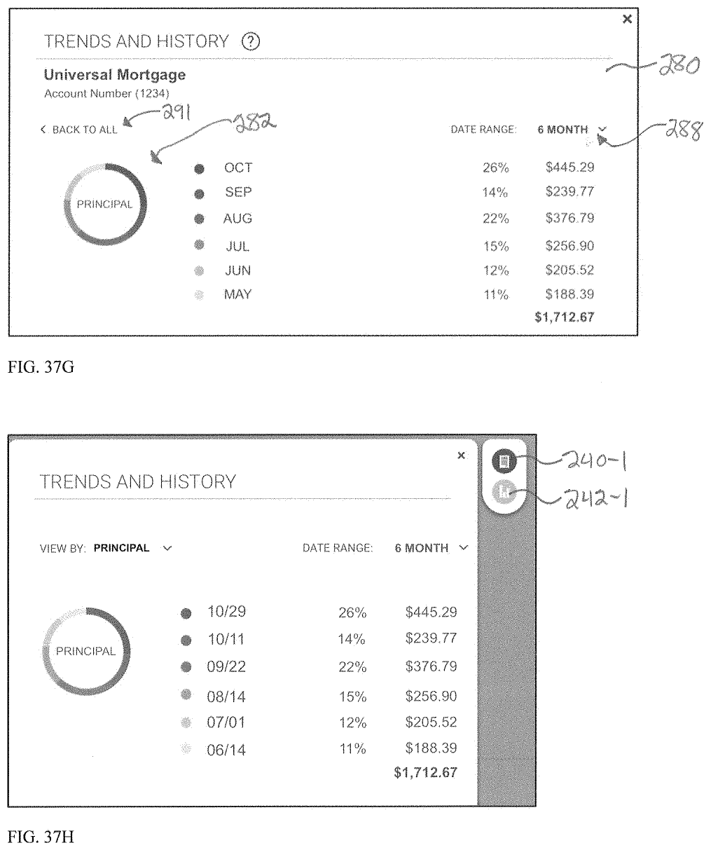

Referring to FIG. 12 the area 144e is subdivided into a particular number of sub-areas. In the illustrated embodiment there are a plurality of sub-areas, for example three, 144e-1, 144e-2, and 144e-3, although there may be a different number of sub-areas and the sub areas may be accessible by a scrolling functionality. In the illustrated embodiment, hovering a mouse pointer over each of the three sub-areas 144e-1, 144e-2, or 144e-3 causes a plurality of icons, for example two, 240-1, 242-1 or 240-2, 242-2, or 240-3, 242-3, respectively, to appear adjacent the respective sub-area 144e-1, 144e-2, or 144e-3 (FIG. 12 illustrates the icon pairs 240-1, 242-1 while the sub-area 144e-1 is being hovered over), although there may be a different number of icons. Further selection of one of the icons 240, such as the icon 240-1, causes execution of a “Notes and Attachments” widget that displays the dialog box or window 250 of FIG. 13. If a note and/or attachment already exist and have been uploaded, then the “Notes and Attachments” widget may display a dialog box or window having the note(s) displayed therein and allowing access to the previously-stored attachments, for example, as shown and described in FIGS. 37B-37D hereinafter.

Selecting a help icon 252 displays a dialog box or window 253 (seen in FIG. 14) including instructions for using the features of the dialog box or window 250 (and the features of dialog boxes or windows 256, 260 described below). Alternatively, selecting a hyperlink “Add Note” 254 (or a similar link, such as “Add/Edit/Delete Note”) causes display of a further dialog box or window 256 (FIG. 15) that permits a user to create, view, edit, and delete notes related to the user's activity. Still further, selection of an “Add Attachment” hyperlink 258 (or “Add/Delete Attachment” or another similar hyperlink) causes display of yet another dialog box or window 260 (FIG. 16) that permits a user to upload a document, such as a statement, or optionally, delete existing document(s).

Uploaded notes and attachments are stored in the database 64 in the DC+ environment. As a result, the uploaded notes and attachments are associated with the related user data and pdf file size is not impacted.

Referring again to FIG. 12, selection of one of the icons 242, for example, the icon 242-1, results in execution of a “Trends and History” widget that displays the dialog box or window 270 of FIG. 17. The dialog box or window 270 displays summary information for a particular selectable period of time (the default may be six months). The widget permits a user to analyze activity from the past statements to the current statement, organizes content into easy to understand categories, and drill-through to sub-categories and individual activity-line items

Specifically, in the illustrated embodiment, a donut chart icon 272 and/or other representation of principal, interest, and other charges for the last six months is shown in FIG. 17. A Date Range drop-down box 274 (also seen in FIG. 18) may be actuated by selecting a hyperlink 276 to permit selection of a different date range, such as three months. The user may select a portion 278 of the donut chart icon 272 to display monthly data for a selected parameter associated with the donut chart portion 278. Thus, for example, the user may select a donut chart portion 278a associated with “Principal” to cause the widget to display a dialog box 280 (FIG. 19) having text and one or more representations, such as donut chart 282, indicating the amounts of principal and percentage of principal paid expressed as a ratio of total payment paid by the user for each of the six months up to the current statement date. The dialog box or window 280 may be alternatively or in addition be displayed in response to selection of a hyperlink “Principal” 284 of FIG. 18. Alternatively, the user may select a donut chart portion 278b of FIG. 18 associated with “Interest” to cause the widget to display a dialog box or window 286 (FIG. 20) having text and one or more representations, such as donut chart 285, indicating the amounts of interest and percentage of interest paid expressed as a ratio of total payment paid by the user for each of the six months up to the current statement date. The dialog box or window 286 may be alternatively or in addition be displayed in response to selection of a hyperlink “Interest” 288 of FIG. 18. If other charges were paid in the selected time period, a corresponding dialog box or window may be displayed by selecting the corresponding portion of the donut chart 278 or by selecting a hyperlink “Other Charges” seen in FIG. 18.

The number of months that are displayed by the dialog boxes or windows 280, 286 is determined by the selected date range using drop-down boxes 288, 289, respectively, identical to the drop-down box 274 of FIG. 17. Further a user may return from the dialog boxes 280, 286 to the dialog box or window 270 of FIG. 18 by selecting a “Back to All” hyperlink 291, 292 in dialog boxes or windows 280, 286, respectively.

Referring again to FIG. 18, the user may select a further hyperlink 275 to cause the dialog box or window 270 to display historical data concerning principal, interest, and other charges paid by month as a line or graph chart 294 (FIG. 21). (This functionality is only available for certain document types). The line or graph chart 294 shows how the payment dollar amount for each of the top five (or other number) transaction categories (Principal, Interest, Escrow, Fees, etc.) has changed over time. The line or graph chart's y-axis (vertical) represents the total payment dollar amount and the x-axis (horizontal) represents the statement month. Each data point represents a total payment amount applied to a specific transaction category for a specific statement date. Each series of data points connected by a straight line represents how a specific transaction category's total payment amount has changed over time. For instance, if the user selects the date range of 6 months, the transaction category Principal will display 6 data points connected by straight lines that identify the total dollar amount applied to the principal for each statement that was issued within the last 6 months. If there is no payment for a specific month then the data point will equal zero dollars.

The user may use a mouse to hover over portions of the dialog boxes or windows 270, 280, 286 to cause display of data. Thus, for example, hovering over the portion 278a, 278b causes display of the corresponding principal or interest as shown in FIGS. 23A, 23B, respectively, that was paid expressed as a ratio of total payments for the selected time period. The user may also hover over portions of the line chart 294 of FIG. 21 to display summaries of amounts paid by month (for example, as seen in FIG. 22) or may hover over portions of either of the donut charts 282 or 285 (for example, as seen in FIGS. 24 and 25) to display the principal and interest, respectively, that was paid in a corresponding month expressed as a ratio of total payment for that month.

Customer Service Agent Area 144f

Selecting the area 144f of FIG. 4 causes execution of a “Deals and Offers” widget that displays a dialog box or window 300 as seen in FIG. 26. The dialog box or window 300 in turn displays external content, such as as text, images, video, audio, etc. In the illustrated embodiment the widget displays a “USA Home Mortgage” image as seen in FIG. 26 that promotes new service/product offerings, money saving tips, refinance offers, etc. The dialog box or window 300 may have hyperlinks, icons, and/or other display structures that, when selected, link the user to a third-party website using an API. Alternatively, selecting one of these display structures may link the user to the server 66 or another server.

Unpaid Principal Balance Area 144g

Selection of the area 144g of FIG. 4 causes a “Loan to Value” widget to be executed that displays a dialog box or window 304 (FIG. 27). The widget obtains an estimate of the current balance remaining on the user's loan, obtains an indication of the value of the home (e.g., from a third-party as when the area 144d is selected), and calculates a ratio of the current loan balance to the estimate of the home value. The Loan to Value ratio is calculated as the lien (current mortgage amount or current amount owed on the property) divided by the appraised value of the property, expressed as a percentage.

For example, a borrower taking on a $92,500 mortgage to purchase a home appraised at $100,000 would have a loan-to-value ratio of 92.50% (92,500/100,000). The ratio is displayed in the dialog box or window 304.

If desired, the third-party's name/logo may be displayed as a hyperlink in the dialog box or window 304 that directs the user to the third-party's website.

Interest Rate Area 144h

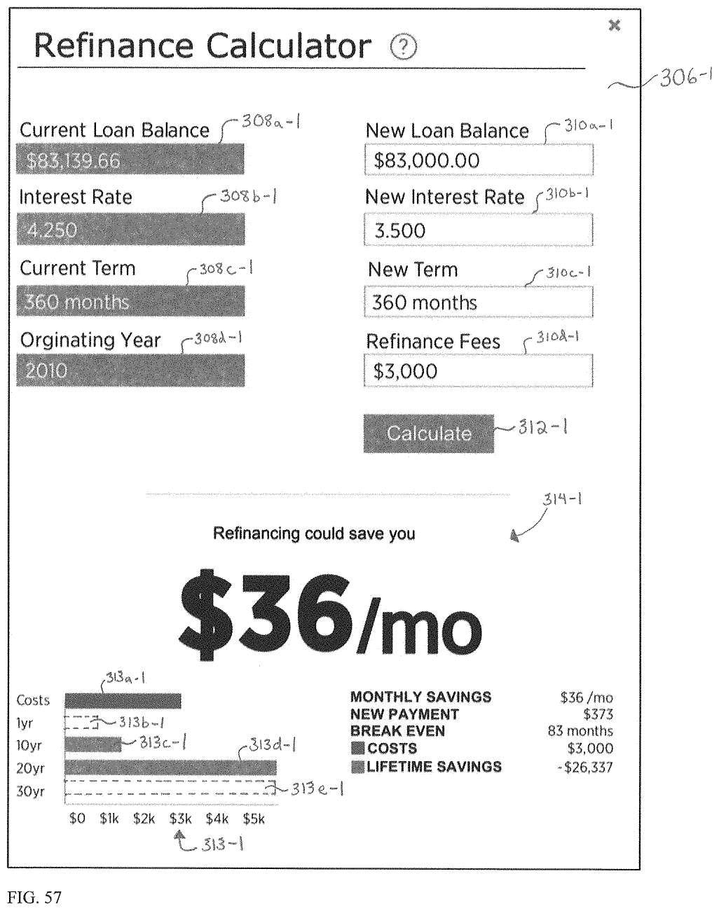

When the user selects the area 144h, a “Refinance Calculator” widget displays a dialog box or window 306 (FIG. 28) that allows the user to compare the user's current loan against a theoretical or actual new loan to help the user ascertain whether refinancing the loan would be desirable. The current loan details (i.e., current loan balance, interest rate, term (in months) and the year of origination of the loan) are displayed in four fields 308a, 308b, 308c, and 308d. Four text boxes 310a, 310b, 310c, and 310b may be filled in by the user (or some or all of the text boxes 310 may be filled in by the widget using data retrieved from the DC+ environment stored in the database 64 and any remainder filled in by the user) regarding a new loan balance, a new interest rate, a new loan term (in months), and total costs to refinance. A button “Calculate” 312 may be selected once the text boxes 310 are filled to cause the widget to calculate and display in the dialog box 306 values including: “Monthly Savings,” (comprising an estimate of monthly savings that would be realized in refinancing were to occur), “New Payment,” (i.e., the amount payable each payment period, typically each month), “Break Even,” (i.e., the time period it would take to save as much money as would be expended in a refinance), “Costs,” and “Lifetime Savings.” A bar graph 313 includes bar icon fields 313a-313e that display visual representations of the costs that would be incurred during a refinance, as well as calculated values “1 yr,” “10 yr,” “20 yr,” and “30 yr” that comprise the yearly savings that would be realized from the loan origination date to the indicated year of the mortgage. (The fields 313b-313e are shown as dotted lines in FIG. 29 because the example illustrates a situation in which refinancing would not result in savings. FIG. 57 illustrates an example in which savings could be obtained). The calculated values are evaluated by the widget to render a determination of whether refinancing is advisable and a message based on the determination is displayed in a field 314.

The “Refinance Calculator” widget uses the following formulas to calculate the above refinance parameters:

Widget Input Abbreviations
OLpv = OriginalLoan: Present Value (Widget Input)
Olir = OriginalLoan: Interest Rate (Widget Input)
Olftm = OriginalLoan: Full Term Months (User Input)
Oloty = OriginalLoan: Original Term Year (User Input as “YYYY”)
NLpv = NewLoan: Present Value (User Input)
Nlir = NewLoan: Interest Rate (User Input)
NLftm = NewLoan: Full Term Months (User Input)
Nlfee = NewLoan: Fees (User Input)
Other Input Abbreviations
Sdcy = System Date Current Year (Current Date Year as “YYYY”)
RESULTS (Calculate Button Results)
Note: Formulas are shown in Microsoft Excel format
Estimated Monthly Savings
=(IF((Olpv>0.01),((Olir/12)*Olpv)/(1−((1+(Olir/12))\hat{ }(−(Olftm−((Sdcy−
Oloty)*12))))),0))−(IF((NLpv>0.01),(((Nlir/12)*NLpv)/(1−((1+(Nlir/12))\hat{ }(−
(NLftm))))),0))
New Payment
=IF((NLpv>0.01),(((Nlir/12)*NLpv)/(1−((1+(Nlir/12))\hat{ }(−(NLftm))))),0)
Break Even
=Nlfee/((IF((Olpv>0.01),((Olir/12)*Olpv)/(1−((1+(Olir/12))\hat{ }(−(Olftm−((Sdcy−
Oloty)*12))))),0))−(IF((NLpv>0.01),(((Nlir/12)*NLpv)/(1−((1+(Nlir/12))\hat{ }(−
(NLftm))))),0)))
Costs
=Nlfee
Lifetime Savings
=((IF((Olpv>0.01),((Olir/12)*Olpv)/(1−((1+(Olir/12))\hat{ }(−(Olftm−((Sdcy−
Oloty)*12))))),0))*Olftm)−(((IF((NLpv>0.01),(((Nlir/12)*NLpv)/(1−
((1+(Nlir/12))\hat{ }(−(NLftm))))),0))*NLftm)+((IF((Olpv>0.01),((Olir/12)*Olpv)/(1−
((1+(Olir/12))\hat{ }(−(Olftm−((Sdcy−Oloty)*12))))),0))*(Olftm−NLftm)))
Yearly Savings Formula (1 Year)
=IF(IF(((Olftm−((Sdcy−Oloty)*12))>=12),((((IF((Olpv>0.01),((Olir/12)*Olpv)/(1−
((1+(Olir/12))\hat{ }(−(Olftm−((Sdcy−Oloty)*12))))),0))−
(IF((NLpv>0.01),(((Nlir/12)*NLpv)/(1−((1+(Nlir/12))\hat{ }(−(NLftm))))),0)))*12)−
Nlfee),0)<0,0,IF(((Olftm−((Sdcy−
Oloty)*12))>=12),((((IF((Olpv>0.01),((Olir/12)*Olpv)/(1−((1+(Olir/12))\hat{ }(−
(Olftm−((Sdcy−Oloty)*12))))),0))−(IF((NLpv>0.01),(((Nlir/12)*NLpv)/(1−
((1+(Nlir/12))\hat{ }(−(NLftm))))),0)))*12)−Nlfee),0))
Yearly Savings Formula (10 Years)
=IF(IF(((Olftm−((Sdcy−
Oloty)*12))>=120),((((IF((Olpv>0.01),((Olir/12)*Olpv)/(1−((1+(Olir/12))\hat{ }(−
(Olftm−((Sdcy−Oloty)*12))))),0))−(IF((NLpv>0.01),(((Nlir/12)*NLpv)/(1−
((1+(Nlir/12))\hat{ }(−(NLftm))))),0)))*120)−Nlfee),0)<0,0,IF(((Olftm−((Sdcy−
Oloty)*12))>=120),((((IF((Olpv>0.01),((Olir/12)*Olpv)/(1−((1+(Olir/12))\hat{ }(−
(Olftm−((Sdcy−Oloty)*12))))),0))−(IF((NLpv>0.01),(((Nlir/12)*NLpv)/(1−
((1+(Nlir/12))\hat{ }(−(NLftm))))),0)))*120)−Nlfee),0))
Yearly Savings Formula (20 Years)
=IF(IF(((Olftm−((Sdcy−
Oloty)*12))>=240),((((IF((Olpv>0.01),((Olir/12)*Olpv)/(1−((1+(Olir/12))\hat{ }(−
(Olftm−((Sdcy−Oloty)*12))))),0))−(IF((NLpv>0.01),(((Nlir/12)*NLpv)/(1−
((1+(Nlir/12))\hat{ }(−(NLftm))))),0)))*240)−Nlfee),0)<0,0,IF(((Olftm−((Sdcy−
Oloty)*12))>=240),((((IF((Olpv>0.01),((Olir/12)*Olpv)/(1−((1+(Olir/12))\hat{ }(−
(Olftm−((Sdcy−Oloty)*12))))),0))−(IF((NLpv>0.01),(((Nlir/12)*NLpv)/(1−
((1+(Nlir/12))\hat{ }(−(NLftm))))),0)))*240)−Nlfee),0))
Yearly Savings Formula (30 Years)
=IF(IF(((Olftm−((Sdcy−
Oloty)*12))>=360),((((IF((Olpv>0.01),((Olir/12)*Olpv)/(1−((1+(Olir/12))\hat{ }(−
(Olftm−((Sdcy−Oloty)*12))))),0))−(IF((NLpv>0.01),(((Nlir/12)*NLpv)/(1−
((1+(Nlir/12))\hat{ }(−(NLftm))))),0)))*360)−Nlfee),0)<0,0,IF(((Olftm−((Sdcy−
Oloty)*12))>=360),((((IF((Olpv>0.01),((Olir/12)*Olpv)/(1−((1+(Olir/12))\hat{ }(−
(Olftm−((Sdcy−Oloty)*12))))),0))−(IF((NLpv>0.01),(((Nlir/12)*NLpv)/(1−
((1+(Nlir/12))\hat{ }(−(NLftm))))),0)))*360)−Nlfee),0))

Header area and icons.

Search Area 130

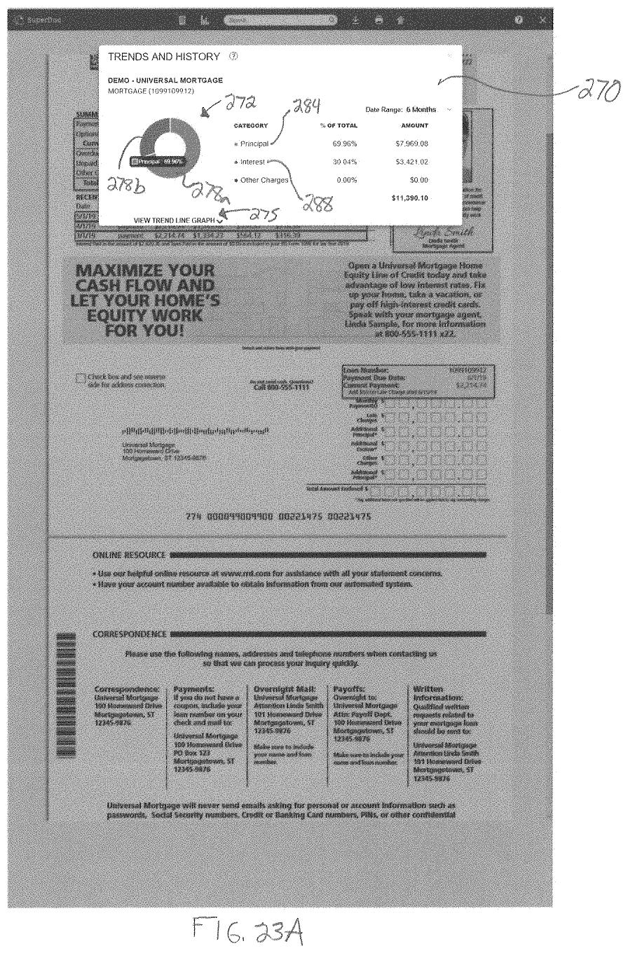

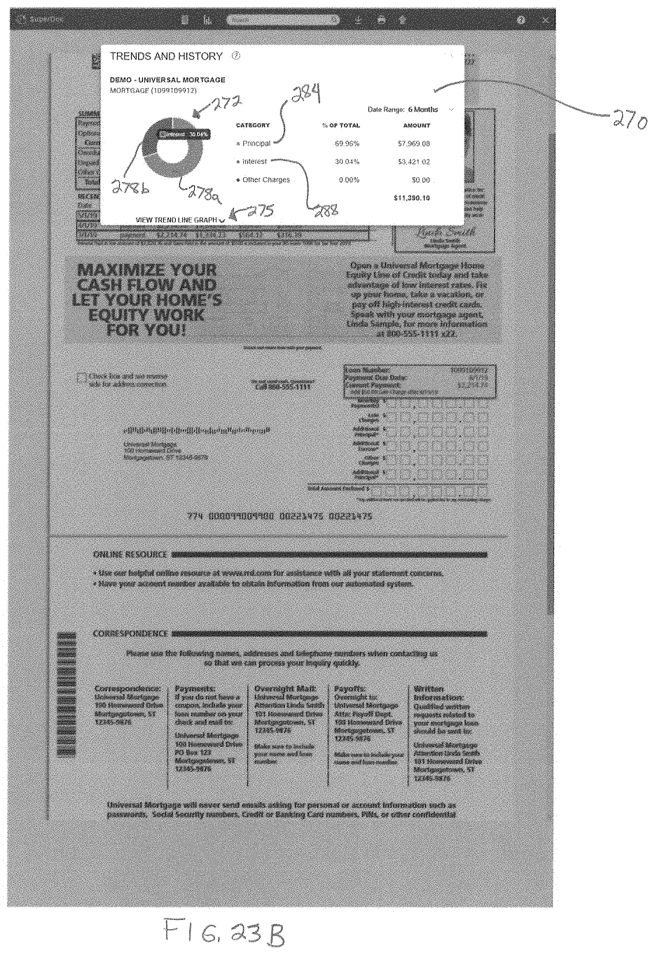

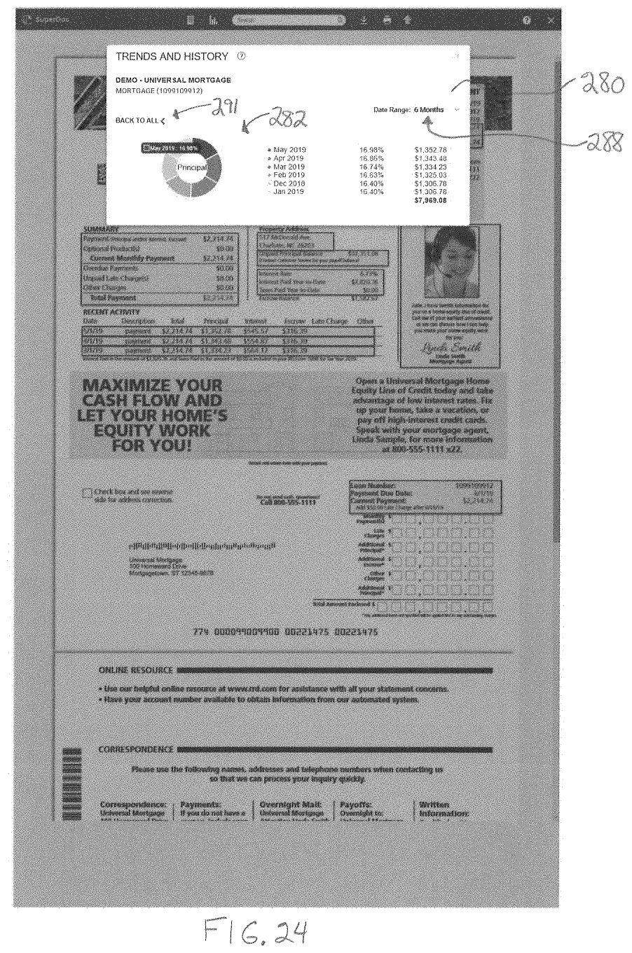

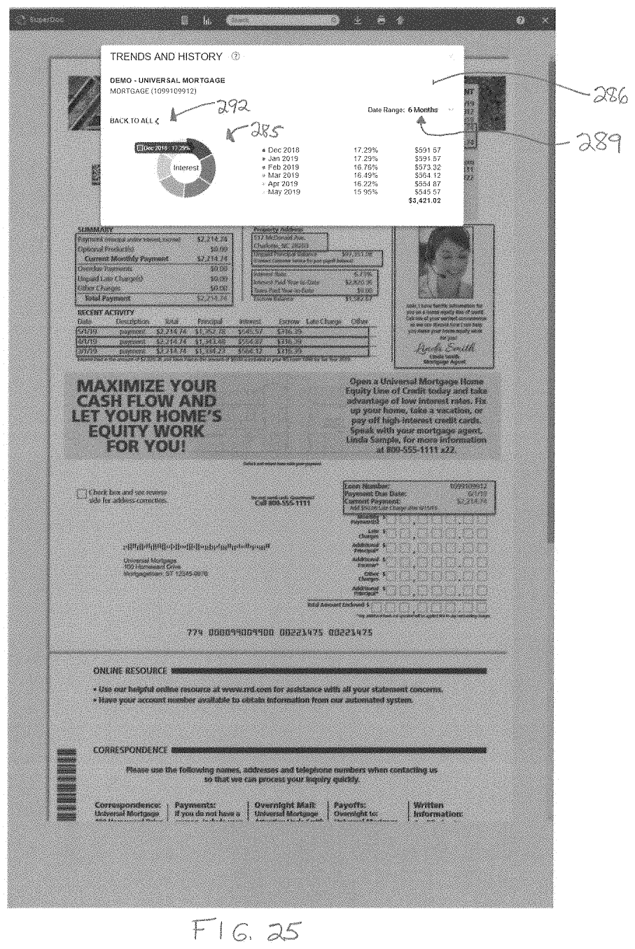

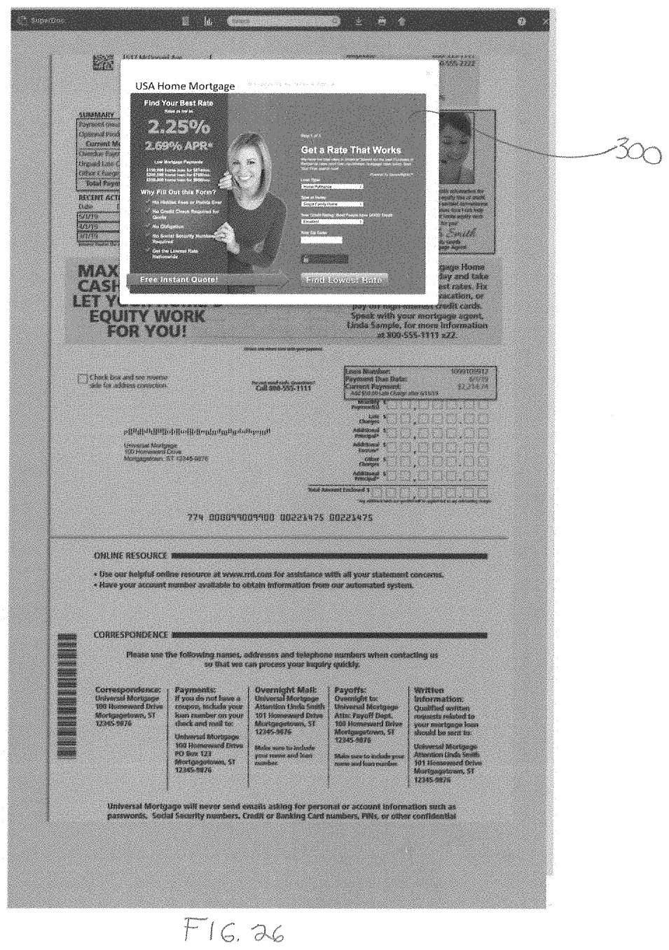

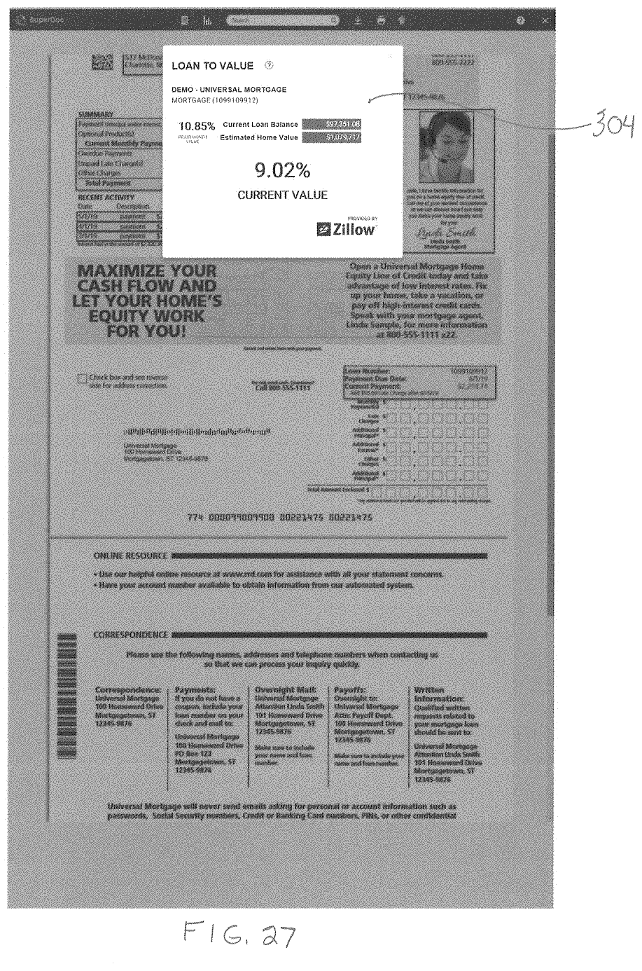

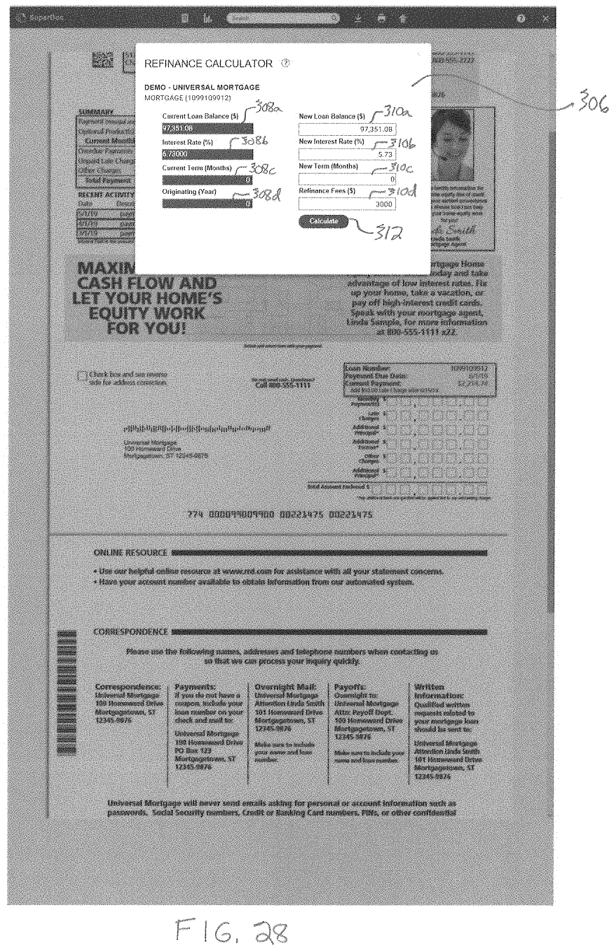

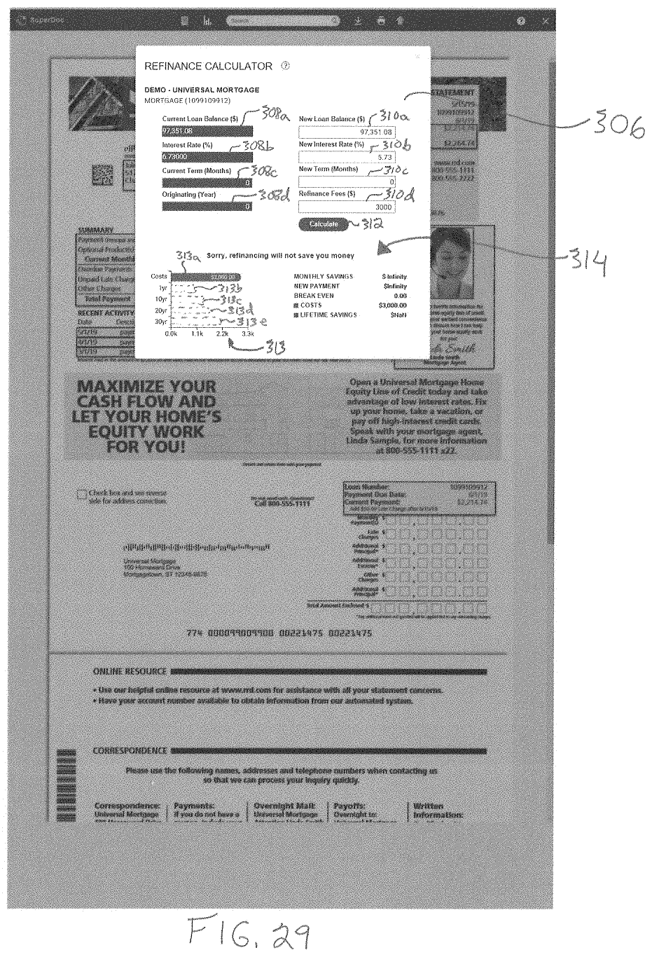

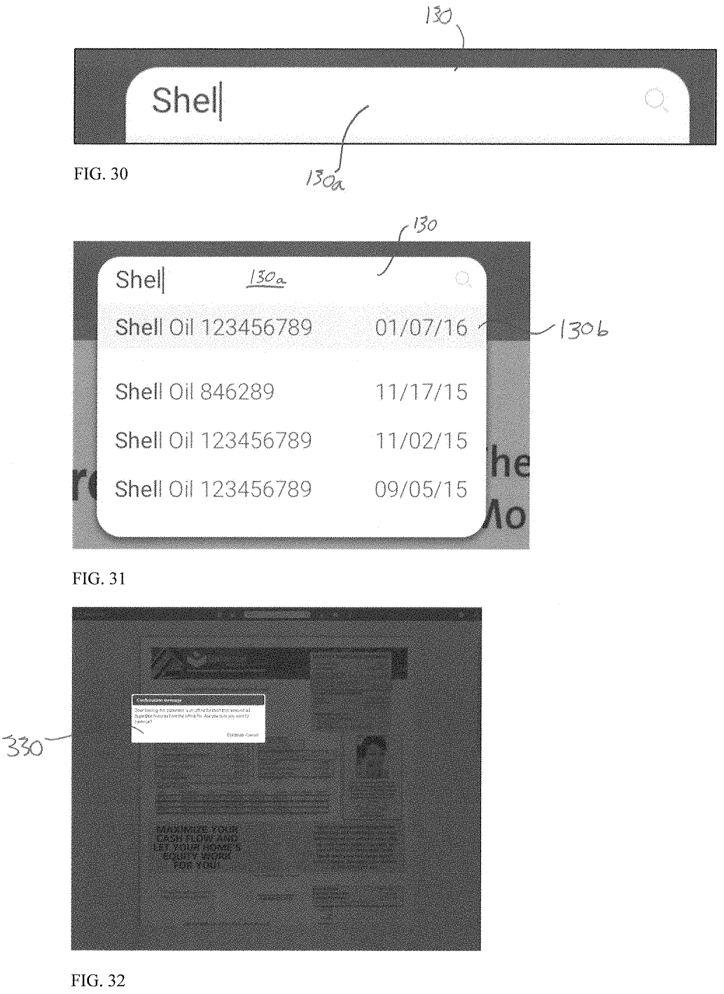

Referring to FIGS. 4, 30, and 31, when selected by the user, the search area 130 transforms into a search box that can accept user input to be searched for in a database. As a user inputs text, the search box provides a list of suggestive results based on current and past document activity. When a user selects a suggested result, the monitor 76 may display the document 139 (or 90 or 180) in a browser window with highlighting thereon indicating text that matches the text entered in the search area 130. The search is not necessarily limited to the document that is opened, but may include search results from other documents processed or stored in database 64. Therefore, if desired, matches in other documents other than the current document 90 or 180 or 139 may be indicated and may be selected for viewing by the user in select portions of the document or in the document in its entirety.

The search area 130 also has a predictive search and navigate feature, which, after a predetermined number of characters (such as four) are entered into the area 130a, develops and displays suggestions to the user that match the entered text (FIG. 31 illustrates four possible matches, with the most recent being displayed at a top-level field 130b). Any of the displayed suggestions may be selected by a user, whereupon the suggestion is copied to the portion 130a of the search area 130 where text is entered).

Icon 128a and 128g

Referring to FIG. 4 selection of the icon 128a (the “Download” icon) causes a dialog box or window 330 shown in FIG. 32 to open. The displayed message warns the user that all enhanced features will be removed from the downloaded file. If the user selects a “Continue” button, then the document 90 of FIG. 2 is downloaded to the computer 68. Selection of a “Cancel” button returns the user to the enhanced document 139. As noted previously, the user may be given the ability to download the enhanced document 139 instead, if desired. In an alternative embodiment, selection of the icon 128g (the “share to cloud” icon) causes a dialog box or window to open displaying a plurality of sharing options, such as “Dropbox,” “Google Drive,” “iCloud,” and “Box.” When a user selects one of the plurality of options, a message window appears displaying a plurality of additional options, such as a “Continue” button and a “Cancel” button. If the user is connected to a cloud storage account, a message is displayed warning the user that downloading this statement is an offline function that removes all enhanced features from the offline file. If the user selects a “Continue” button, then the document is downloaded and saved to the user's connected cloud storage account. Selection of a “Cancel” button returns the user to the enhanced document. If the user is not-connected to a cloud storage account, a dialog box or window displays a message regarding accessing the cloud storage, a form with an plurality of fields, such as an email field, password field, and plurality of buttons, such as “Sign-in and Connect,” and “Cancel.” Once a user is connected to a cloud storage account using the foregoing, a message displays that the user is connected. After a defined amount of time, the message displaying that the user is connected may disappear. A message is displayed warning the user that downloading this statement is an offline function that removes all enhanced features from the offline file. If the user selects a “Continue” button, then the document is downloaded and saved to the user's connected cloud storage account. Selection of a “Cancel” button returns the user to the enhanced document.

Icon 128b

Selecting this icon gives the user the ability to print the document using the native browser capability.

Icon 128c

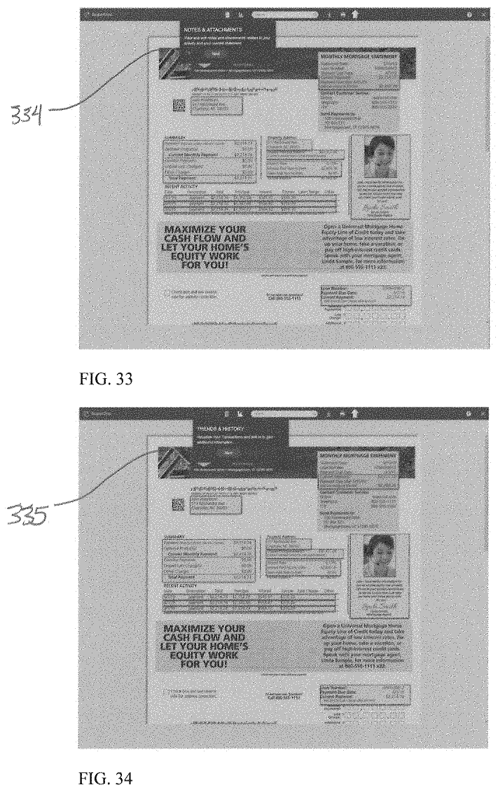

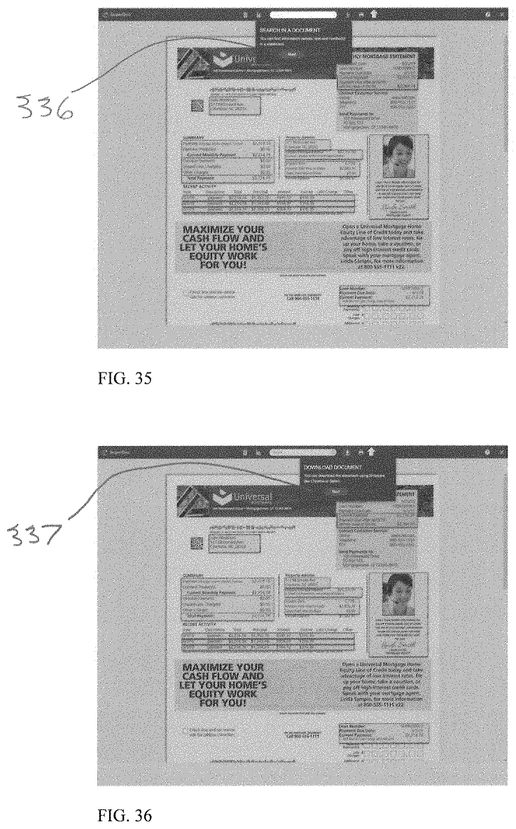

Selecting this icon takes the user through the tour effectuated by the “Guided Tour” button 216 of FIG. 8. FIGS. 33-37 illustrate dialog boxes or windows 334-338 that are sequentially opened as the user navigates through the guided tour by selecting the “Next” button in the boxes 334-337. The dialog boxes highlight the functionality available using the icons 128a, 128b, 128d, and 128e. The user may exit the guided tour by selecting the “Exit Guide” button in any of the boxes 334-338.

Icons 128d and 128e

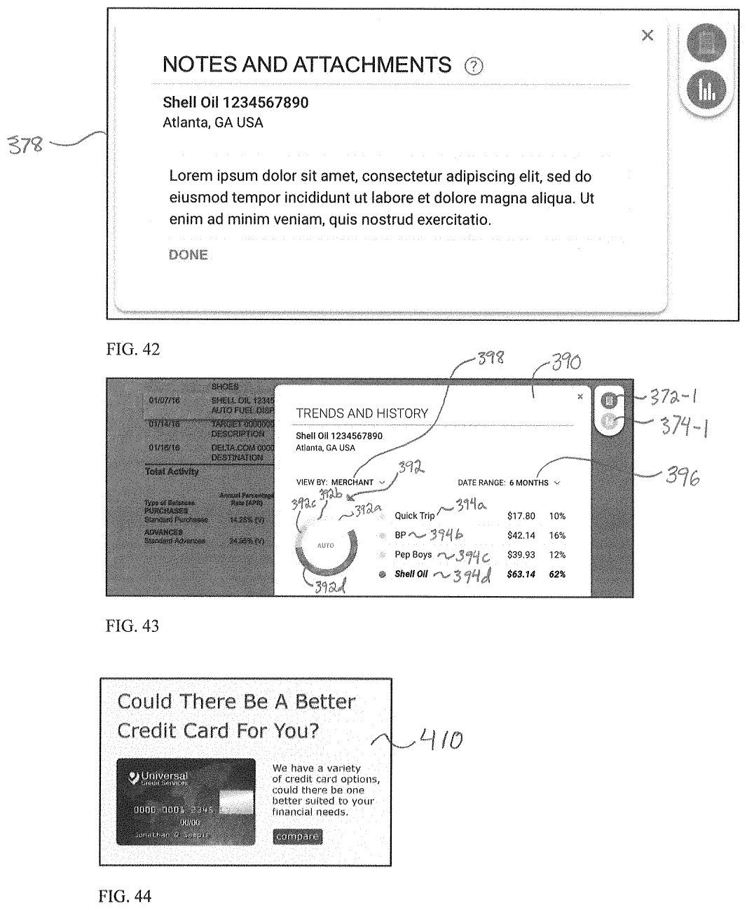

Hovering over the icon 128d causes the tooltip “Notes and Receipts” 339 to be displayed by the Notes and Attachments” widget as seen in FIG. 37A. Further selection of the icon 128d (e.g., by clicking on same) results in display of a dialog box or window, thereby allowing use of the functionality of FIGS. 13-16 or the functionality of FIGS. 41 and 42 described hereinafter. Alternatively, such selection may open a further exemplary dialog box or window 340 of FIG. 37B, which, in turn, allows the user to access the functionality of FIGS. 37B-37D. The box or window 340 displays a table with the following columns:
Date—Displays the date of the transaction activity
Description—Displays up to the 120 characters of the description text of the transaction
Principal—Displays the actual dollar amount applied to the principal
Interest—Displays the actual dollar amount applied to the interest
Attachments—Displays the total amount of attachments saved for the note

Each row (in the illustrated embodiment rows 341 and 342) represents a specific activity-line item. Each activity-line item may have one or more notes and one or more attachments (image or .pdf) associated therewith. Icons 343 and 344 may be used to select/deselect the rows 341 and 342, respectively. When the user selects a row and there is a note, the previously created note is displayed. FIG. 37C illustrates the dialog box or window 340 after selection of the row 341 whereby the note is displayed beneath the specific activity-line item information of row 341.

When a user selects the number 345 between the parentheses adjacent the hyperlink link “Add Attachment” 346 a window opens displaying the previously-saved attachments. When a user selects the “Add Attachment” hyperlink 346 a file selection window opens, such as the dialog box 260 of FIG. 16, that uses the native browser's or operating system's “select attachment” system to allow the user to attach a file to the transaction.

When a user selects a “Delete” hyperlink 347 a window opens that gives the user the option to delete the note, the attachment, or both. On the other hand, when a user selects an “Edit Note” hyperlink 348, the user may modify the text of the previously created note using the dialog box 256 of FIG. 15.

Once the foregoing operations are complete the widget opens a dialog box or window 349 (FIG. 37D) and a “Done” hyperlink 350 (FIG. 37D) may be selected by the user to save any and all changes.

Hovering over the icon 128e causes the tooltip “Trends and History” 351 (as seen in FIG. 37E) to be displayed by the “Trends and History” widget. Further selection of the icon 128e by clicking on same causes the widget to display a dialog box, such as the dialog box or window 270 of FIG. 17, thereby allowing use of the functionality of FIGS. 17-25. Alternatively, such selection may open a further exemplary dialog box or window 352 of FIG. 37F, which, in turn, allows the user access to the functionality of FIGS. 37F-37I, (FIG. 37H may be displayed instead of FIG. 37G in the sequence of functionality, if desired) which provide the same functionality as that described in connection with FIGS. 17-25, but which differ as to data and addition of an “Escrow” field 353 and data associated therewith.

Icon 128f

Selecting the icon 128f closes the window displaying the modified document 139.

Other icons may be provided in the header area, such as a “Super Doc Home” icon 340, seen in FIG. 4.

Referring next to FIG. 38, a different example of a document 350 comprising a credit card statement having enhanced features is shown. The document 350 is opened in the same manner as the document 139. The document 350 is opened in a window having a header 352 with icons 354a, 354b, 354c, 354e, 354d, and search area 356 similar or identical to and implementing the same or similar functionality as the icons 128a, 128d, 128e, 128g, 128f, and the search area 130, respectively, of FIG. 4.

In the illustrated embodiment of FIG. 38, areas 358a-358e comprise areas implementing enhanced features “Credit Line Calculator,” “Past Statement Balances,” “Offers,” “Balance Payoff Calculator,” and “Change Address,” respectively, implemented by widgets.

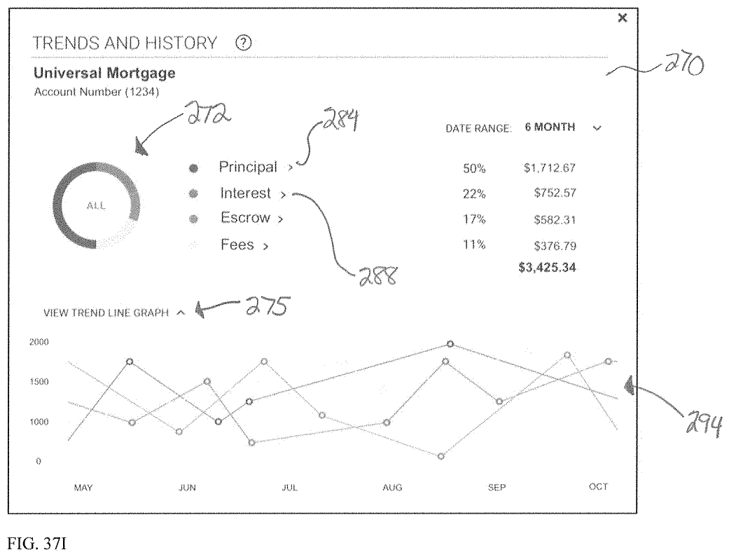

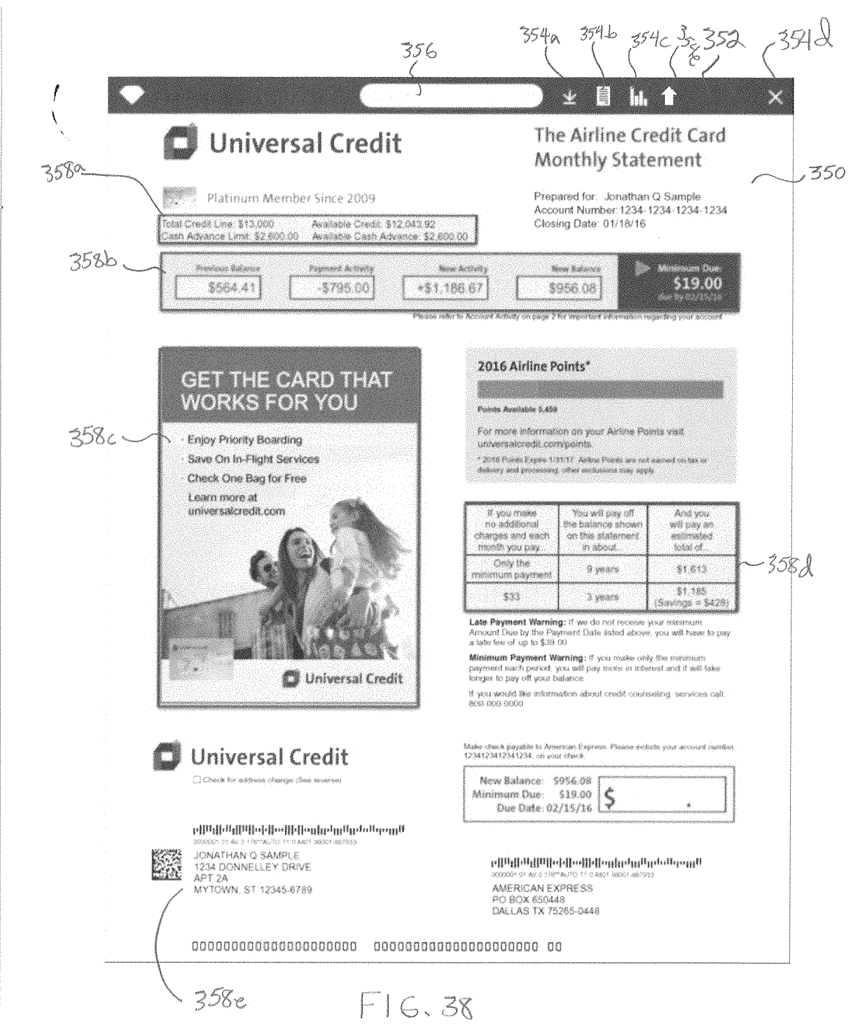

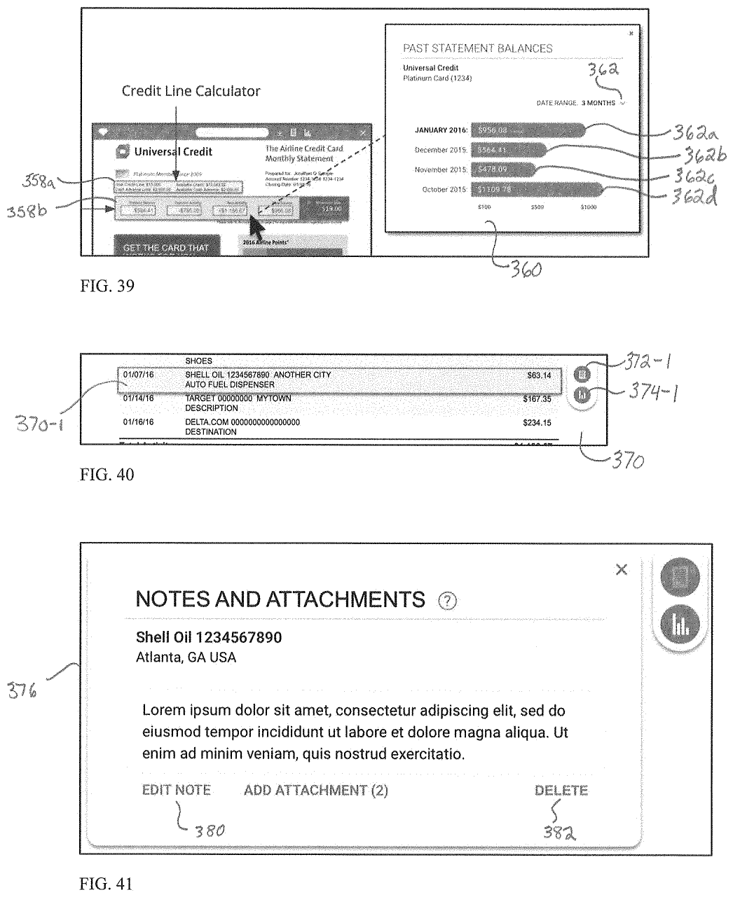

FIG. 39 illustrates a dialog box or window 360 opened by selection of the area 358b. Such selection causes execution of the “Past Statement Balances” widget described in connection with FIGS. 5, 6, and 6A. FIG. 39 illustrates an alternative to the dialog box or window 170 wherein the number of months N selected by the user via a month icon 362 and a drop-down box results in display in the dialog box or window 360 of the selected number N of prior months plus display of the current month. (The dialog box or window 170 displays N−1 prior months plus display of the current month). Also, while not shown in FIG. 39, a help icon may be displayed as shown in FIG. 5 (i.e., icon 189) that is selectable to provide help instructions to a user, for example, in the form seen in FIG. 6. Any of the displayed bar icons 362b-362d may be selected as in the embodiment of FIG. 5 to cause display/download of a prior statement.

It should be apparent that additional enhanced features may be provided when a document comprising a credit card statement is displayed. For example, if a user has a plurality of credit cards, an icon (not shown) or an enhanced area (not shown) may be provided on the document that, when invoked, causes a dialog box or window to be displayed in which a plurality of information, such as amount due, and interest rate, is displayed. The widget may optionally display a message that denotes which credit card the user should use based on credit terms of the cards. In another example, an icon (not shown) may be provided in the header 352 or an enhanced area (not shown) may be provided on the document that, when invoked, causes a dialog box or window to be displayed in which a credit score chart (not shown) associated with the user. Such credit score chart may use credit score information acquired from a credit reporting agency, such as TransUnion, Equifax, or Experian PLC, and display such credit score information in the dialog box or window. Alternately, the credit score chart may be developed from information obtained from one or more of the credit reporting agency/agencies and a credit score may be developed from such information and displayed. Such credit score chart may display, for example, how the credit score of the user has changed over time and/or values of credit scores acquired from or developed using information acquired from multiple credit reporting agencies. It should be apparent to one who has ordinary skill in the art that, in some embodiments, such credit score chart may be formatted in a manner similar to the way information is displayed in the dialog box or window generated by the “Trends and History” widget (See FIGS. 37F-37I).

Referring next to FIG. 40, a Recent Activity area 370 analogous to the Recent Activity area 144e of FIG. 4 is shown. The Recent Activity area 370 displays activity lines representing credit transactions that have occurred since the last statement date for the subject credit card and may appear, for example, on a different page of the statement other than the page displayed in FIG. 38. Hovering over any of a plurality of sub-areas, for example sub-area 370-1, causes icons 372-1 and 374-1 identical to the icons 240-1 and 242-1 of FIG. 12 to appear. Selecting the icon 372-1 causes execution of the “Notes and Attachments” widget described above in connection with FIGS. 13-16. FIGS. 41 and 42 show dialog boxes or windows 376, 378 that are analogous to the boxes 250 of FIGS. 13 and 256 of FIG. 15, respectively, except that the dialog box or window 376 includes hyperlink “Edit Note” 380 (as opposed to the link “Add Note” 254 of FIG. 13) and “Delete” 382 inasmuch as a note has already been entered using the “Notes and Attachments” widget. A “Cancel” hyperlink like the “Cancel” link of FIG. 15 may be included in the dialog box or window 378 of FIG. 42 to allow a user to cancel changes to a note, if desired.

When the icon 374-1 of FIG. 40 is selected a widget analogous to the Trends and History widget described above in connection with FIGS. 17-25 is executed. FIG. 43 illustrates a dialog box or window 390 analogous to the dialog box or window 270 of FIG. 17 that is initially opened when the icon 374-1 is selected. The dialog box or window 390 includes a donut icon 392 that illustrates a summary of all of the transactions for a selectable period of time including and related to the selected transaction (i.e., the transaction at the area 370-1). In the illustrated embodiment, the transaction at the area 370-1 relates to a transaction at an automobile product vendor (such as a gasoline station) and the donut icon 392 summarizes all “Auto” transactions over a date range (i.e., six months). A user may “drill down” into transaction details by selecting donut icon portions 392a-392d or by selecting hyperlink 394a-394d, similar or identical to the functionality of FIGS. 17-25 described above. The user may select a “Date Range” via a hyperlink 396 and a drop-down box as described above in connection with FIG. 17. A hyperlink 398 and a drop-down box permit a user to view by a selected category, such as the illustrated category “Merchant.”

FIG. 44 illustrates a dialog box or window 410 that is displayed by the “Deals and Offers” widget shown in connection with FIG. 26 above when the area 358c of FIG. 38 is selected by the user. As in the previous embodiment the widget may display external content, such as text, images, video, audio, etc. and may have hyperlinks, icons, and/or other display structures that, when selected, link the user to a website, similar or identical to the dialog box or window 300. This widget may not open a help icon in the dialog box or window 410.

Referring to FIG. 45 a dialog box or window 412 is opened by the “Profile Update” widget described in connection with FIGS. 10 and 11 above when the area 358e is selected by the user. As in the embodiment described above, the user may enter, edit, and/or delete personal information and, optionally, establish preferences in association with the use of the enhanced features.

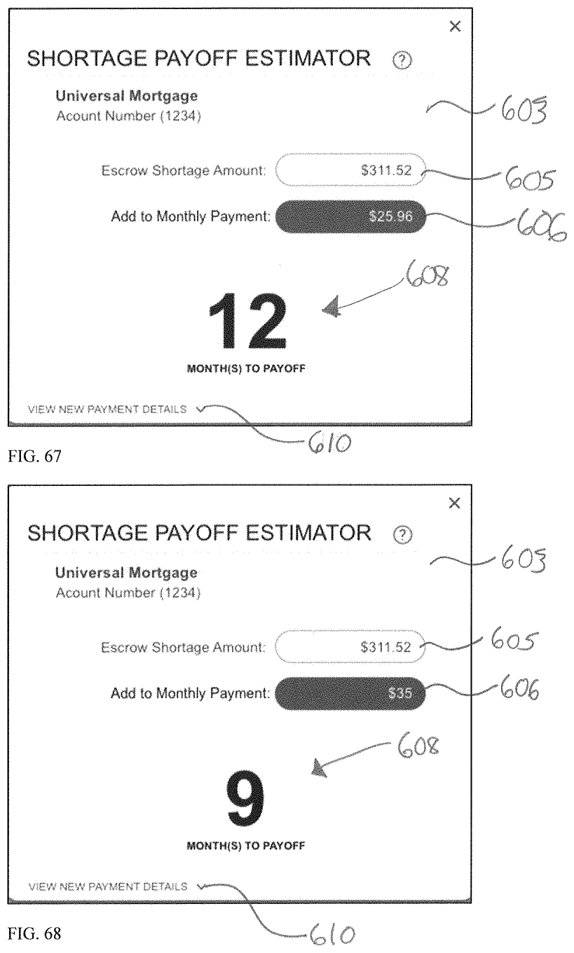

The following describes enhanced functionality features for utility statements (FIGS. 47-55) and escrow statements (FIGS. 59-69) as indicated. Although specific examples of such statements with enhanced features are not illustrated herein, it should be understood that the widgets and enhanced features described in the following are similar or identical to the widgets and functionality described above, in some cases modified as noted to implement functionality specific to such types of statements.

Utility Statements

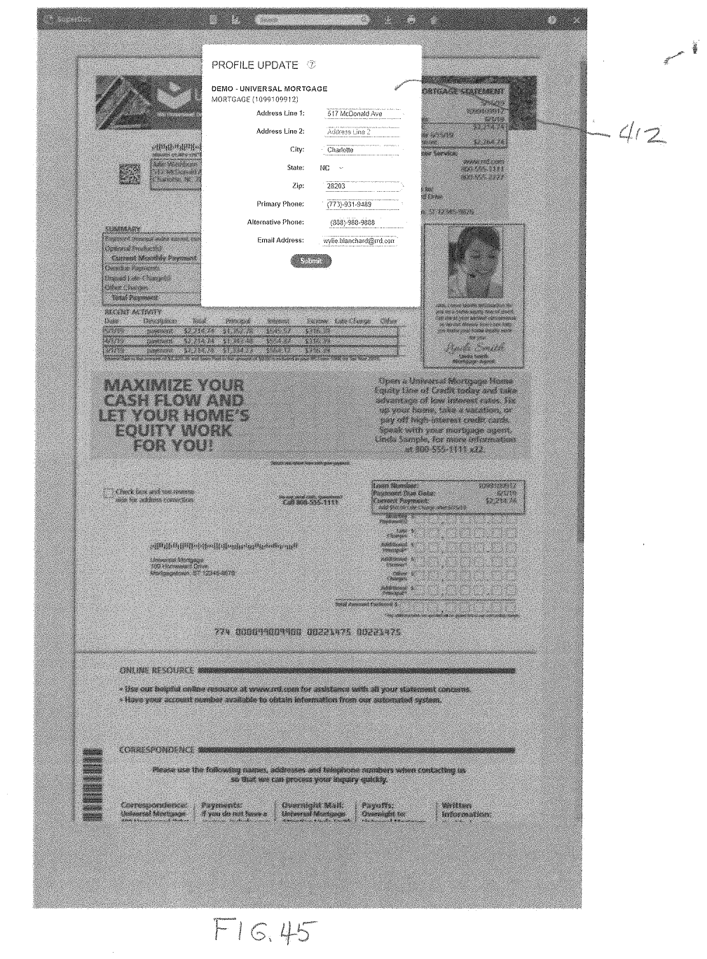

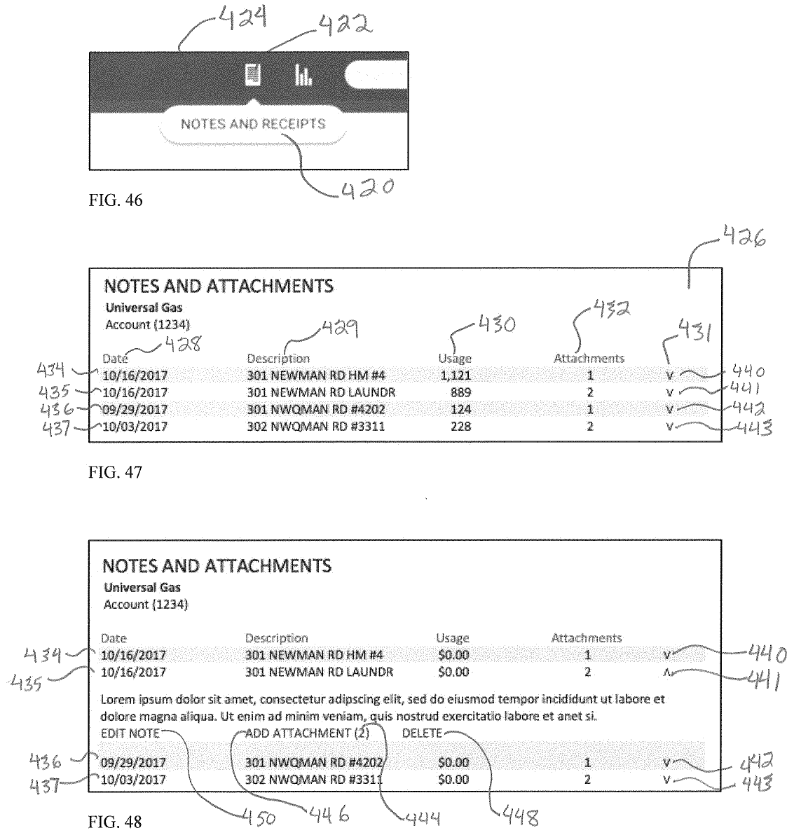

FIG. 46 illustrates a tool tip 420 that is displayed when a user hovers over a “Notes and Receipts” icon 422 in a header bar 424 of a window displaying a utility statement with enhanced features. Further selection of the “Notes and Receipts” icon 422 (e.g., by clicking on same) causes the “Notes and Attachments” widget described above to open a dialog box or window 426 of FIG. 47. The dialog box or window 426 includes the following columns 428-432:
Date (column 428)—Displays the date or date range of the transaction activity;
Description (column 429)—Displays up to the first 120 characters of the description text of the transaction activity;
Usage (column 430)—The column header will display “kWh” for an Electricity Statement, “CCF” for a Gas Statement, and “GAL” for a Water Statement replacing the header “Usage.” The column 430 displays the total amount of utility services consumed since the last reading;
(Blank) (column 431)—This column does not display content in this example; and
Attachments (column 432)—Displays the total number of attachments saved for the note.

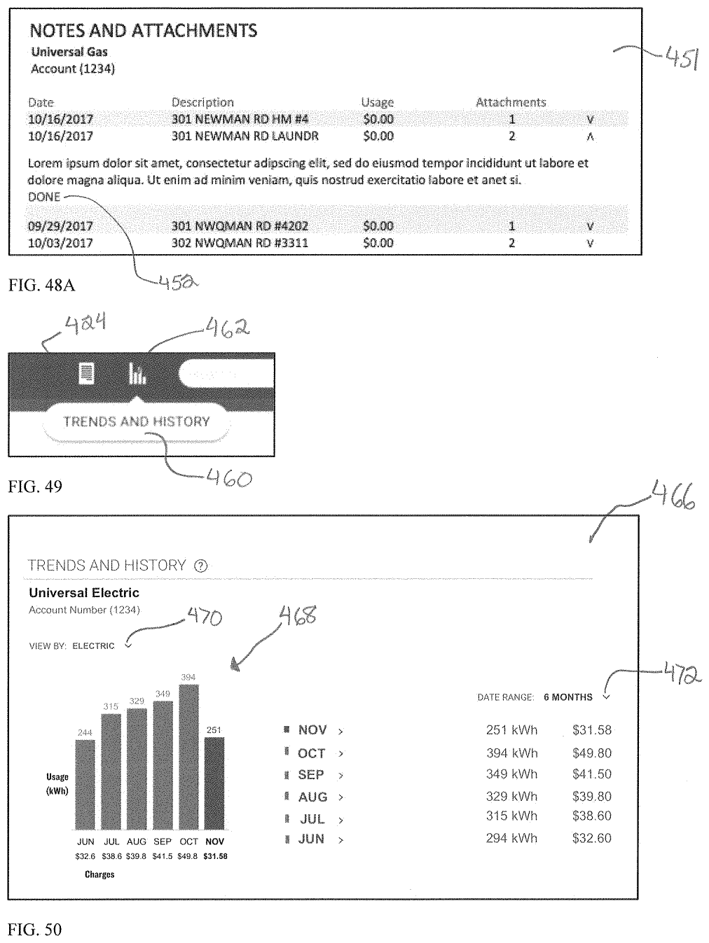

Each row (in the illustrated embodiment rows 434-437) represents a specific activity-line item. Each activity-line item may have one or more notes and one or more attachments (image or .pdf) associated therewith. Icons 440-443 may be used to select/deselect the rows 434-437, respectively. When the user selects a row a window opens displaying the previously created note. FIG. 48 illustrates the dialog box or window 426 after selection of the row 435 whereby the note is displayed between the rows 435, 436.

When a user selects the number 444 between the parentheses adjacent the hyperlink link “Add Attachment” 446 a window opens displaying the file names and/or thumbnail versions of the previously-saved attachments. When a user selects the “Add Attachment” hyperlink 446 a file selection window opens, such as the dialog box or window 260 of FIG. 16, that uses the native browser's or operating system's “select attachment” system to allow the user to attach a file to the transaction.

When a user selects a “Delete” hyperlink 448 a window opens that gives the user the option to delete the note, the attachment, or both. On the other hand, when a user selects an “Edit Note” hyperlink 450, the user may modify the text of the previously created note using the dialog box or window 256 of FIG. 15.

Once the foregoing operations are complete the widget opens a dialog box or window 451 (FIG. 48A) and a “Done” hyperlink 452 may be selected by the user to save any and all changes.

FIG. 49 illustrates a tool tip 460 that is displayed when a user hovers over a “Trends and History” icon 462 in the header bar 424 of the window of FIG. 46 displaying the utility statement with enhanced features. Further selection of the “Trends and History” icon 462 (e.g., by clicking on same) causes the “Trends and History” widget described above to open a dialog box or window 466 of FIG. 50. The dialog box or window 466 includes the following:
Graph Pane 468, which may be a donut chart as previously described or the illustrated column chart wherein the pane 468 displays an interactive graph;
Legend Pane 470 comprising a category drop-down selection list allowing a user to select among “Electric” (as illustrated in FIG. 50), “Gas,” or “Water” categories. Selection of a category causes respective activity category titles and data values to be displayed in the dialog box or window 466;
Date Range drop-down arrow allowing the user to select a desired data range for display, such as 6 months, 1 year, or all available historic data (the past 6 months may be the default time range).

Thus, as shown, electric charges for the selected period of time (i.e., the preceding six months) are shown in bar graph form with data and electric usage units (i.e., kilowatt-hours). Selection of “Gas” or “Water” causes display of gas or water charges, respectively, for the selected period of time (e.g., six months) with the appropriate usage units.

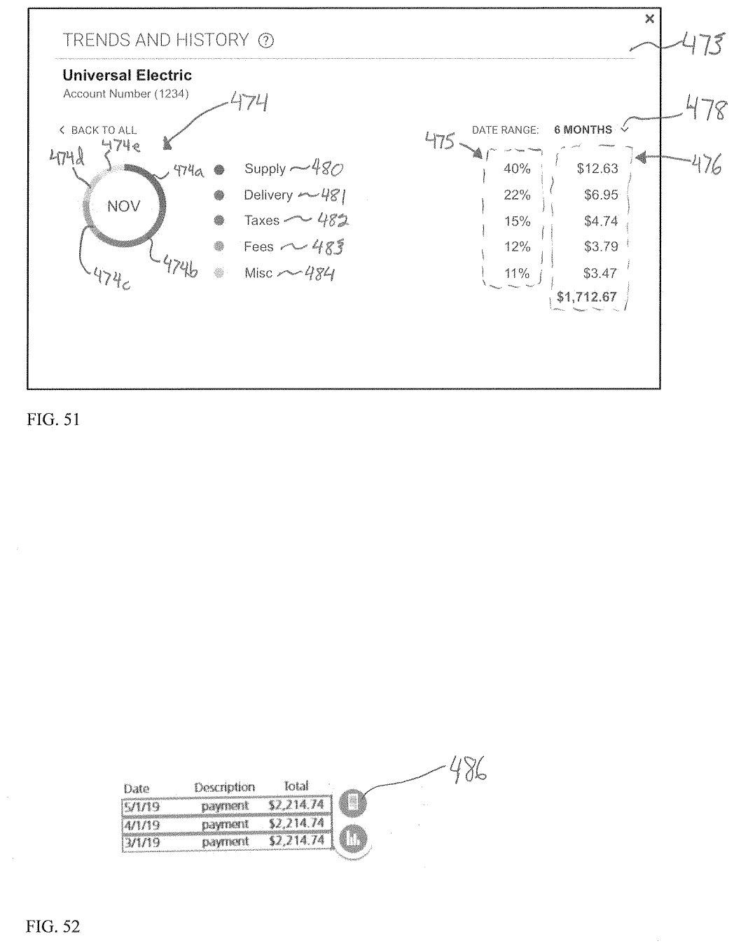

Selection of one of the columns of the pane 468 or one of the hyperlink (such as the “Nov” column of the chart or the “Nov” hyperlink) results in the drill-down dialog box or window 473 of FIG. 51 illustrating details of the November electric costs, including a donut chart 474 and expense details in columns 475-476 and a drop-down box 478 allowing selection of a desired date range. The dialog box or window 473 is similar to the box or window 280 of FIG. 24. Hovering over sub-areas 474a-474e or hyperlinks “Supply,” “Delivery,” “Taxes,” “Fees,” or “Misc” 480-484, respectively, causes display of the respective expense component for the selected month. A “Back to All” hyperlink, when selected returns the user to the display of FIG. 50.

Referring to FIG. 52 when the user selects an activity line representing an expense item of the utility statement (similar to selection of the sub-area 370-1 of FIG. 40), a “Notes and Attachments” icon 486 is displayed, and optionally, an icon for “Trends and History.” Selection of the “Notes and Attachments” icon 486 results in the “Notes and Attachments” widget displaying the functionality shown in FIGS. 47 and 48 above.

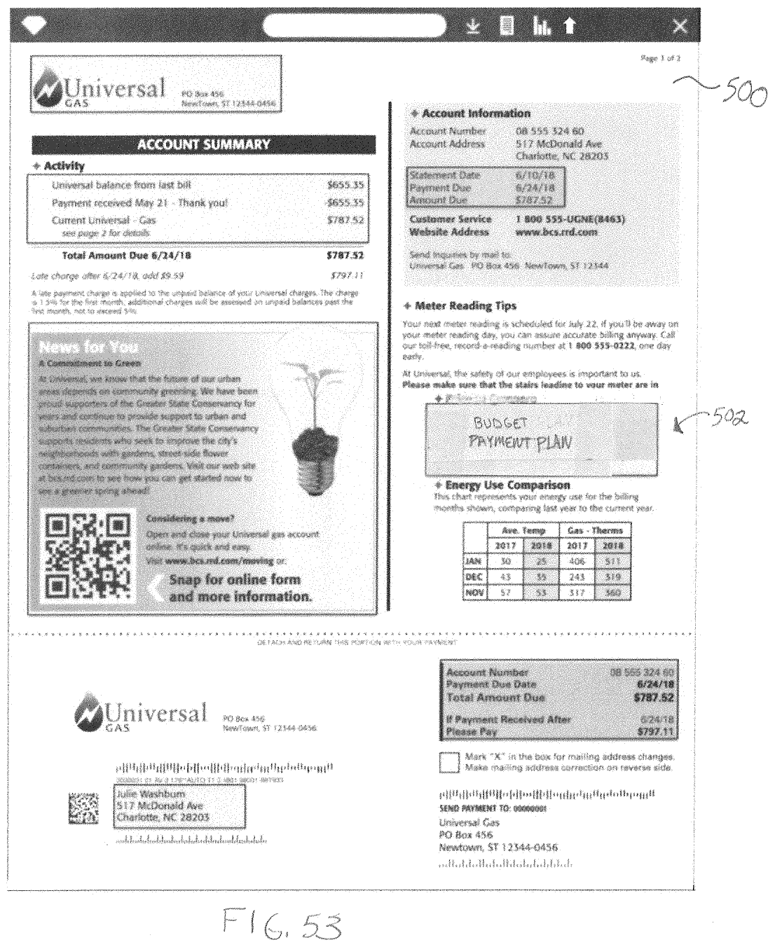

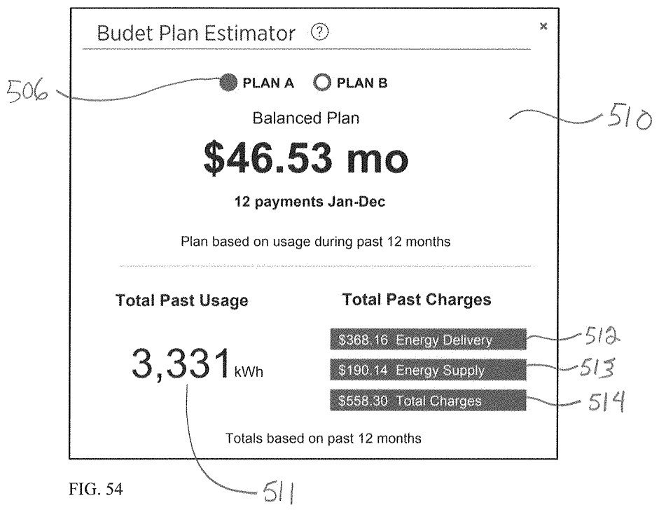

FIG. 53 illustrates a portion of a sample utility statement 500 having an indication 502 of a budget payment plan (described below) in effect for the user. When the user selects the indication 502 a “Budget Plan Estimator” widget causes a dialog box or window 504 to be displayed (as seen in FIG. 54) comprising a form having radio buttons 506, 508 for Plan A and Plan B, respectively, with Plan A radio button 506 being selected (i.e., active). Plan A comprises an estimated Budget Payment Plan while Plan B comprises an estimated Actual Payment Plan. A Budget Payment Plan allows a user to budget his/her expenses and avoid the surprise of an unexpected, higher than normal utility bill when actual usage changes. With a Budget Payment Plan, a user's annual utility bill is averaged over the preceding eleven months and the current month, a small monthly percentage is added to cover inflation as well as environmental factors and other fees, then the user then pays the resulting averaged and augmented amount every month.

In instances where 12 months of past archived data is not available then the budget payment plan is determined by totaling the monthly billed amount (total amount owed) for the past 5 months plus the current month, dividing that amount by 6, and adding a small monthly amount to cover for inflation, environmental fees, and other costs.

Users on an Actual Payment Plan are billed and pay for the actual usage fees for the utility or utilities consumed during the actual billing period.

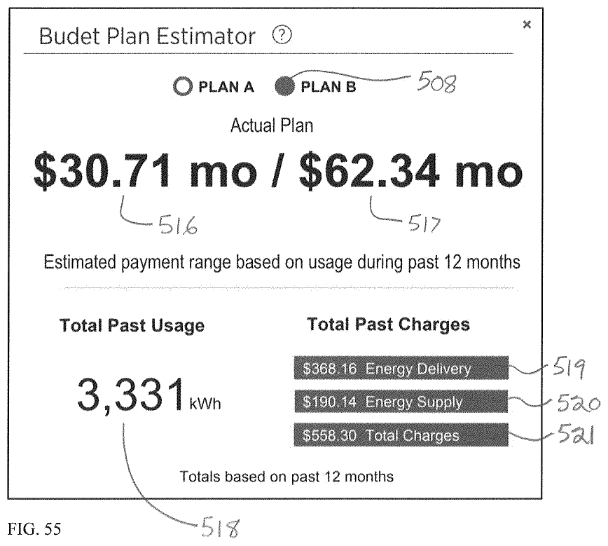

When the radio button 506 of the dialog box or window 504 is selected the following fields shown in FIG. 54 are displayed (the dialog boxes or windows of FIGS. 54 and 55 are shown for the example of an electric utility portion of a statement, it being understood that water and gas portions of a statement would be identically displayed except as to usage units, breakdown for charges unique to each utility service (i.e., electric, water, or gas), and, optionally, an indication of the particular utility service to which the figures shown in box or window 504 applies):
Current budget payment (field 510);
Total actual usage for the past 11 months plus the current month (field 511); and
A breakdown of past usage charges for the past 11 months plus the current month (in the illustrated embodiment for electric service) comprising:
   Energy Delivery total amount billed (field 512)
   Energy Supply total amount billed (field 513); and
   Total Charges billed (field 514).

As seen in FIG. 55 when the radio button 508 is selected the following fields are displayed based on the prior eleven months charges plus the current month charges:
Lowest total usage charge (field 516);
Highest total usage charge (field 517);
Current total actual usage (field 518); and
A breakdown of past usage charges for the past 11 months plus the current month (in the illustrated embodiment for electric service) comprising:
   Energy Delivery total amount billed (field 519)
   Energy Supply total amount billed (field 520); and
   Total Charges billed (field 521).

Escrow Statements

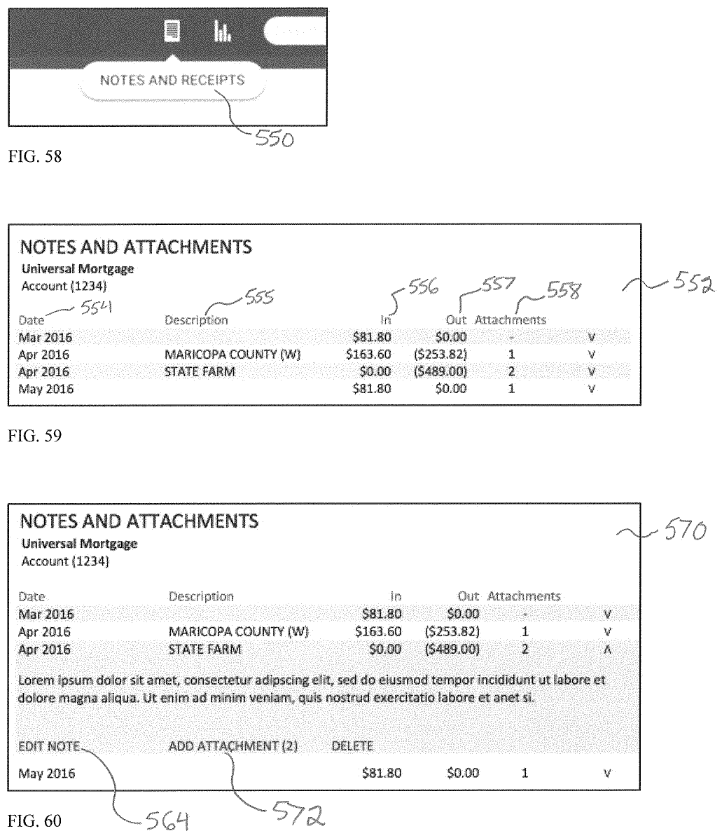

Referring to FIG. 58, when the user hovers over the “Notes and Receipts” icon 550 of the header bar displaying the escrow statement, the “Notes and Attachments” widget opens a dialog box or window 552 (FIG. 59) displaying a table with the following columns.
Date (column 554)—Displays the date of the transaction activity (If the date of the transaction activity not available then it will display the statement issue date);
Description (column 555)—Displays up to the first 120 characters of the description text of the transaction activity;
In (column 556)—Displays the actual dollar amount deposited to the escrow account since the last statement;
Out (column 557)—Displays the actual dollar amount withdrawn from the escrow account since the last statement; and
Attachments (column 558)—Displays the total amount of attachments saved for the note

Each of a plurality of rows 559-562 represents a specific activity-line item. Each activity-line item can have one note and one or more attachments (image/.pdf). When an activity-line item has both a note and an attachment, then each is represented on its own row. For instance, when the user selects a row using one of a plurality of icons 564-567 for an “Edit Note,” (such as the row 561) a dialog box or window 570 (FIG. 60) is displayed showing the previously-created note text.

When the user selects the number in between the parentheses adjacent the hyperlink “Add attachment” 572, which indicates that total amount of attachments linked to the note, a window opens displaying the attachments.

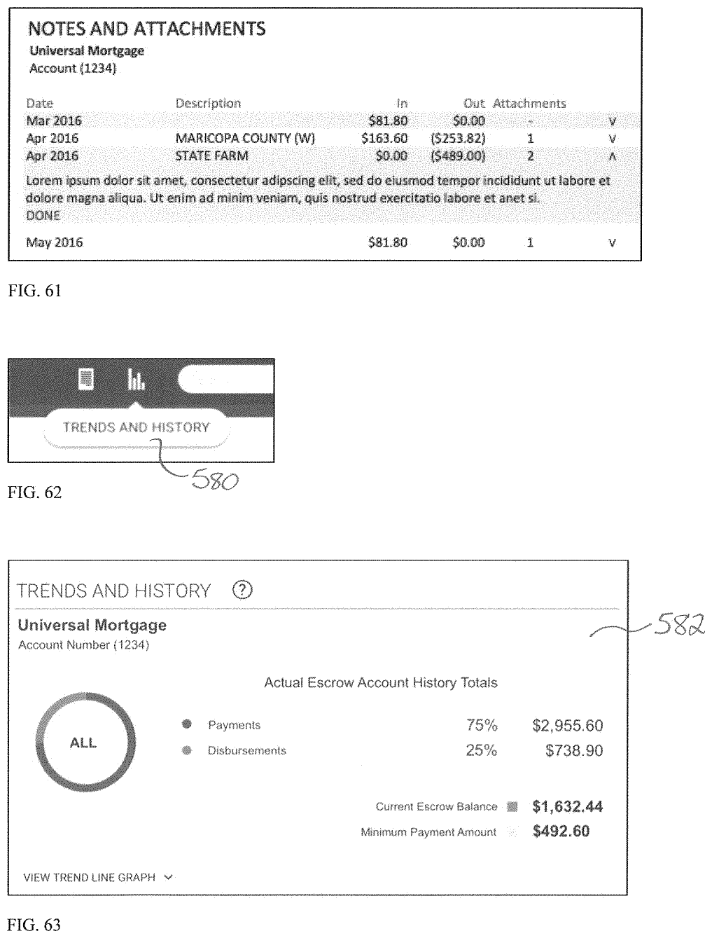

The functionality represented is otherwise identical to that illustrated by FIGS. 37B-37D (see also FIG. 61).

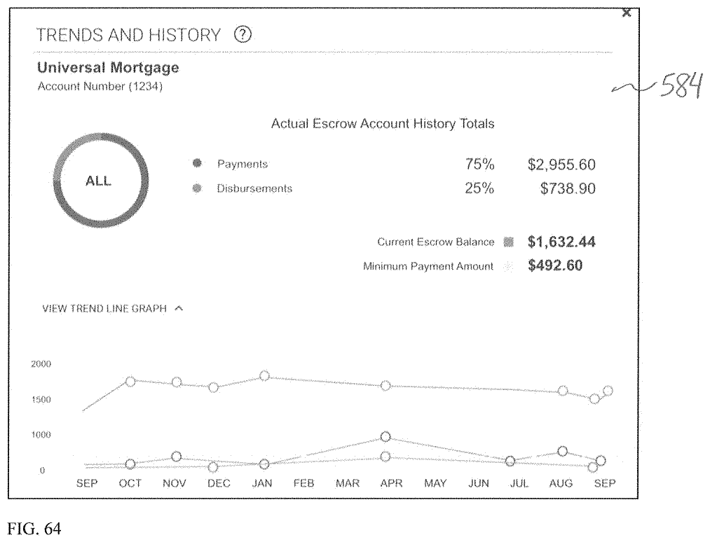

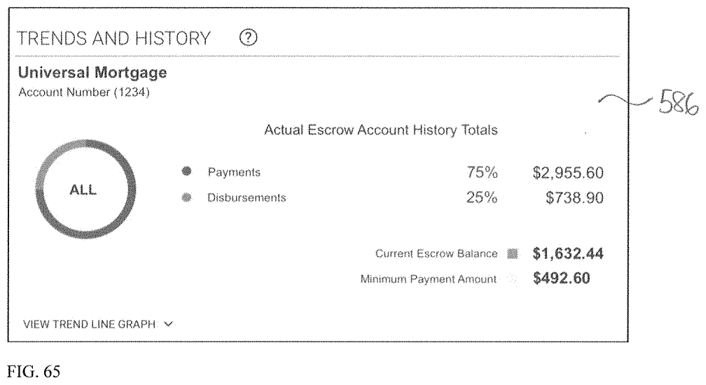

Referring next to FIG. 62, when the user hovers over the Trends and History” icon 580 of the header bar displaying the escrow statement, the “Trends and History” widget opens a dialog box or window 582 illustrated in FIG. 63. dialog box or window displays data for categories “Payments” and “Disbursements. The dialog box or window 582 of FIG. 63, as well as dialog boxes or windows 584 and 586 of FIGS. 64 and 65, respectively, have the same functionality of FIGS. 37F-37I described above.

Escrow statements may have the same activity-line functionality described previously, for example, as shown and described for the functionality of the “Notes and Attachments” widget in connection with FIGS. 41 and 42. If desired, the activity-line “Trends and History” may be omitted for escrow statements.

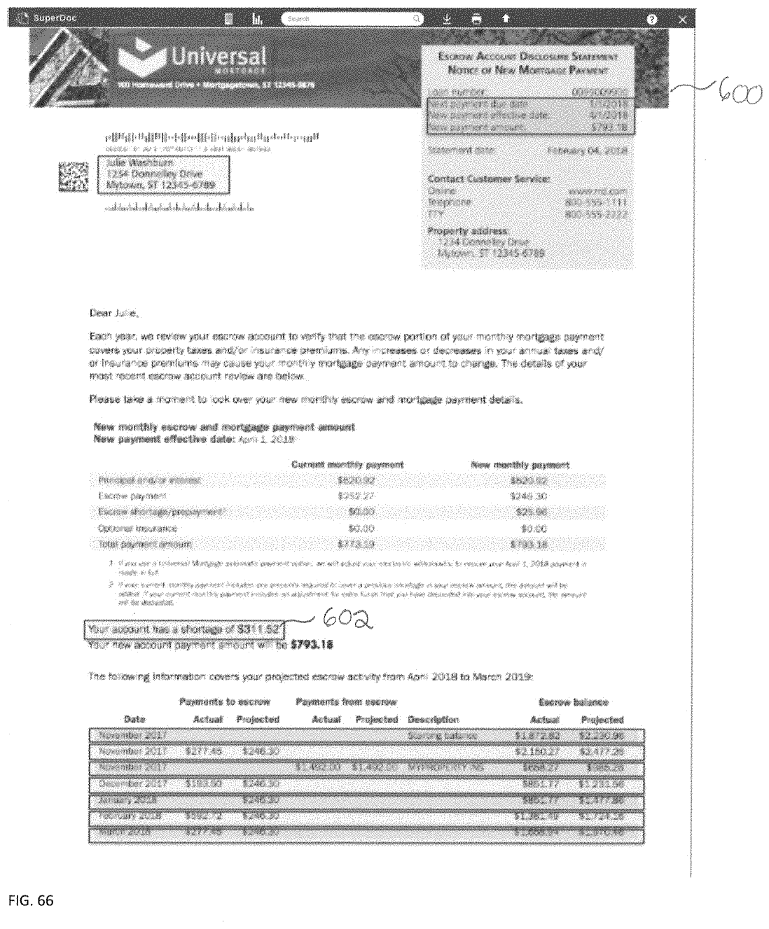

FIG. 66 illustrates a sample escrow statement 600 having a number of enhanced areas, such as area 602. When a user selects the area 602 a “Shortage Payoff Estimator” widget displays a dialog box or window 603 having a field 605 display the amount of shortage in the account as indicated on the escrow statement (or $0 if the account is not in arrears), a field 606 displaying the additional amount that the user would need to pay per month to eliminate the shortfall in a particular period of time, a field 608 showing the remaining months (as selected by the user) until the shortage is paid, and a View New Payment Details drop down arrow icon 610.

The default view displays a payoff estimate assuming that the shortage amount will be paid off over 12 months. Thus, the field 606 displays an “Add to Monthly Payment Amount” equaling the “Escrow Shortage Amount” in field 605 divided by 12. Additionally, the “Month(s) to Payoff” field 608 displays 12 months to payoff.

The user is able to enter a different amount in the field 606, whereupon the “Month(s) to Payoff” field 608 changes to reflect the amount of payments needed to pay the total “Escrow Shortage Amount”. Thus, for example, If the Escrow Shortage Amount equals $311.53 and the default view estimates that adding $25.96 to my Monthly Payment will take 12 months to payoff the shortage, when the user enters $35.00 into the “Add to Monthly Payment” field 606 the “Month(s) to Payoff” value in the field 608 changes to 9, as seen in FIG. 68.

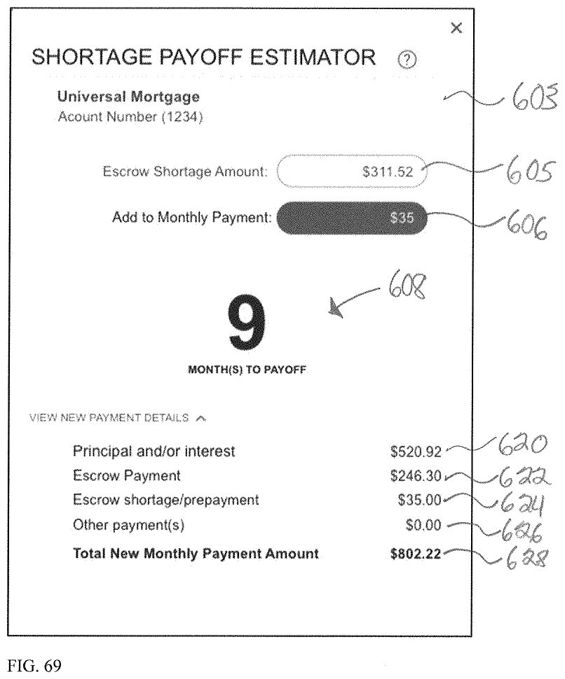

As seen in FIG. 69, when the user selects the View New Payment Details drop down arrow icon 610, the widget displays a value of a new “Principal and/or interest payment” in a field 620, a new “Escrow Payment” in a field 622, an estimated “Escrow shortage/prepayment” value in a field 624 that equals the amount entered into the “Add to Monthly Payment” field 606, an updated “Other payments(s)” value in a field 626 that totals all other new payments indicated on the statement (for instance, insurance), and a “Total New Monthly Payment Amount” in a field 628 that equals the total of the above items.

If desired, a “Pay Shortage” payment button may be included in the dialog box or window 603 that, when selected, links to a third-party payment portal to enable the user to pay the escrow shortfall by credit card, bank account, or otherwise, such as using the functionality described above in connection with FIG. 7.

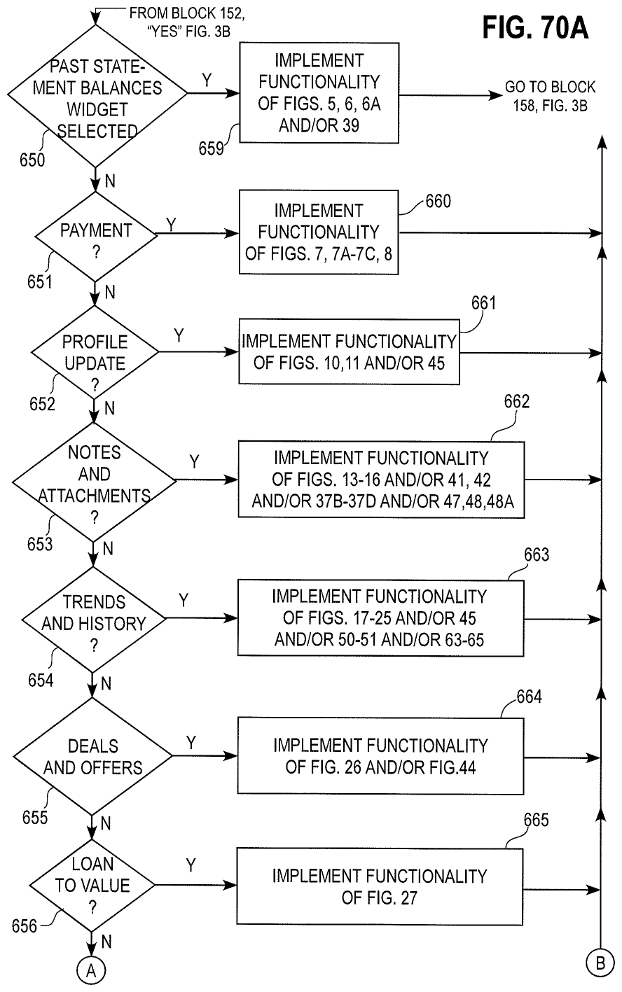

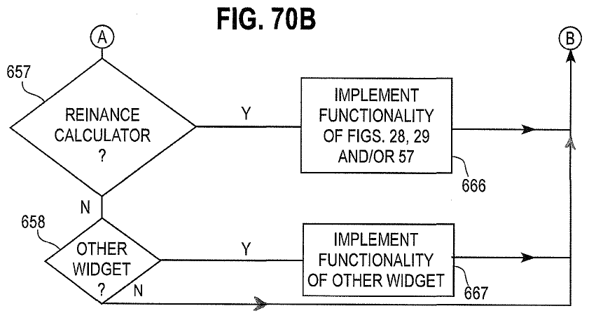

Referring next to FIGS. 70A and 70B, a series of blocks 650-658 determines which widget has been selected and blocks 659-667 implement the proper functionality depending upon which widget has been selected. In this regard, as noted by the blocks 659-667 the functionality of one or more FIGS. may be used together or separately. Thus, for example, the block 659 illustrates that the functionality of the groups represented by FIGS. 5-6A and/or FIG. 39 may be used alone or together as desired. Further, it may be noted that some or all of the features of one of the groups represented by the indicated FIGS. may be used together with one or more of the features of another one or more of the groups.

Referring next to FIG. 70C, a series of blocks 668-674 determines which area/icon has been selected and blocks 675-681 implement the proper functionality depending upon which area/icon has been selected. In this regard, as noted by the blocks 675-681 the functionality of one or more FIGS. may be used together or separately. Thus, for example, the block 675 illustrates that the functionality of the groups represented by FIG. 9 and/or FIG. 56 may be used alone or together as desired. Further, it may be noted that some or all of the features of one of the groups represented by the indicated FIGS. may be used together with one or more of the features of another one or more of the groups.

It should be apparent to one who has ordinary skill in the art that the embodiments described in the foregoing may be used to provide additional enhanced features to documents.

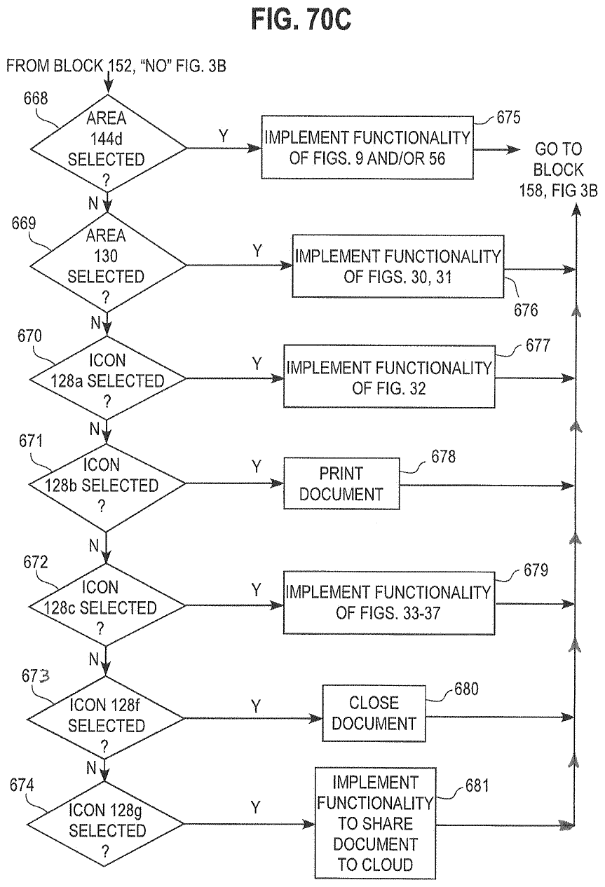

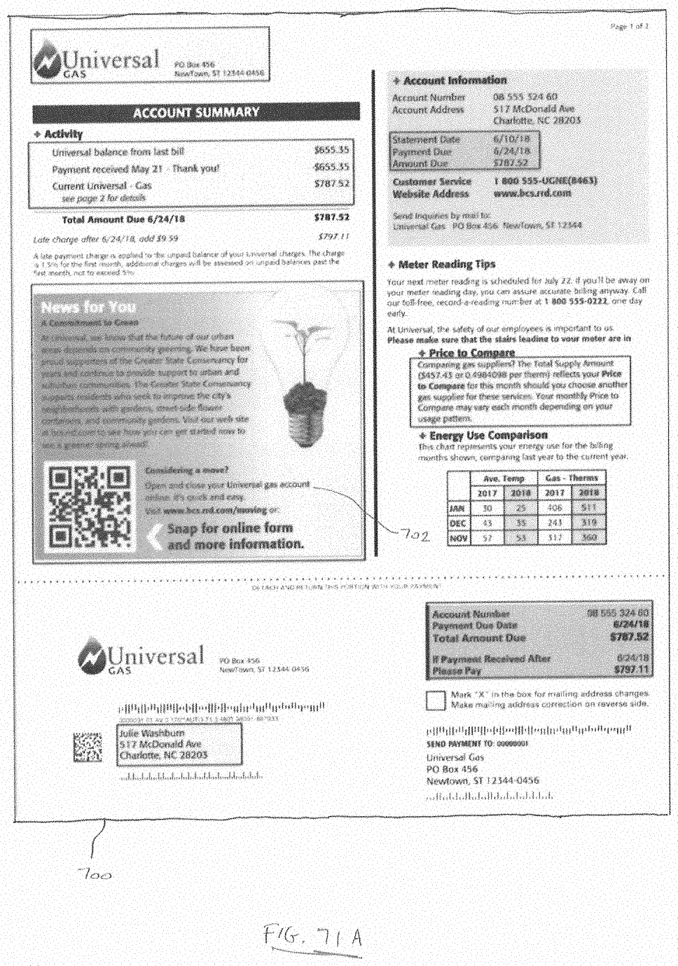

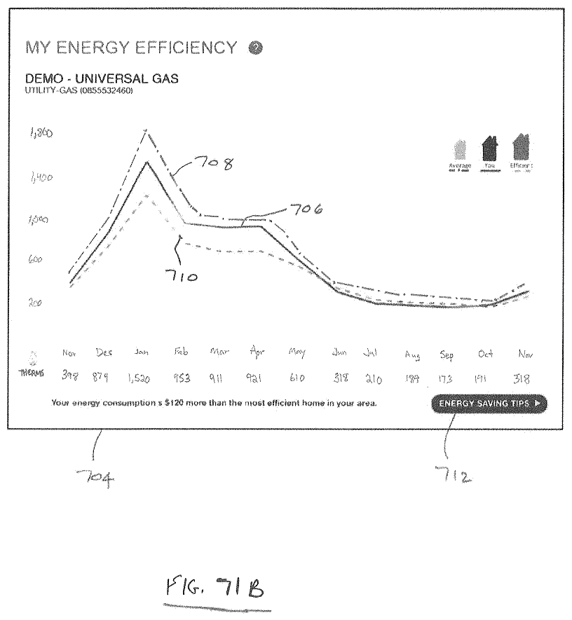

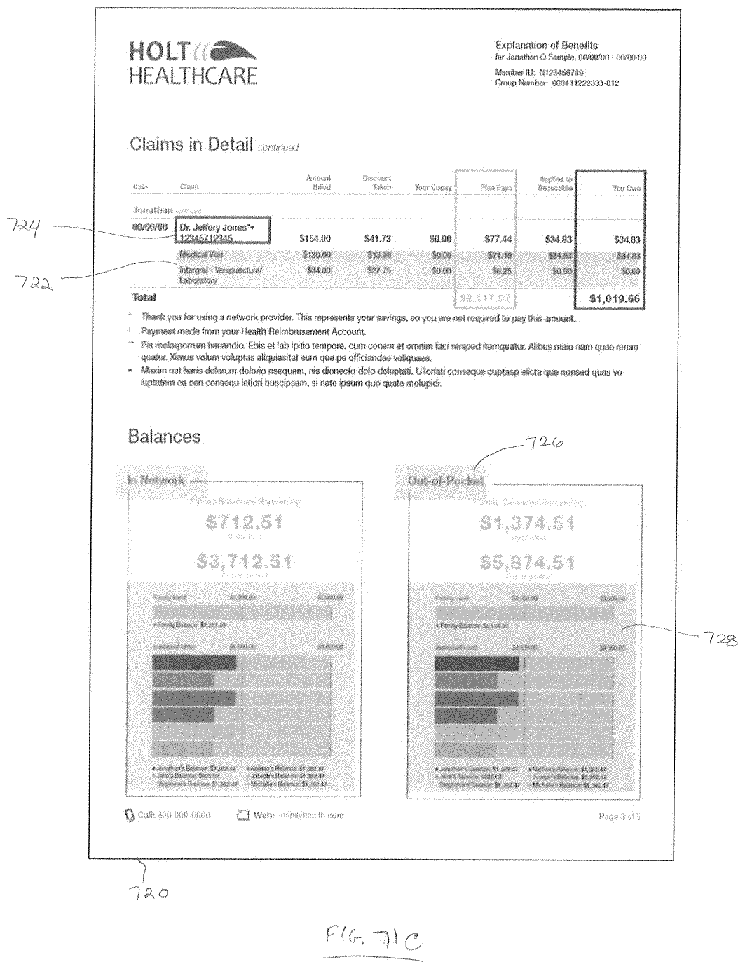

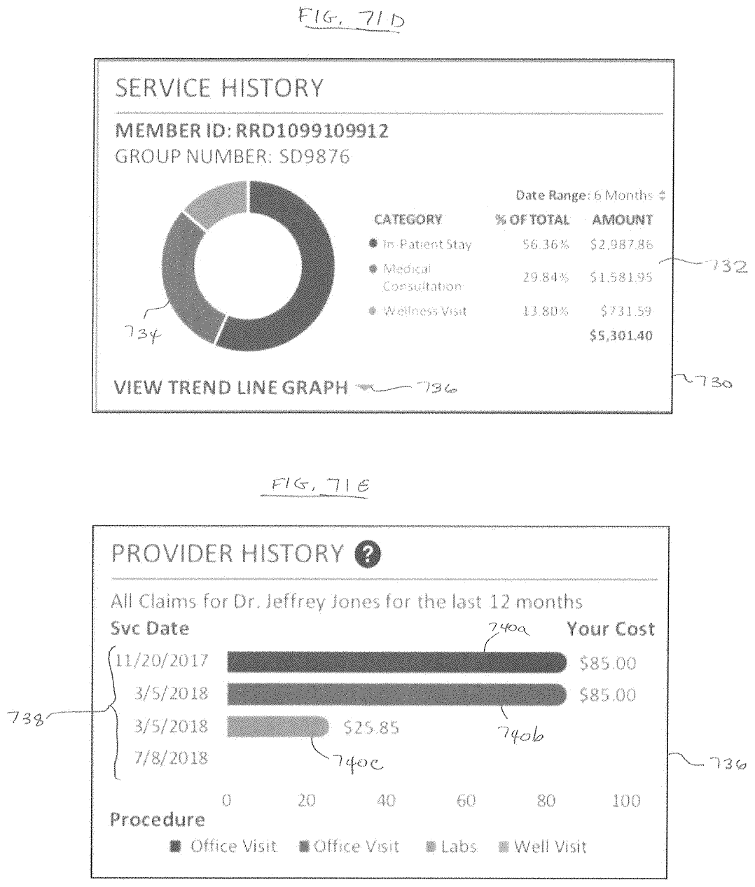

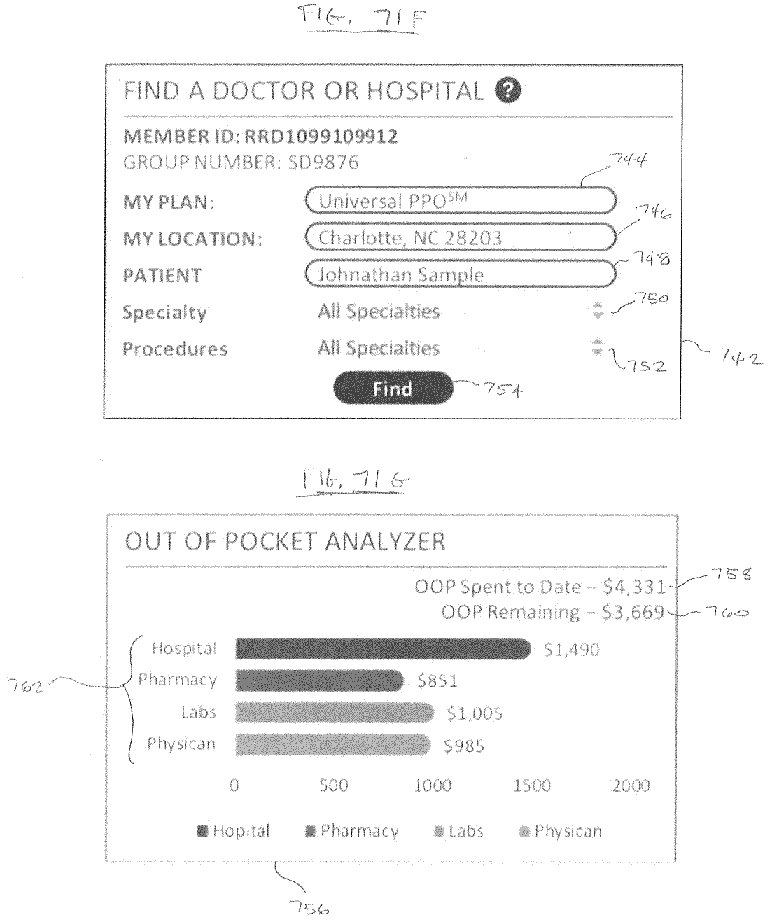

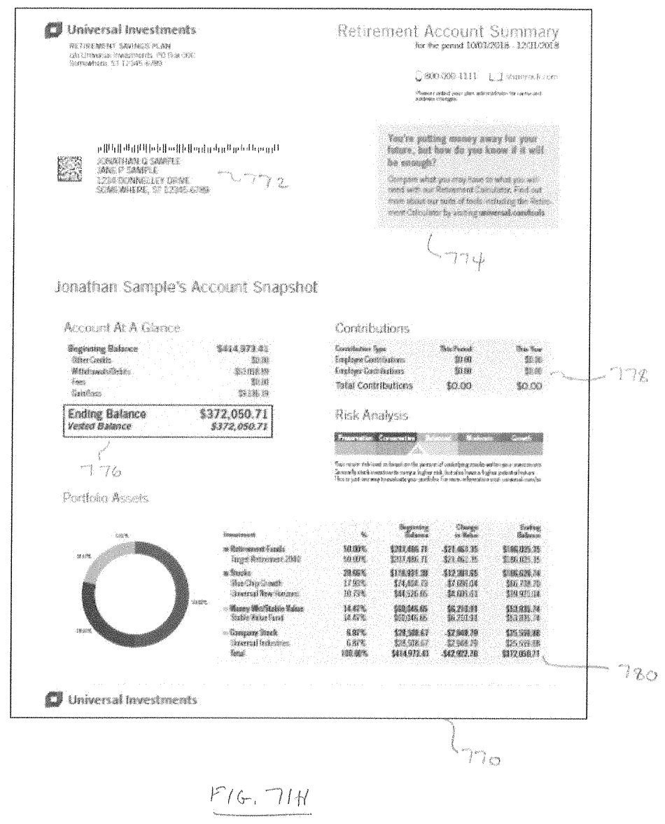

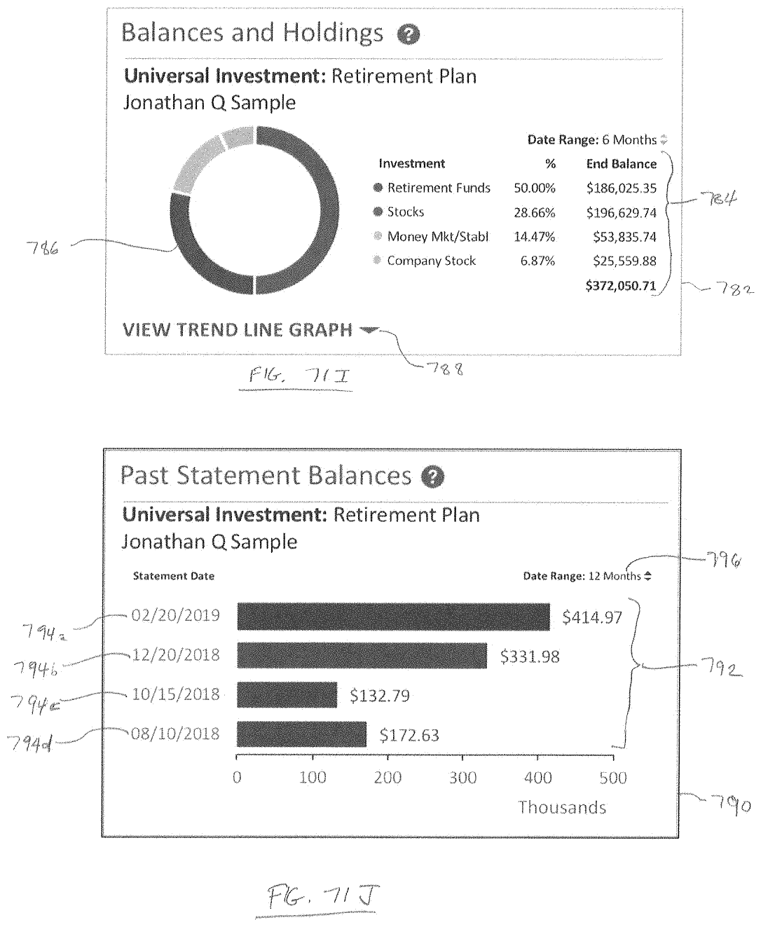

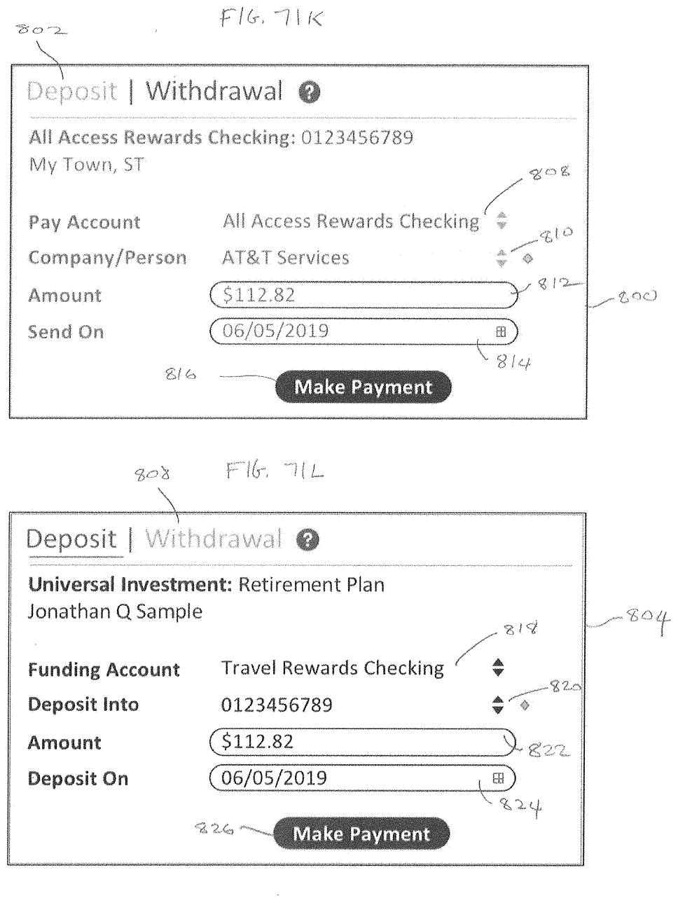

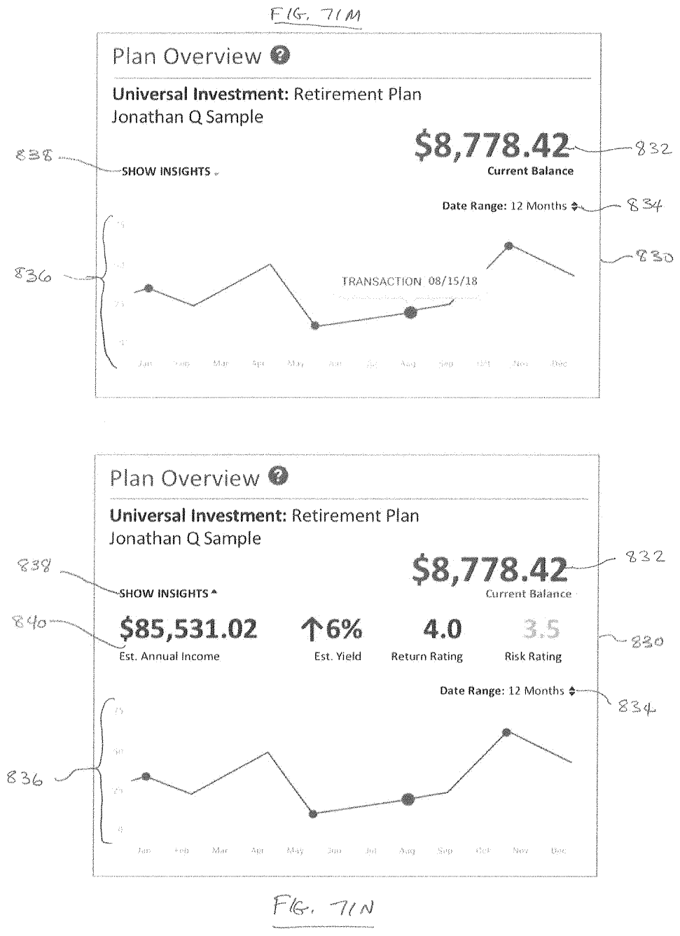

For example, referring to FIGS. 71A and 71B, a utility bill document 700 may include an area 702 that when invoked or actuated displays a dialog box or window 704 (FIG. 71B) that shows energy efficiency information associated with user. In one embodiment, as shown in FIG. 71B, such energy efficiency information may include, for example, a graph 706 that shows the energy consumption by the user over a predetermined period of time, a graph 708 that shows the average energy use of a predetermined cohort of energy consumers, and a graph 710 that shows the energy use typical of an energy efficient consumer. In some embodiments, the dialog box or window 704 may also include an area 712 that, when invoked (i.e., selected), displays a further dialog box or window (not shown) that has information regarding practices the user may undertake to reduce energy consumption.

It should be apparent to one of ordinary skill in the art that the embodiments described above may be adapted to add enhanced features to other types of documents, including, for example, healthcare or insurance statements, retirement or financial account statements, and the like.

Referring to FIGS. 71C-71G, a document 720 associated with a healthcare or insurance account of the user may be displayed with areas 722, 724, 726, and 728 associated with enhanced features. Invoking the area 722 causes display of a dialog box or window 730 shown in FIG. 71D in which information regarding services provided to the user is displayed. In particular, such dialog box or window 730 may display a region 732 in which amounts associated with different types of healthcare services and portion of such amounts relative to a total amount spent by the user are shown. The dialog box or window 730 may also include a graphical display 734 of such amount information shown as, for example, a pie or donut chart or the like. The dialog box or window 730 may further include an area 736 that, when invoked, causes display of a further dialog box or window (not shown) in which a trend line graph showing historical spending by the user for healthcare services. Alternately, in some embodiments, invoking the area 736 may cause the dialog box or window 730 to increase in size to add a region (not shown) in which such trend line graph (not shown) is displayed.

As shown in FIG. 71C, the area 724 is associated with a name of a healthcare provider and invoking such area causes display of a dialog box or window 736 (FIG. 71E). In some embodiments, the dialog box or window 736 shows a bar graph 738 that identifies one or more date(s) when the provider associated with the area 724 provided one or more service(s) to the user and the cost(s) incurred by the user for such service(s). In some embodiments, each bar 740a, 740b, 740c (or portions thereof) of the bar graph 738 may be color coded to identify a category of the service associated with such bar 740.

Invoking the area 726 of the document 720 (FIG. 71C) causes display of a dialog box or window 742 shown in FIG. 71F. Referring to FIG. 71F, the dialog box or window 742 includes an area 744 in which identification information regarding an insurance plan associated with the user may be displayed, an area 746 in which a location associated with the user may be displayed, and an area 748 in which a patient associated with the user may be displayed. In some embodiments, one or more of the areas 744, 746, and 748 may be invoked to change the information displayed therein. For example, if the area 748 is invoked, the user may be able to identify a different patient than the one shown in such area. The user may wish to change the patient name to select, for example, another person on the same insurance plan identified in the region 748. Similarly, the user may wish to change the location shown in the area 746 to select a different location than the one shown in such area, for example, a location proximate to a workplace.

The dialog box or window 742 also includes an area 750 that the user may invoke to select a specialty and an area 752 that the user may invoke to select a procedure. In some embodiments, invoking one of the areas 750 and 752 may display a pop-up menu with a list of specialties and procedures, respectively, from which the user may select a particular specialty or procedure, respectively. It should be apparent to one who has ordinary skill in the art that other ways of selecting a specialty or procedure may be provided.

The dialog box or window 742 further includes an area 754 that when invoked generates a further dialog box or window (not shown) that displays a list of providers that are associated with the insurance plan identified in the area 744, are proximate the location identified in the area 746, and provide the specialty and/or procedure identified in areas 750 and/or 752. It should be apparent to one who has ordinary skill in the art that provider information may be stored in the database 64 (FIG. 1), the datastore 100 associated with an entity that supplied the document 720, or another predetermined database accessible via the wide area network 67. As would be apparent to one who has ordinary skill in the art, the information displayed, entered, and/or selected in the areas 744-752 may be used to form a query that is used to select and display a subset of providers from such provider information.

Referring once again to FIG. 71C, selecting the area 728 causes a dialog box or window 756 to be displayed. The window 756 includes an area 758 in which information regarding out-of-pocket expenditures spent by the user during a predetermined amount of time, an area 760 that displays information regarding, for example, additional fees that may still need to be paid out-of-pocket before an insurance provider will pay fees, and a bar chart 762 that shows a breakdown of the out-of-pocket expenditures shown in the area 758 in accordance with predetermined categories.

As shown in FIGS. 71H-71L, a document 770 associated with a financial account, for example, a retirement account, may include areas 772, 774, 776, 778, and 780 that enable enhanced features. Invoking the area 772 causes the “Profile Update” widget to operate as described hereinabove in connection with FIG. 10.

Invoking the area 774 redirects the web browser or opens a web browser window/tab on the client computer 68 (FIG. 1) that includes various retirement tools such as, for example, a retirement calculator tool.

Invoking the area 776 causes a dialog box or window 782 having an area 784 that shows how the balance in the retirement account associated with the document is 770 is allocated to predetermined categories of investments. The dialog box or window 782 may also include an area 786 in which such information is represented as a pie or donut chart. The dialog box or window 782 may also include an area 788 that when invoked displays a further dialog box or window (not shown) that shows a trend graph illustrating how the balance in the retirement account has changed over a predetermined period of time. In some embodiments, invoking the area 788 expands the size of the dialog box or window 782 to add an additional area (not shown) in which such trend graph is displayed.

In some embodiments, invoking the area 776 may cause a dialog box or window 790 (FIG. 71J) to be displayed instead of the dialog box or window 782. Referring to FIG. 71J, the dialog box or window 790 shows an area 792 in which a balance of the financial account at different statement dates is shown. The area 792 includes one or more regions 794 associated with each statement date. In some embodiments, invoking an area 794 associated with a particular statement date displays a statement (e.g., a PDF) or other document associated with such statement date.

The dialog box or window 790 may include an area 796 that allows the user to select a date range and all statements issued in connection with the financial account associated with the document 770 within the selected date range are displayed in the area 792.

Referring once again to FIG. 71H and FIGS. 71K and 71L, invoking the area 778 (FIG. 71H) causes a dialog box or window 800 to be displayed. The dialog box or window 800 includes an area 802. Invoking the area 802 causes the dialog box or window 800 to be replaced by the dialog box or window 804. The dialog box or window 804 includes an area 806 and invoking the area 806 causes the dialog box or window 804 to be replaced by the dialog box or window 800.

As described below, the user may use the dialog box or window 800 to initiate a transfer of funds from a financial account and the dialog box or window 804 to deposit funds into a financial account.

The dialog box or window 800 also includes an area 808 that allows selection of a particular account associated with the user. It should be apparent to one who has skill in the art that the user may have different accounts (e.g., checking, savings, retirement, and the like) at the entity that issued the financial document 770. If the user has access to more than one such account, the user may invoke the area 808 to select, e.g., via a pop-up menu, a particular account from a list of accounts associated therewith.

The dialog box or window 800 includes an area 810 that the user may invoke to select a payee of funds, an area 812 to enter an amount of money to transfer from the account selected by invoking the area 808 to the payee, and an area 814 to specify a date for such transfer. In some embodiments, invoking the area 814 may enable the user may type in a date in the area 814, may display a calendar widget (not shown) that allows the user to select a date, or allow another way to specify such date as apparent to one who has ordinary skill in the art.

The dialog box or window 800 includes an area 816 that, when invoked, schedules the funds transfer specified by the user.

Referring to FIG. 71L, the dialog box or window 804 includes an area 818 that, when invoked, enables the user to select an account from which to transfer funds, an area 820 to specify an account into which the funds should be transferred, an area 822 to specify an amount of the funds to transfer, and an area 824 to specify a date when the funds should be transferred. The dialog box or window 804 further includes an area 826 that, when invoked, schedules the transfer of funds specified by invoking areas 818-824.

Referring once again to FIG. 71H, invoking the area 780 causes display of a dialog box or window 830 shown in FIGS. 71M and 71N.

Referring to FIG. 71M, the dialog box or window 830 includes an area 832 in which a current balance is displayed of an account with which the document 770 is associated.

The dialog box or window 830 also includes an area 834 that, when invoked, allows the user to specify a period of time, and an area 836 in which a graph of how the balance of the account has changed over such specified period of time is displayed.

The dialog box or window 830 includes an area 838 that, when invoked, causes the size of the dialog box or window 830 to be expanded sufficiently to accommodate an area 840 between the areas 832 and 834, as shown in FIG. 71N. The area 840 includes additional information such, for example, as annual estimate income, an estimated yield, a risk rating, and the like regarding the account associated with the document 770 (FIG. 71H). Further, if the area 838 is invoked when the area 840 is displayed, the area 840 is hidden and the size of the dialog box or window 830 is reduced accordingly, as shown in FIG. 71M.

### INDUSTRIAL APPLICABILITY

It can be visualized that the widgets and/or enhanced functionality allow documents to be more interactive as a layer over a new or existing PDF or other document type. Enabling an interactive experience between user(s) and one or more relevant document(s) in the database 64 (whether or not the documents are opened) leads to improved utility and versatility. User(s) may engage directly with opt-in solutions and products/services with prepopulated and other forms as well as other content so as to increase the favorability of e-statement usage.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only and should not be taken as limiting the scope of the disclosure.

We claim:

1. A method, comprising the steps of:
receiving first page definition language (PDL) code defining a first document wherein the first PDL code includes first data;
deriving further code from the first code;
using the further code to display the first document with an indication of functionality at a particular location wherein the particular location includes a representation of the first data
receiving a user selection of the particular location; and
in response to receipt of user selection of the particular location, displaying second data from a data source other than the first document wherein the second data are related to the first data by at least one of (a.) subject matter and (b.) chronology.

2. The method of claim 1, wherein the step of displaying the second data further comprises the step of displaying the first data with the second data.

3. The method of claim 2, wherein the second data represents a value associated with a first time period and the first data represents a value associated with a second time period subsequent to the first time period.

4. The method of claim 1, wherein the step of deriving comprises the step of combining the first PDL code with second code to obtain the further code.

5. The method of claim 1, wherein the second data is obtained from a third-party website.

6. The method of claim 1, wherein the first data includes an identification of a recipient and the second data includes an editable indication of details relating to the recipient.

7. The method of claim 1, wherein the document comprises a statement and the first data include an indication of current activity related to the statement and the second data include a representation of the current activity and past activity.

8. The method of claim 7, further including the step of displaying a particular category of the activity in response to selection of the representation of the current activity and the past activity.

9. The method of claim 7, wherein the representation of the current activity and the past activity is presented in graph form.

10. The method of claim 1, wherein the document comprises a statement and the first data include an indication of current activity related to the statement and the second data include at least one of at least one note and at least one attachment.

11. The method of claim 1, wherein the document comprises a statement and the first data comprises a balance due for a current statement period and the second data includes a representation of balances due for a selectable number of statement periods prior to the current statement period.

12. A non-transitory computer-readable medium, having programming for executing the following steps:
receiving first page definition language (PDL) code defining a first document wherein the first PDL code includes first data;
deriving further code from the first code;
using the further code to display the first document with an indication of functionality at a particular location wherein the particular location includes a representation of the first data receiving a user selection of the particular location; and
in response to receipt of user selection of the particular location, displaying second data from a data source other than the first document wherein the second data are related to the first data by at least one of (a.) subject matter and (b.) chronology.

13. The computer-readable medium of claim 12, wherein the step of displaying the second data further comprises the step of displaying the first data with the second data.

14. The computer-readable medium of claim 13, wherein the second data represents a value associated with a first time period and the first data represents a value associated with a second time period subsequent to the first time period.

15. The computer-readable medium of claim 12, wherein the step of deriving comprises the step of combining the first PDL code with second code to obtain the further code.

16. The computer-readable medium of claim 12, wherein the second data is obtained from a third-party website.

17. The computer-readable medium of claim 12, wherein the first data includes an identification of a recipient and the second data includes an editable indication of details relating to the recipient.

18. The computer-readable medium of claim 12, wherein the document comprises a statement and the first data include an indication of current activity related to the statement and the second data include a representation of the current activity and past activity.

19. The computer-readable medium of claim 18, further including the step of displaying a particular category of the activity in response to selection of the representation of the current activity and the past activity.

20. The computer-readable medium of claim 18, wherein the representation of the current activity and the past activity is presented in graph form.

21. The computer-readable medium of claim 12, wherein the document comprises a statement and the first data include an indication of current activity related to the statement and the second data include at least one of at least one note and at least one attachment.

22. The computer-readable medium of claim 12, wherein the document comprises a statement and the first data comprises a balance due for a current statement period and the second data includes a representation of balances due for a selectable number of statement periods prior to the current statement period.

23. A method, comprising the steps of:
receiving first data from code defining a document in accordance with a page definition language (PDL) specification wherein the first data would be displayed at a particular location of the document if the document were displayed using the code;
receiving second data from a data source other than the document wherein the second data are related to the first data by at least one of (a.) subject matter and (b.) chronology; and
instructing a client device to display the document together with a portion in response to selecting the particular location on the client device wherein the portion includes a representation of at least one of (c.) the first data and the second data and (d.) a combination of the first data and the second data.

24. The method of claim 23, further comprising the step of instructing the client device to display selection options at the particular location.

25. The method of claim 24, further comprising the step of instructing the client device to undertake a particular function using the first data and the second data when one of the selection options is selected.

26. The method of claim 23, wherein the second data represents a value associated with a first time period and the first data represents a value associated with a second time period subsequent to the first time period.

27. The method of claim 23, wherein the first data includes an identification of a recipient and the second data includes an editable indication of details relating to the recipient.

28. The method of claim 23, wherein the document comprises a statement and the first data include an indication of current activity related to the statement and the second data include a representation of the current activity and past activity.

29. The method of claim 28, further including the step of displaying a particular category of the current activity and the past activity in response to selection of the representation of the current activity and the past activity.

30. The method of claim 28, wherein the representation of the current activity and the past activity is presented in graph form.

31. The method of claim 23, wherein the document comprises a statement and the first data include an indication of current activity related to the statement and the second data include at least one of at least one note and at least one attachment.

32. The method of claim 23, wherein the document comprises a statement and the first data comprises a balance due for a current statement period and the second data includes a representation of balances due for a selectable number of statement periods prior to the current statement period.

33. A method of using data stored in one or more entries of a database, wherein the data are related by at least one of subject matter and chronology, the method comprising the steps of:
receiving first code defining a first document according to a page description language specification;
using the first code to develop second code defining a second document having a first portion at least substantially identical to a corresponding portion of the first document and the second document further having a second portion that includes a selectable area;
operating a display device in accordance with the second code to display the second document;
receiving an indication of selection of the selectable area; and
in response to receipt of the indication displaying a representation of at least one entry in the database.

34. The method of claim 33, wherein the at least one entry in the database represents a value associated with a first time period and first data are displayed at the selectable area representing a value associated with a second time period subsequent to the first time period.

35. The method of claim 33, wherein first data are displayed at the selectable area representing an identification of a recipient and the at least one entry in the database represents an editable indication of details relating to the recipient.

36. The method of claim 33, wherein first data are displayed at the selectable area representing current activity related to the statement and the at least one entry in the database represents the current activity and past activity.

37. The method of claim 36, further including the step of displaying a particular category of the current activity and the past activity.

38. The method of claim 36, wherein the representation of the current activity and the past activity is presented in graph form.

39. The method of claim 33, wherein the first document comprises a statement and first data are displayed at the selectable area representing current activity related to the statement and the at least one entry in the database represents at least one of at least one note and at least one attachment.

40. The method of claim 33, wherein the first document comprises a statement and first data are displayed at the selectable area representing a balance due for a current statement period and the at least one entry in the database represents balances due for a selectable number of statement periods prior to the current statement period.
